(19) United States
(12) Patent Application Publication
(10) Pub. No.: US 2026/0001106 A1
(43) Pub. Date: Jan. 1, 2026

(54) STEAM GENERATOR AND INTELLIGENT DEVICE

(71) Applicant: TINECO INTELLIGENT TECHNOLOGY CO., LTD., Jiangsu (CN)

(72) Inventors: Fan FAN, Jiangsu (CN); HUANG Jian, Jiangsu (CN); Tao CHEN, Jiangsu (CN); Dunjie YU, Jiangsu (CN); Kaibo ZHANG, Jiangsu (CN); Xing ZANG, Jiangsu (CN); Peng HU, Jiangsu (CN); Zhuang MA, Jiangsu (CN); Yongshuai ZHAI, Jiangsu (CN); Chunyan FU, Jiangsu (CN); Wenjie DONG, Jiangsu (CN); Jingshan ZHENG, Jiangsu (CN); Jincheng Xue, Jiangsu (CN)

(73) Assignee: TINECO INTELLIGENT TECHNOLOGY CO., LTD., Jiangsu (CN)

(21) Appl. No.: 18/857,520

(22) PCT Filed: Apr. 18, 2023
(86) PCT No.: PCT/CN2023/088949

§ 371 Date: Oct. 17, 2024

(30) Foreign Application Priority Data
Apr. 18, 2022 (CN) 202210406323.5
Apr. 18, 2022 (CN) 202220897653.4
Jun. 28, 2022 (CN) 202210753615.6
Aug. 26, 2022 (CN) 202211035346.6
Sep. 1, 2022 (CN) 202211065486.8
Sep. 1, 2022 (CN) 202211066832.4
Sep. 7, 2022 (CN) 202211091415.5

(51) Int. Cl. B08B 3/02; B08B 13/00; H05B 1/02; H05B 3/06

(52) U.S. Cl. CPC B08B 3/02; B08B 13/00; H05B 1/0244; H05B 3/06; B08B 2203/007; B08B 2203/02; H05B 2203/021

(57) ABSTRACT

A steam generator an intelligent and cleaning device are provided. The steam generator includes a heating body, a heating chamber, and a water inlet and an air outlet in communication with the heating chamber; the heating body is configured to heat water entering the heating chamber via the water inlet; the heating body includes a heating zone covered with water, and a high-temperature zone uncovered with water; the water at the heating zone forms steam after being heated; the steam is configured to be discharged via the air outlet after being heated by the high-temperature zone.

### CROSS-REFERENCE TO RELATED APPLICATIONS

This application is the national phase of International Patent Application No. PCT/CN2023/088949, titled “STEAM GENERATOR AND INTELLIGENT DEVICE”, filed on Apr. 18, 2023, which claims priorities to Chinese Patent Application No. 202211091415.5, titled “STEAM GENERATOR AND INTELLIGENT DEVICE”, filed on Sep. 7, 2022, Chinese Patent Application No. 202210406323.5, titled “CLEANING DEVICE”, filed on Apr. 18, 2022, Chinese Patent Application No. 202211035346.6, titled “STEAM GENERATOR AND INTELLIGENT DEVICE”, filed on Aug. 26, 2022, Chinese Patent Application No. 202210753615.6, titled “CLEANING DEVICE, CLEANING ASSEMBLY, AND CLEANING METHOD”, filed on Jun. 28, 2022, Chinese Patent Application No. 202220897653.4, titled “CLEANING DEVICE AND HEATING APPARATUS”, filed on Apr. 18, 2022, Chinese Patent Application No. 202211065486.8, titled “CLEANING DEVICE AND HEATING BODY”, filed on Sep. 1, 2022, Chinese Patent Application No. 202211066832.4, titled “CLEANING DEVICE AND HEATING APPARATUS”, filed on Sep. 1, 2022, with the National Intellectual Property Administration, PRC, which are incorporated herein by reference in their entireties.

### FIELD

The present disclosure relates to the technical field of steaming devices, and in particular to a steam generator, and further to an intelligent device.

### BACKGROUND

There are many devices on the market that are required to generate steam, such as cordless steam scrubbers, cordless steam mops, and cordless eye smokers. A steam generator is small or miniature, and has the same basic principle as the boiler, that is, water inside the steam generator is heated through a heating apparatus to form steam, which is then sprayed after passing through a pipe, to be used for scenarios of cleaning work or maintenance and the like. However, the existing small or miniature steam generator is limited by the size, power and other factors, the amount of steam sprayed is limited, which cannot be directly observed by the user, leaving the user with misunderstanding of a small amount of steam or no steam sprayed, affecting the user's experience.

### SUMMARY

A steam generator and an intelligent device are provided according to the present disclosure to solve the problems in the conventional art.

According to a first aspect of the present disclosure, a steam generator is provided, which includes a heating body, a heating chamber, and a water inlet and an air outlet that are in communication with the heating chamber. The heating body is configured to heat water entering the heating chamber from the water inlet. The heating body includes a heating zone covered with water, and a high temperature zone not covered with water. Water in the heating zone is heated to form steam, which is heated in the high temperature zone and then sprayed out from the air outlet.

In an embodiment of the present disclosure, at least a portion of an entire circumferential sidewall of the heating body is configured to be not covered with water, to form the high temperature zone.

In an embodiment of the present disclosure, the heating body includes a heat-conducting part and a heating part, a hollow internal chamber of the heat-conducting part serves as the heating chamber, and the heating part is configured to be wrapped around at least a portion of an outer surface of the heat-conducting part.

In an embodiment of the present disclosure, the steam generator has a first end and a second end that are opposite to each other along an axial direction of the steam generator. The water inlet is arranged at the first end of the steam generator, and the air outlet is arranged at the second end of the steam generator. The heating body is configured to gradually incline upwardly from the first end to the second end, the heating zone is at a position adjacent to the first end of the heating body.

In an embodiment of the present disclosure, in a direction from the first end to the second end, an inclination angle R of the heating body with respect to the horizontal plane meets the following relationship: 5°≤R≤60°.

In an embodiment of the present disclosure, the steam generator further includes a housing, and the heat-conducting part is arranged in an internal chamber of the housing. A water injection pipe joint forming a water inlet is arranged at a first end of the housing.

In an embodiment of the present disclosure, in an axial direction of the heat-conducting part, the heating part is configured to have a predetermined distance from each of the first end and second end of the heat-conducting part.

In an embodiment of the present disclosure, the steam generator further includes a pre-heating pipe. The pre-heating pipe is wrapped around the heat-conducting part at a position adjacent to the second end of the heat-conducting part. An inlet of the pre-heating pipe is configured to be connected to an outside water source, and an outlet of the pre-heating pipe is configured to be connected to the water inlet via a pipe.

In an embodiment of the present disclosure, the pre-heating pipe is wrapped around the heat-conducting part at a position staggered from the heating part.

In an embodiment of the present disclosure, the steam generator includes a housing, an internal chamber of the housing forms the heating chamber. The heating body is arranged in the heating chamber and is configured to extend in the heating chamber in a direction from a first end to a second end. A space above the heating body is larger than a space below the heating body in the heating chamber.

In an embodiment of the present disclosure, the housing includes a first enclosure part arranged below the heating body, and a flaring part connected to the first enclosure part and inclined outwardly from a position connected with the first enclosure part to outside of the heating body, and a second enclosure part arranged above the heating body and connected to the flaring part.

In an embodiment of the present disclosure, the first enclosure part and the second enclosure part are in a circular arc shape, and a radius of curvature of the first enclosure part is smaller than a radius of curvature of the second enclosure part.

In an embodiment of the present disclosure, the high temperature zone is configured to maintain at a temperature of 280-580° C.

In an embodiment of the present disclosure, the steam generator is provided with a scale deposit chamber inside that is in communication with the heating chamber, the scale deposit chamber is arranged on a side adjacent to the high temperature zone and is configured to receive scale.

In an embodiment of the present disclosure, the air outlet is arranged on the steam generator at a position corresponding to the scale deposit chamber. A filter assembly is arranged in the scale deposit chamber, and the filter assembly is configured to cover the air outlet.

According to a second aspect of the present disclosure, an intelligent device is provided, which includes the steam generator.

According to a third aspect of the present disclosure, a steam generator is provided. The steam generator has a first end and a second end that are opposite to each other along an axial direction of the steam generator. The steam generator includes a housing and a heating body. The housing is provided with a heating chamber inside as well as a water inlet and an air outlet that are in communication with the heating chamber. The heating body is arranged in the heating chamber and is configured to extend in the heating chamber in a direction from the first end to the second end. Water entering the heating chamber from the water inlet is configured to be heated and atomized under the action of the heating body and sprayed out from the air outlet. A space above the heating body is larger than a space below the heating body in the heating chamber.

In an embodiment of the present disclosure, the housing includes a first enclosure part arranged below the heating body; a flaring part connected to the first enclosure part and inclined outwardly from a position connected to the first enclosure part to the outside of the heating body; and a second enclosure part arranged above the heating body and connected to the flaring part.

In an embodiment of the present disclosure, the first enclosure part and the second enclosure part are in a circular arc shape, and a radius of curvature of the first enclosure part is smaller than a radius of curvature of the second enclosure part.

In an embodiment of the present disclosure, opposite sides of the first enclosure part extend at least above a bottom of the heating body.

In an embodiment of the present disclosure, a distance L1 between a bottom of the heating body and the first enclosure part meets the following relationship: 1.5 mm≤L1≤4.5 mm.

In an embodiment of the present disclosure, the steam generator is configured to allow only a portion of the heating body to be covered with water and to maintain a surface of another portion of the heating body not covered with water at a maximum temperature of 280-580° C., to allow at least a portion of water entering the steam generator from the water inlet to be heated and atomized and sprayed out from the air outlet.

In an embodiment of the present disclosure, the steam generator is configured so that, when in use, the heating body gradually inclines upwardly in a direction from the first end to the second end, where a low temperature zone represents a zone of the heating body covered with water and a high temperature zone represents a zone not covered with water.

In an embodiment of the present disclosure, in the direction from the first end to the second end, an inclination angle R of the heating body with respect to the horizontal plane meets to the following relationship. 3°≤R≤15°.

In an embodiment of the present disclosure, the housing is provided with at least a scale deposit chamber extending downwardly at a position corresponding to the high temperature zone of the heating body, the scale deposit chamber is in communication with the heating chamber, and a bottom of the scale deposit chamber is configured to be lower than a bottom of the heating chamber.

In an embodiment of the present disclosure, the heating body comprises a temperature detecting element, a detection point of the temperature detecting element is set at the high temperature zone and is used to measure a temperature of the high temperature zone; and in an axial direction of the steam generator, a relative position between the detection point and a side wall of the scale deposit chamber adjacent to the first end is within 10 mm.

In an embodiment of the present disclosure, the air outlet is arranged on the housing at a position corresponding to the scale deposit chamber; a filter assembly is arranged in the scale deposit chamber, and water heated and atomized is sprayed out from the air outlet after passing through the filter assembly.

In an embodiment of the present disclosure, a central axis of the air outlet is located higher than a bottom of the second end of the heating body.

In an embodiment of the present disclosure, the air outlet is arranged on an end surface of the second end of the housing; the filter assembly is configured to cover the air outlet.

In an embodiment of the present disclosure, the air outlet is arranged at a top position of the housing adjacent to the second end; the filter assembly comprises a first filter arranged above the scale deposit chamber and covering the air outlet, and a second filter connected to the first filter and extending to the bottom of the scale deposit chamber.

In an embodiment of the present disclosure, the water inlet is arranged on the housing at a position of above the heating body.

In an embodiment of the present disclosure, the heating body is fixed with a flange at a position adjacent to the first end, and the heating body is connected to an open end of the housing by the flange; and a distance L2 between a central axis of the water inlet and an end surface of the flange meets the following relationship: 0 mm≤L2≤30 mm.

In an embodiment of the present disclosure, the steam generator further includes a control unit. The control unit is configured to control a heating power of the heating body and a flow rate of water from the inlet into the heating chamber based on a temperature collected by the temperature detecting element.

Compared with the conventional steam generator, in the steam generator according to the present disclosure, the heating body includes a heating zone covered with water and a high-temperature zone not covered with water, where water entering the heating zone is heated into steam through the heating zone, and the formed steam is heated into high-temperature steam through the high-temperature zone. In this way, the steam is secondarily heated in the high-temperature zone, a greater loss of steam that is caused by the steam condensing into water and coming out of the pipe when flowing through the pipe can be avoided. Moreover, when the high-temperature steam is sprayed out from the air outlet of the steam generator, there is a greater temperature difference between the steam and the outside air, which generates more steam with better visibility, thus enhancing the visual effect of the sprayed steam. Moreover, the higher temperature steam will also vaporize the moisture in the air, thereby further forming more water mist.

Other features and advantages of the present disclosure will become clear through the following detailed description of exemplary embodiments of the present disclosure with reference to the drawings.

### BRIEF DESCRIPTION OF THE DRAWINGS

FIG. 1 is a schematic diagram of a longitudinal section of a steam generator according to an embodiment of the present disclosure;

FIG. 2 is a schematic diagram of an internal structure of a steam generator according to an embodiment of the present disclosure;

FIG. 3 is a schematic explosive view of a steam generator according to an embodiment of the present disclosure;

FIG. 4 is a schematic top view of a steam generator according to an embodiment of the present disclosure;

FIG. 5 is a schematic diagram of a structure of a steam generator according to another embodiment of the present disclosure;

FIG. 6 is a schematic diagram of a longitudinal section of a steam generator according to another embodiment of the present disclosure;

FIG. 7 is a schematic diagram of an internal structure of a heating body according to another embodiment of the present disclosure;

FIG. 8 is a schematic diagram of a cross-section of a steam generator according to another embodiment of the present disclosure;

FIG. 9 is a schematic diagram of a longitudinal section of a steam generator according to another embodiment of the present disclosure;

FIG. 10 is a schematic diagram of a three-dimensional structure of a filter assembly according to an embodiment of the present disclosure;

FIG. 11 is a schematic three-dimensional diagram of a steam generator according to another embodiment of the present disclosure;

FIG. 12 is a schematic three-dimensional diagram of a cleaning device according to an embodiment of the present disclosure;

FIG. 13 is a schematic sectional view of a heating apparatus according to an embodiment of the present disclosure;

FIG. 14 is a schematic sectional view of a housing and a sealing ring according to an embodiment of the present disclosure;

FIG. 15 is a schematic sectional view of an assembly of a heating body, a temperature detecting element and an insulating sealing part according to an embodiment of the present disclosure;

FIG. 16 is a schematic sectional view of an assembly of a heating body, a temperature detecting element and an insulating sealing part with a heat-conducting rod removed according to an embodiment of the present disclosure;

FIG. 17 is an enlarged view of a part A in FIG. 16;

FIG. 18 is a schematic three-dimensional diagram of a cleaning device according to an embodiment of the present disclosure;

FIG. 19 is a schematic sectional view of a heating apparatus according to an embodiment of the present disclosure;

FIG. 20 is a schematic sectional view of a housing and a sealing ring according to an embodiment of the present disclosure;

FIG. 21 is a schematic sectional view of an assembly of a heating body, a temperature detecting element and an insulating sealing part according to an embodiment of the present disclosure;

FIG. 22 is a schematic sectional view of an assembly of a heating body, a temperature detecting element and an insulating sealing part with a heat-conducting rod removed according to an embodiment of the present disclosure;

FIG. 23 is an enlarged view of a part A in FIG. 22;

FIG. 24 is a schematic side view of a heating body with a heating body housing removed according to an embodiment of the present disclosure;

FIG. 25 is a schematic sectional view of a heating body according to an embodiment of the present disclosure;

FIG. 26 is a schematic explosive view of a heating body according to an embodiment of the present disclosure;

FIG. 27 is a schematic three-dimensional diagram of a heat-conducting rod according to an embodiment of the present disclosure;

FIG. 28 is a schematic three-dimensional diagram of a heating body with a front support part removed according to an embodiment of the present disclosure;

FIG. 29 is a schematic sectional view of a heating body according to another embodiment of the present disclosure;

FIG. 30 is a schematic side view of a first wire and a second wire as well as a positive wire and a negative wire according to an embodiment of the present disclosure;

FIG. 31 is a schematic diagram of a longitudinal section of a steam generator according to an embodiment of the present disclosure;

FIG. 32 is a schematic diagram of an internal structure of a heating body according to an embodiment of the present disclosure;

FIG. 33 is a schematic sectional view of a steam generator according to an embodiment of the present disclosure;

FIG. 34 is a schematic diagram of a longitudinal section of a steam generator according to another embodiment of the present disclosure;

FIG. 35 is a schematic diagram of a three-dimensional structure of a filter assembly according to an embodiment of the present disclosure;

FIG. 36 is a schematic three-dimensional diagram of a steam generator according to an embodiment of the present disclosure;

FIG. 37 exemplarily illustrates a schematic diagram of a structure of a cleaning device according to an embodiment of the present disclosure;

FIG. 38 exemplarily illustrates a schematic diagram of a structure of a cleaning device according to another embodiment of the present disclosure;

FIG. 39 exemplarily illustrates a schematic diagram of a structure of a cleaning device according to another embodiment of the present disclosure;

FIG. 40 exemplarily illustrates a schematic flowchart of a cleaning method according to an embodiment of the present disclosure;

FIG. 41 is a schematic three-dimensional diagram of a cleaning device according to an embodiment of the present disclosure;

FIG. 42 is a schematic sectional view of a heating apparatus according to an embodiment of the present disclosure;

FIG. 43 is a schematic sectional view of a housing and a sealing ring according to an embodiment of the present disclosure;

FIG. 44 is a schematic sectional view of an assembly of a heating body, a temperature detecting element and an insulating sealing part according to an embodiment of the present disclosure;

FIG. 45 is a schematic sectional view of an assembly of a heating body, a temperature detecting element and an insulating sealing part with a heat-conducting rod removed according to an embodiment of the present disclosure;

FIG. 46 is an enlarged view of part Ain FIG. 45;

FIG. 47 is a schematic side diagram of a heating body with a heating body housing removed according to an embodiment of the present disclosure;

FIG. 48 is a schematic sectional view of a heating body according to an embodiment of the present disclosure;

FIG. 49 is a schematic explosive view of a heating body according to an embodiment of the present disclosure;

FIG. 50 is a schematic three-dimensional diagram of a heat-conducting rod according to an embodiment of the present disclosure;

FIG. 51 is a schematic three-dimensional diagram of a heating body with a front support part removed according to an embodiment of the present disclosure;

FIG. 52 is a schematic sectional view of a heating body according to another embodiment of the present disclosure;

FIG. 53 is a schematic side diagram of a first wire and a second wire as well as a positive wire and a negative wire according to an embodiment of the present disclosure;

FIG. 54 is a schematic three-dimensional diagram of a cleaning device according to an embodiment of the present disclosure;

FIG. 55 is a schematic partial three-dimensional diagram of a cleaning device according to an embodiment of the present disclosure;

FIG. 56 is a schematic partial sectional view of a cleaning device according to an embodiment of the present disclosure;

FIG. 57 is an enlarged view of part Ain FIG. 56;

FIG. 58 is a schematic sectional view of a heating apparatus according to an embodiment of the present disclosure;

FIG. 59 is a schematic sectional view of a housing and a sealing ring according to an embodiment of the present disclosure;

FIG. 60 is a schematic sectional view of an assembly of a heating body, a temperature detecting element and an insulating sealing part according to an embodiment of the present disclosure;

FIG. 61 is a schematic sectional view of an assembly of a heating body, a temperature detecting element and an insulating sealing part with a heat-conducting rod removed according to an embodiment of the present disclosure;

FIG. 62 is an enlarged view of a part B in FIG. 61.

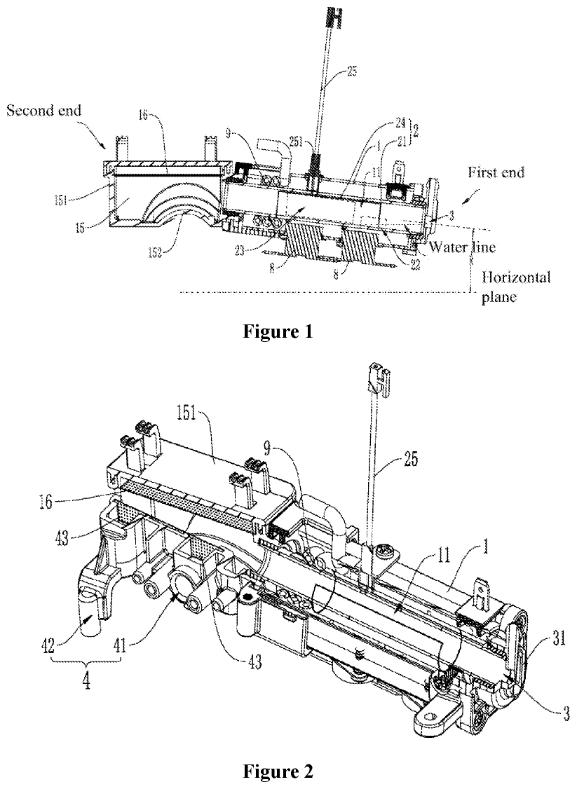

The one-to-one correspondence between the names of the components and the reference numbers in FIGS. 1 to 62 is shown as follows:
1. Housing; 101. Upper housing; 102. Lower housing; 11. Heating chamber; 1111. First end; 1112. Second end; 12. First enclosure part; 120. Air jet head; 13. Flaring part; 130. Cooling apparatus; 131. Heat exchanger pipe; 1311. First segment; 1312. First heat exchange segment; 1313. Second segment; 132. Drive mechanism; 1321. First pump body; 1322. Second pump body; 140. Water supply pipe; 143. Three-way pipe; 150. Flexible pipe; 160. Sealing member; 14. Second enclosure part; 15. Scale deposit chamber; 151. Scale deposit part housing; 152. Scale deposit part projection; 16. Filter assembly; 161. First filter; 162. Second filter; 180. Water spray assembly; 181. Water spray nozzle; 190. Filter box,
2. Heating body; 20. Heating apparatus; 21. Heating part; 22. Heating zone; 23. High temperature zone; 24. Heat-conducting part; 25. Temperature detecting element; 251. Detection point; 26. Horizontal segment; 27. Extension segment; 231. Heating wire; 232. Heating body housing; 233. Heat-conducting rod; 2331—Thermocouple groove; 234. Heating body housing; 2340. Supporting body; 2341—Notch; 2342—First extension part; 2343—Second extension part; 2350. Front support part; 2360. Rear support part; 235. Heating body chamber; 237—Through groove; 2381. First wire; 2382. Second wire; 2391—First wire channel; 2392—Second wire channel; 28. Sealing ring; 29. Insulating sealing part; 262. Positive wire; 263. Negative wire; 2641—Positive wire channel; 2642—Negative wire channel;
3. Water inlet; 31. Water injection pipe joint; 32. Air outlet enclosure part;
4. Air outlet; 41. First air outlet; 42. Second air outlet; 43. Air outlet chamber;
5. Flange; 6. Sealing ring; 7. Temperature fuse; 8. Temperature control switch;
9. Pre-heating pipe; 91. Inlet; 92. Outlet; 90. Body; 901. Roller brush; 902. Air jet nozzle.

### DETAILED DESCRIPTION OF EMBODIMENTS

Various exemplary embodiments of the present disclosure will now be described in detail with reference to the drawings. It should be noted that the relative arrangements, numerical expressions and values of the components and steps set forth in these embodiments do not limit the scope of the present disclosure unless otherwise specifically stated.

The following description of at least one exemplary embodiment is in fact merely illustrative and in no way serves as any limitation on the present disclosure and its application or use.

Techniques, methods, and devices known to those skilled in the art may not be discussed in detail, but where appropriate, the techniques, methods, and devices should be considered as a portion of the specification.

In all examples shown and discussed herein, any specific values should be interpreted as merely exemplary and not as limitations. Thus, other examples of exemplary embodiments may have different values.

It should be noted that, similar symbols and letters denote similar items in the following drawings, and therefore, once an item is defined in one drawing, no further discussion is required in the subsequent drawings.

Herein, the terms “top”, “bottom”, “front”, “back”, “left”, “right” and the like are used only to indicate relative positional relationship between related parts, rather than defining the absolute positions of such related parts.

Herein, the terms “first”, “second” and the like are used only for distinguishing each other, rather than indicating the importance and order, or the premise of mutual existence.

Herein, the terms “equal”, “same” and the like are not limitations in a strict mathematical and/or geometrical sense, but also encompass errors that are understandable to those skilled in the art and are permitted by manufacture or use, etc.

A steam generator is provided according to the present disclosure, which includes a heating body and a heating chamber. The heating chamber is provided with an inlet and an outlet at two ends of the heating chamber that are in communication with the heating chamber, and the heating body is used to heat water entering the heating chamber from the water inlet. When the steam generator is applied in an external device, the steam generator is installed in the external device in a transverse manner, that is, the extension direction or the axial direction of the steam generator or the heating body is approximately the horizontal direction or is set at an angle to the horizontal plane.

Specifically, the surface of the heating body includes a heating zone covered with water and a high-temperature zone not covered with water. Water in the heating zone is heated and boiled to form steam, and the formed steam is secondarily heated in the heating chamber through the high-temperature zone of the heating body to form high-temperature steam at a higher temperature. After the steam is secondarily heated in the high-temperature zone, the steam can be avoided to condense into water and flow out from the pipe when it flows in the pipe, which results in the occurrence of large steam loss. In addition, when the high-temperature steam is sprayed out from the air outlet of the steam generator, there is a greater temperature difference with the outside air, which generates more visible water mist, thus enhancing the visual effect of the sprayed steam. Moreover, the steam with a higher temperature will also vaporize the moisture in the air, thereby further forming more water mist.

The high temperature zone in the present disclosure is called relative to the heating zone. Since the heating zone is covered with water, a maximum temperature of the heating zone will not exceed 100° C., and the high temperature zone may have a temperature of more than 100° C. relative to the heating zone since it is not covered with water. In an embodiment of the present disclosure, the temperature of the high temperature zone maintains between 280° C. and 580° C., which allows the steam formed in the heating zone to be secondarily heated by the high temperature zone as it flows in the heating chamber to the high temperature zone to form high temperature steam with a higher temperature, and the temperature of the steam in the heating chamber may reach over 170° C.

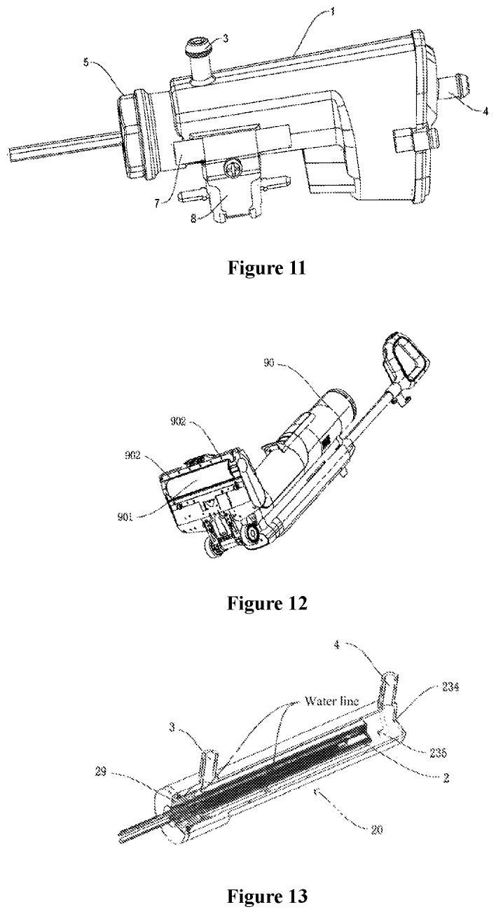

For ease of understanding, the specific structure and operating principle of the steam generator according to the present disclosure are described in detail below with reference to FIGS. 1 to 11 in conjunction with an embodiment.

A steam generator is provided according to the present disclosure, which may be used on various intelligent devices that need to generate steam, such as a cordless steam scrubber, a cordless steam mop, a cordless eye smoker, and the like. The steam generator according to the present disclosure is a miniature device which may be applied to cordless devices with low power and utilizes a battery of the cordless device itself for power supply. However, the steam generator according to the present disclosure may also be applied on a cord device, which will not be specifically described herein.

As shown in FIGS. 1 and 2, the steam generator includes a heating body 2, a heating chamber 11, and a water inlet 3 and an air outlet 4 that are in communication with the heating chamber 11. The heating body 2 is configured to heat water entering the heating chamber 11 from the water inlet 3. The water inlet 3 is connected to an external water source, and the external water source may be a reservoir that comes with the intelligent device or other devices that can provide water.

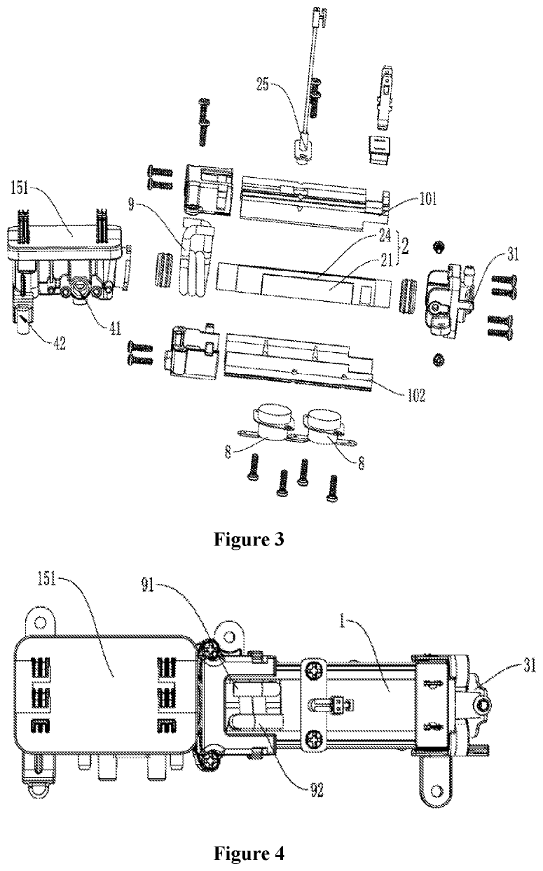

As shown in FIG. 1, in an embodiment of the present disclosure, the steam generator further includes a housing 1, the heating body 2 includes a heat-conducting part 24 and a heating part 21. The heating part 21 is wrapped around at least a portion of an outer surface of the heat-conducting part 24, the hollow internal chamber of the heat-conducting part 24 is the heating chamber 11, the heat-conducting part 24 is arranged in the internal chamber of the housing 1, and a water injection pipe joint 31 forming the water inlet 3 is arranged at an end of the housing 1. As shown in FIG. 3, in an embodiment of the present disclosure, the housing 1 may include an upper housing 101 and a lower housing 102, and the heating body 2 is wrapped in the internal chamber of the housing 1 by fastening the upper housing 101 to the lower housing 102.

During the operation of the steam generator, water enters the heating chamber 11 in the heat-conducting part 24 from the water injection pipe joint 31, and the heating part 21 heats the heat-conducting part 24 from the outside, which in turn heats the water inside the heat-conducting part 24.

Further, as shown in FIGS. 1 and 2, in an embodiment of the present disclosure, along the axial direction of the steam generator, the steam generator has opposite first end and second end. The water inlet 3 is arranged at the first end of the steam generator, and the air outlet 4 is arranged at the second end of the steam generator. The heating body 2 is configured to incline upwardly gradually from the first end to the second end, and the heating zone 22 is at a position adjacent to the first end of the heating body 2. Since the heating body 2 is gradually inclined upwardly from the first end to the second end, the position adjacent to the first end of the heating body 2 may be covered with water, and the position adjacent to the second end of the heating body 2 is not prone to be covered with water, thereby forming a high temperature zone 23.

In the use of the steam generator of the present disclosure, water may enter the heating chamber 11 from the water inlet 3 at the first end of the steam generator, and the water entering from the water inlet 3 may first contact the heating zone 22 of the heating body 2, and then be heated into steam by the heating zone 22, and the formed steam moves inclined upwardly along the extension direction of the heating body 2, passes through the high temperature zone 23, and is secondarily heated into high temperature steam by the high temperature zone 23. After passing through the high-temperature zone 23, the high-temperature steam is finally sprayed out from the air outlet 4 at the second end of the steam generator. As the steam is secondarily heated in the high-temperature zone 23, it can be avoided that the steam condenses into water and flows out of the pipe when it flows in the pipe, which results in a large loss of steam. In addition, after the high temperature steam is sprayed out from the air outlet 4 of the steam generator, there is a great temperature difference with the outside air, and more water mist with good visibility can be generated, thus enhancing the visual effect of the steam being sprayed. Moreover, the high temperature steam can also vaporize the moisture in the air, thereby further forming more water mist.

As shown in FIG. 1, in an embodiment of the present disclosure, in the direction from the first end to the second end, the inclination angle R of the heating body 2 with respect to the horizontal plane meets the following relationship: 5°≤R≤60°. When the inclination angle R is less than 5°, more zone on the surface of the heating body 2 will be covered with water, and the area of the high temperature zone 23 will be small, making it difficult to heat the steam into high temperature steam, and when the inclination angle R is greater than 60°, it will be difficult to bring out the scale, resulting in the scale deposited at the heating zone 22. In addition, the water gathering at the heating zone 22 may reduce the contact area between the water and the heating zone 22, resulting in a lower heating efficiency. By controlling the inclination angle of the heating body 2 with respect to the horizontal plane to be between 5° and 60°, the heating zone 22 covered with water and the high temperature zone 23 not covered with water can be formed in the heating chamber 11 by controlling the amount of water.

Since the heat-conducting part 24 is provided with some mating parts made of plastic or rubber at two ends, in order to avoid damage to the mating parts, as shown in FIGS. 1 and 2, in an embodiment of the present disclosure, there is a predetermined distance between the heating part 21 and the first end and the second end of the heat-conducting part 24, respectively along the axial direction of the heat-conducting part 24. Since the heating part 21 has a predetermined distance with respect to the first end and the second end of the heat-conducting part 24, respectively, the high temperature generated by the heating part 21 can be prevented from affecting the mating parts at the two ends of the heat-conducting part 24, which in turn ensures that the steam generator can operate properly.

Further, as shown in FIGS. 1 to 4, in an embodiment of the present disclosure, the steam generator further includes a pre-heating pipe 9, the pre-heating pipe 9 is wrapped around the heat-conducting part 24 at a position adjacent to the second end thereof, the inlet 91 of the pre-heating pipe 9 is connected to an external water source, and the outlet 92 of the pre-heating pipe 9 is connected to the water inlet 3 through a pipe.

During the use of the steam generator of the present disclosure, water may first enter into the pre-heating pipe 9, and is pre-heated in the pre-heating pipe 9, then the water after pre-heating enters the heating zone from the water inlet 3 to generate steam. In this way, heat emitted from the second end of the heat-conducting part 24 be utilized to pre-heat the water from the outside water source before entering the heating chamber 11 to generate steam, thereby improving the utilization rate of the heat of the heating body 2. Further, the pre-heating pipe 9 can be utilized to absorb residual heat generated at a position of the heating body 2 adjacent to the second end thereof, to prevent the high temperature generated by the heating part 21 from influencing the mating parts at the two ends of the heat-conducting part 24, thereby protecting the mating members on the second end of the heating body 2.

As shown in FIGS. 1 and 2, in an embodiment of the present disclosure, the pre-heating pipe 9 is wrapped around the heat-conducting part 24 at a position staggered from the heating part 21. In this way, it can be avoided that the pre-heating pipe 9 is in a position where the high temperature zone 23 is located, which causes the temperature of the high temperature zone 23 to decrease, thereby ensuring that the high temperature zone 23 can heat the steam into high temperature steam.

In an embodiment of the present disclosure, the bottom of the entire axial sidewall of the heating body 2 may all be covered with water to form a heating zone. That is, a portion of the circumferential sidewall of the heating body 2 at any position is submerged in water, as long as it can be ensured that the position not covered with water can reach the temperature required to heat the steam, for example, as long as it can be ensured that a certain zone or position not covered with water can maintain at a temperature between 280° C. and 580° C.

However, for small devices, as the limitations of power and volume of the steam generator, the position of the heating body 2 not covered with water is difficult to maintain the temperature of the steam for secondary heating, which makes the position not covered with water to have a low temperature, the steam sprayed out from the air outlet 4 is prone to condense into water inside the pipe due to the low temperature, resulting in a large loss of steam. Further, condensate will flow out along the pipe, affecting the normal use of the cordless eye smoker and other intelligent devices.

Based on this, in an embodiment of the present disclosure, at least a portion of the entire circumferential sidewall of the heating body 2 is configured to be not covered with water, to form a high-temperature zone 23. Regardless of whether the heating body 2 is regular or irregular, as long as the entire circumferential sidewall at certain positions are not covered with water, the positions of the heating body may be left in a “dry burning” state, and thus the positions of the heating body can reach a high temperature, for example, between 280° C. and 580° C.

Taking FIG. 1 as an example, the heating body 2 is in the shape of a regular rod or cylinder, and the entire circumferential sidewall of the second end of the heating body 2 is not covered with water, so that the temperature of the high-temperature zone 23 can be higher, thus making the temperature of the high-temperature steam higher, and avoiding high-temperature steam to condense into water inside the intelligent device before being sprayed, to reduce the losses of the steam generator and reduce the amount of water used by the steam generator, thereby improving the duration of the steam generator, and also improving the spray effect of the steam generator.

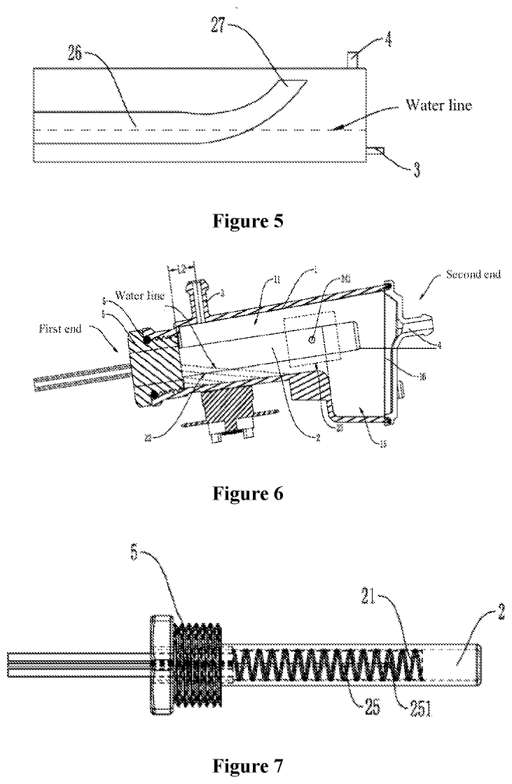

Taking FIG. 5 as an example, the heating body 2 includes a horizontal segment 26 extending in a horizontal direction, and an extension segment 27 extending upwardly from the horizontal segment 26, where the extension segment 27 may be perpendicular to the horizontal segment 26 or may be inclined at a predetermined angle relative to the horizontal segment 26. The bottom sidewall in the axial direction of the horizontal segment 26 is submerged in water, and at least a portion of the extension segment 27 is located above the water line as a whole, i.e., the entire circumferential sidewall of a portion of the extension segment 27 is not covered with water, thereby forming a high-temperature zone 23 in the entire circumferential zone of the extension segment 27 not covered with water, which makes the steam generated in the heating zone 22 be secondarily heated when passing through the high-temperature zone 23 to form a high-temperature steam.

Specifically, in actual use, the existing steam generator not only requires a large amount of power for the heating body, but also consumes a large amount of water, due to the need to consider steam loss and to partially submerge the entire circumference part of the heating body 2 in water. In contrast, the water consumption of the steam generator of the present disclosure can be controlled to be about 5 g/min, with a maximum of no more than 10 g/min, so that the duration of the steam generator of the present disclosure is greatly extended under the condition that the volume of the reservoir is the same. In addition, the use of the above-described structure makes the maximum power of the steam generator of the present disclosure be only 300 w, and the effect of generating steam can also be ensured.

As shown in FIGS. 1 and 2, in an embodiment of the present disclosure, the housing 1 is provided with a scale deposit chamber 15 communicating with the heating chamber 11, and the scale deposit chamber 15 has a scale deposit part housing 151 arranged on a side adjacent to the high temperature zone 23, and is configured to receive scale.

During the use of the steam generator, since the heating body 2 continuously heats the water in the heating chamber 11, water containing soluble calcium and magnesium compounds will precipitate insoluble calcium or magnesium salts, that is, scale particles, after boiling, and the scale particles in the steam may adhere to the chamber wall of the heating chamber 11 when contacting the chamber wall of the heating chamber 11. In this way, with the continuous use of the steam generator, the scale on the chamber wall of the heating chamber 11 will accumulate thicker and thicker.

In a case that the scale deposit chamber 15 is arranged, the high-temperature steam has a certain momentum during the flow toward the air outlet 4, thereby causing the high-temperature steam mixed with scale particles to deposit in the scale deposit chamber 15 under the action of gravity during the flow toward the air outlet 4, thereby slowing down the deposition rate of the scale, thus extending the service life of the steam generator.

Moreover, as shown in FIG. 1, in the direction from the first end to the second end, the inclination angle R of the heating body 2 with respect to the horizontal plane meets the following relationship: 5°≤R≤60°, it can be avoided the case that the scale particles in the steam cannot be moved the scale deposit chamber 15 due to the large inclination angle, so as to ensure that the scale particles in the steam fall into the scale deposit chamber 15 to a maximum extent.

As shown in FIGS. 2 and 3, in an embodiment of the present disclosure, the air outlet 4 includes a first air outlet 41 and a second air outlet 42, and the first air outlet 41 and the second air outlet 42 have different the pipe diameters, and the steam sprayed from them have different pressures and flow rates, so that during the operation of the steam generator, it can be determined to open any one of the air outlets, or to open both of the air outlets at the same time according to actual needs.

As shown in FIGS. 2 and 3, the first air outlet 41 and the second air outlet 42 are arranged on the side wall of the scale deposit part housing 151, and the steam generated in the heating chamber 11 flows into the scale deposit chamber 15, and the scale carried in the steam is also carried into the scale deposit chamber 15 for storage, and the steam flows out through the first air outlet 41 and/or the second air outlet 42. In order to avoid the scale particles in the high temperature steam from flowing back into the heating chamber 11, in an embodiment of the present disclosure, a scale deposit part projection 152 is provided between the scale deposit chamber 15 and the heating chamber 11. The scale deposit part projection 152 is in the form of an upwardly protruding curved arc, and with the scale deposit part projection 152, the scale particles in the high temperature steam may be deposited in the scale deposit chamber 15 between the scale deposit part housing 151 and the scale deposit part projection 152, preventing scale particles in the scale deposit chamber 15 flowing back to the heating chamber 11, and thus preventing the scale particles from being deposited in the heating chamber 11.

As shown in FIGS. 1 to 3, in an embodiment of the present disclosure, the steam generator of the present disclosure is provided with a temperature detecting element 25, and a detection point 251 of the temperature detecting element 25 is arranged inside the heat-conducting part 24 at a position corresponding to the high-temperature zone 23, and is used to measure the temperature of the high-temperature zone 23. Specifically, the temperature detecting element 25 may be a thermocouple detecting element or a thermistor detecting element and the like. In a case that the temperature detecting element 25 is a thermocouple detecting element, the detection point 251 of the thermocouple detecting element is a connection point of the two heat electrodes; and in a case that the temperature detecting element 25 is a thermistor detecting element, the detection point 251 of the thermistor detecting element is a position of the thermistor. After obtaining the temperature of the high temperature zone 23, the steam generator of the present disclosure may adjust the heating power of the heating part 21, thereby ensuring that the heating body can properly heat the water into high temperature steam.

Further, in an embodiment of the present disclosure, as shown in FIGS. 1 and 3, in order to avoid an explosion accident of the steam generator due to a malfunction such as poor water intake, dry burning, or excessive heating power, a temperature control switch 8 is provided in the bottom of the housing 1, which can turn off the heating part 21 when the temperature of the housing 1 exceeds a set temperature, and restart the heating part 21 when the temperature of the housing 1 falls below the a temperature. With the temperature control switch 8, it can prevent the temperature of the steam generator from being too high and thus causing accidents.

As shown in FIGS. 1 and 4, in an embodiment of the present disclosure, the air outlet 4 is located on the housing 1 at a position corresponding to the scale deposit chamber 15, and a filter assembly 16 is provided in the scale deposit chamber 15, and the filter assembly 16 covers the air outlet 4. The high temperature steam is configured to be sprayed out from the air outlet 4 after passing through the filter assembly 16. As the filter assembly 16 is arranged in the scale deposit chamber 15, scale particles that fail to deposit and have a particle size larger than the hole size of the filter to be retained by the filter assembly 16 when the steam passes through the filter assembly 16, avoiding that the scale sprayed out from the air outlet 4 carries scale particles with large particle sizes, which may subsequently cause clogging of the air outlet.

As shown in FIG. 2, in an embodiment of the present disclosure, the first air outlet 41 and the second air outlet 42 both protrude outwardly, and an air outlet chamber 43 is enclosed between the sidewall of the first air outlet 41 or the second air outlet 42 and the filter assembly 16. With the air outlet chamber, the tendency of the high temperature steam to flow toward the air outlet 4 can be enhanced, thereby increasing the flow rate of steam at the air outlet 4.

As shown in FIG. 6, in another embodiment of the present disclosure, the steam generator includes a housing 1 and a heating body 2. The housing 1 may be made of aluminum alloy, a heating chamber 11 is formed inside the housing 1, and a water inlet 3 and an air outlet 4 that are in connection with the heating chamber 11 are arranged in the housing 1. The heating chamber 11 may thus be filled with water through the water inlet 3, and the water entering the heating chamber 11 from the water inlet 3 is heated into steam under the action of the heating body 2 and sprayed through the air outlet 4.

As shown in FIG. 6, along the axial direction of the steam generator, the steam generator has opposite first end and second end. The heating body 2 is arranged in the heating chamber 11, and the heating body 2 extends in the heating chamber 11 along the direction from the first end to the second end. Specifically, the heating body 2 is fixed with a flange 5 at a position adjacent to the first end, and the heating body 2 is connected to the open end of the housing 1 by the flange 5, so that the heating body 2 can extend in the heating chamber 11 and be suspended in the heating chamber 11, with a certain spacing between the outer surface of the heating body 2 and the inside wall of the heating chamber 11.

The flange 5 may be fixed to the surface of the first end of the heating body 2 by welding or in a manner known to those skilled in the art, the outer surface of the flange 5 is provided with an external thread, and the open end of the housing 1 may be provided with an internal thread, so that the flange 5 may be fixed to the open end of the housing 1. In order to ensure the sealing effect between the flange 5 and the housing 1, as shown in FIG. 6, a sealing ring 6 may also be provided in the flange 5, the sealing ring 6 is used for sealing the gap between the flange 5 and the housing 1, avoiding water from flowing out of the housing 1.

It is to be understood that the water inlet 3 on the housing 1 may be connected to a water storage tank and a water pump, and the water pump may pump water in the water storage tank to the heating chamber 11 via the water inlet 3. The air outlet may be connected to the air jet head, so that steam generated by the steam generator can be delivered to the air jet head and then dispersed to various air jet nozzles and sprayed out.

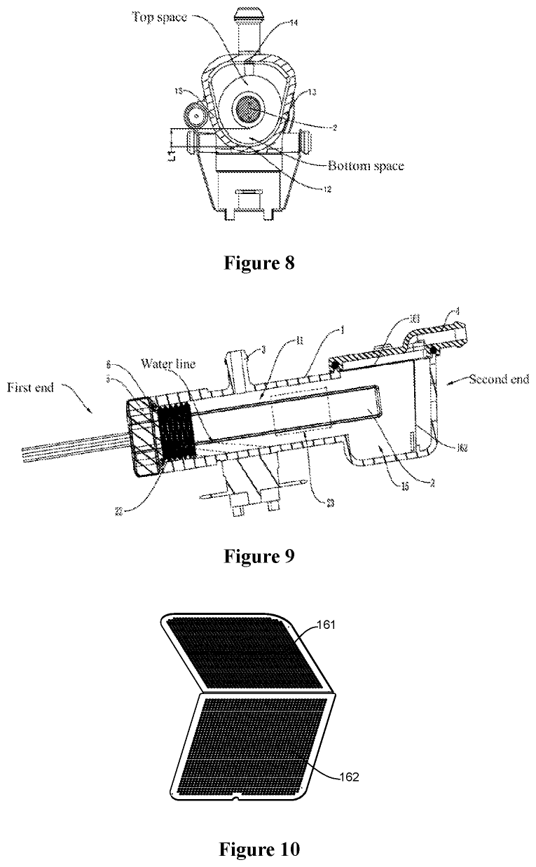

As shown in FIG. 8, in the heating chamber 11 of the steam generator of the present disclosure, the space above the heating body 2 is larger than the space below thereof. The space above the heating body refers to a zone between the upper surface of the heating body and the housing, and the space below the heating body refers to a zone between the lower surface of the heating body and the housing. When water is injected into the heating chamber of the housing from the water inlet, the water will flow toward the bottom space of the heating body under the effect of gravity.

Since the specific gravity of the steam is less than the specific gravity of the scale particles, even if the bottom space of the heating body 2 is filled with scale, as long as there is still space above the heating body 2, the steam formed by the heating body 2 can reach the air outlet 4 from the top of the heating body 2 and to be sprayed out from the air outlet 4. This extends the time required for the scale to fill the space above of the heating body 2, so as extend the service life of the steam generator, thereby reducing the frequency of replacement of the steam generator, thus reducing the cost of using the steam generator.

In an embodiment of the present disclosure, as shown in FIG. 8, the housing 1 includes a first enclosure part 12 arranged below the heating body 2, and a flaring part 13 connected to the first enclosure part 12 and inclined to an outer side of the heating body 2 from a position connected to the first enclosure part 12, and further includes a second enclosure part 14 arranged above the heating body 2 and connected to the flaring part 13. The first enclosure part 12, the flaring part 13, and the second enclosure part 14 enclose the heating chamber 11, which may be integrally molded. In this regard, since the flaring part 13 is inclined to the outside of the heating body 2, the internal space enclosed by the flaring part 13 and the second enclosure part 14 is significantly larger than the internal space located below the heating body 2 that is enclosed by the flaring part 13 and the first enclosure part 12, so that it can be effectively ensured that the space above the heating body 2 is larger than the space below the heating body 2.

As shown in FIG. 8, in an embodiment of the present disclosure, the first enclosure part 12, the second enclosure part 14 both have a circular arc shape, and the radius of curvature of the first enclosure part 12 is smaller than the radius of curvature of the second enclosure part 14. As the first enclosure part 12 is circular arc-shaped, and the cross-section of the heating body 2 is circular, the center of the first enclosure part 12 can coincide with the center of the heating body 2, which ensures that the distances between the various positions of the first enclosure part 12 and the heating body 2 are equal, so that the water entering the bottom of the heating body 2 can contact with the heating body 2 more quickly. From another perspective, only a small amount of water can contact with the heating body 2, to avoid that more water is required due to a large space at the bottom of the heating body 2, which affects the heating efficiency of the steam generator. That is, all the water in the first enclosure part 12 can be well heated to form a mixture of gaseous water and high temperature liquid water.

The second enclosure part 14 above the heating body 2 has a circular shape. Since the flaring part 13 is inclined to the outer side of the heating body 2, the distance between the ends of the second enclosure part 14 is larger than the distance between the ends of the first enclosure part 12, in order to maximize the space above the heating part without increasing the overall dimension of the housing 1, the second enclosure part 14 is also required to have a circular arc shape, and the radius of curvature of the second enclosure part 14 is larger than the radius of curvature of the first enclosure part 12, so as to ensure the space above the heating body 2 while minimizing the size of the steam generator.

As shown in FIG. 8, in an embodiment of the present disclosure, the distance L1 between the bottom of the heating body 2 and the first enclosure part 12 meets the following relationship: 1.5 mm≤L1≤4.5 mm. If L1 is too small, the heat generated by the heating body 2 will be transferred to the surface of the housing 1 and emitted to the outside, which affects the heating efficiency of the heating body 2. If L1 is too large, too much water needs to be added to the heating chamber 11 to make water contact with the heating body 2, and too much water will seriously affect the efficiency of generating steam. In the embodiment of the present disclosure, the distance L1 between the bottom of the heating body 2 and the first enclosure part 12 is between 1.5 mm and 4.5 mm, which can avoid the heat of the heating body 2 from being transferred to the surface of the housing 1, and can also enable a small amount of water to contact the surface of the heating body 2, thereby ensuring the heating efficiency of the heating body 2, and ensuring the generation rate of steam.

Further, as shown in FIG. 8, in an embodiment of the present disclosure, opposite sides of the first enclosure part 12 extend at least above the bottom of the heating body 2. This ensures that the heating body 2 is at an equal distance from each position of the first enclosure part 12, which facilitates the water in the first enclosure part 12 to contact with the heating body 2 as quickly as possible. It should be noted herein that the present disclosure only divides the enclosing sidewall of the heating chamber 11 into the first enclosure part 12, the flaring part 13, and the second enclosure part 14 for the sake of convenience of description. Actually, when the housing 1 is molded in one piece, the two adjacent parts are continuous.

In order for the steam generator to generate a sufficient amount of steam, in an embodiment of the present disclosure, the steam generator is configured to allow only a portion of the heating body 2 to be covered with water, and to maintain the surface of the other portion of the heating body 2 not covered with water at a maximum temperature of 280-580° C., so as to allow at least a portion of the water entering the steam generator from the water inlet 3 to be formed into steam that is then sprayed out from the air outlet 4.

The term “cover” in the present disclosure means that water in the heating chamber 11 is in contact with at least the bottom of the heating body 2 at an axial position, or extends from the bottom to a position at the sidewall, or covers the entire surface of the heating body 2 at that axial position. It should be noted that, when the temperature of the heating body 2 increases, the water covering the position of the heating body 2 will in a boiling state, the boiling water will be in a “jumping” state at some zone of the heating body 2, the state should also be understood as water covering the heating body 2. That is, the heating body 2 is heated as a whole, when the heating body 2 is raised to a predetermined temperature, water is injected into the heating chamber 11 through the water inlet 3, and the injected water will in a “jumping” state when the heating body 2 is raised to a predetermined temperature, and this state should also be understood as water covering the heating body 2.

The surface of the other portion of the heating body 2 not covered with water maintaining at a maximum temperature of 280-580° C. means that in the axial direction of the heating body 2, in the surface away from the zone of the heating body 2 covered with water, at least a portion of the surface of the other portion of the heating body 2 not covered with water maintains at the temperature of 280-580° C.; it can be that the entire surface maintains at a temperature of 280-580° C., or it can be that a portion of the surface maintains at a temperature lower than 280° C.

After a number of tests, when the surface of the other portion of the heating body 2 not covered with water has a maximum temperature of 280-580° C., the flow rate of the formed steam is very large, showing pure white steam with high visibility, thus the user can easily observe the steam.

In order to further improve the steam spray effect of the steam generator, in an embodiment of the present disclosure, the steam generator is configured to maintain the surface of the other portion of the heating body 2 not covered with water at a maximum temperature of 350-400° C. After a number of tests, when the surface of the other portion of the heating body 2 not covered with water maintains at the maximum temperature of 350-400° C., the amount of steam sprayed by the steam generator is large, thus the user can easily see that the steam generator is spraying steam normally.

As shown in FIG. 6, in an embodiment of the present disclosure, when the steam generator is in use, the heating body 2 is gradually inclined upward in the direction from the first end to the second end, i.e., the height of the first end of the heating body 2 is lower than the height of the second end.

In this way, during the use of the steam generator, due to the different specific gravity of the scale particles and the water, and the gradual upward inclination of the heating body 2 in the direction from the first end to the second end, the steam mixed with the scale particles will be continuously deposited downwardly as the steam moves from the heating zone 22 to the high temperature zone 23. When the steam reaches the air outlet 4, the content of the scale particles in the steam has been greatly reduced, thereby preventing the scale particles from flowing out of the air outlet 4 which may clog subsequent structures such as the air jet nozzle.

As shown in FIG. 6, in an embodiment of the present disclosure, the water inlet 3 is arranged on the housing 1 at a position higher than the heating body 2. In this way, water may fall onto the heating body 2 from above the heating body 2. Since the specific gravity of the scale particles is large, the water inlet 3 being arranged above the heating body 2 can effectively prevent a large number of scale particles from being deposited into the water inlet 3, thereby avoiding a malfunction of the steam generator due to the rapid clogging of the water inlet 3, and thus prolonging the service life of the steam generator.

In an embodiment of the present disclosure, the distance between the center axis of the water inlet 3 and the end surface of the flange 5 is 0 mm≤L2≤30 mm. Since 0 mm≤L2≤30 mm, it can be effectively avoided that the water falling from the water inlet 3 is too close to the high-temperature zone 23 of the heating body 2, thereby ensuring that the water entering from the water inlet 3 can be effectively heated by the heating zone 22, which can effectively generate a mixture of gaseous water and high-temperature liquid water. The mixture of gaseous water and high-temperature liquid water then generates steam with good visibility when the mixture of gaseous water and high-temperature liquid water reaches the high-temperature zone 23.

Further, as shown in FIG. 6, in an embodiment of the present disclosure, the scale deposit chamber 15 is arranged on the housing 1 at a position corresponding to the high temperature zone 23 of the heating body 2, the scale deposit chamber 15 is in communication with the heating chamber 11, and the bottom of the scale deposit chamber 15 is configured to be lower than the bottom of the heating chamber 11. The steam has a certain momentum during the flow towards the outlet 4, so that when the steam mixed with the scale particles is flowing towards the outlet 4, the scale particles will deposit in the scale deposit chamber 15 under the effect of gravity, thereby slowing down the deposition rate of the scale on the surface of the heating body 2 or on the inside wall of the heating chamber 11, and thus prolonging the service life of the steam generator. In addition, water boils at the position of the heating zone 22, and this boiling water pushes or bounces scale into the scale deposit chamber 15, thereby reducing the deposition of scale on the heating chamber 11 and the heating body 2.

As shown in FIGS. 6 and 9, in an embodiment of the present disclosure, the air outlet 4 is arranged on the housing 1 at a position corresponding to the scale deposit chamber 15. A filter assembly 16 is arranged in the scale deposit chamber 15, and the high temperature steam is sprayed out from the air outlet 4 after passing through the filter assembly 16. As the filter assembly 16 is arranged in the scale deposit chamber 15, scale particles that fail to deposit and have a particle size larger than the hole diameter of the filter to be retained by the filter assembly 16 when the steam passes through the filter assembly 16, so as to avoid that the scale sprayed out from the air outlet 4 has scale particles with a large particle size, which may cause the subsequent clogging of the air jet nozzle.

As shown in FIG. 6, in an embodiment of the present disclosure, the air outlet 4 is arranged on an end surface of the second end of the housing 1, and the filter assembly 16 is configured to cover the air outlet 4, and the filter assembly 16 can effectively retain scale particles that fail to deposit and have a particle size larger than the mesh diameter of the filter, preventing some of the scale particles from being sprayed out from the air outlet 4 bypassing the filter assembly 16.

As shown in FIGS. 9 and 10, in another embodiment of the present disclosure, the air outlet 4 is arranged at a top position adjacent to the second end of the housing 1. The filter assembly 16 includes a first filter 161 arranged above the scale deposit chamber 15 and covering the air outlet 4, and a second filter 162 connected to the first filter 161 and extending to the bottom of the scale deposit chamber 15. Since the filter assembly 16 includes a first filter 161 arranged above the scale deposit chamber 15 and covering the air outlet 4 and a second filter 162 connected to the first filter 161 and extending to the bottom of the scale deposit chamber 15, the area of the overall filter assembly 16 is larger than the area of the filter assembly 16 with only a single filter, which slows down the rate of clogging of the filter assembly 16, thereby prolonging the service life of the steam generator.

As shown in FIGS. 6 and 9, in an embodiment of the present disclosure, there is a spacing between the filter assembly 16 and the inside wall of the housing 1. In this way, compared with the arrangement that the filter assembly 16 covers the outlet 4, in a case that a portion of the filter assembly 16 is clogged with scale particles, steam can pass through other zones of the filter assembly 16 to be sprayed out from the air outlet 4, thereby slowing down the rate of the entire filter being clogged with scale particles, thus prolonging the service life of the filter assembly 16.

As shown in FIGS. 6 and 9, in an embodiment of the present disclosure, the center axis of the air outlet 4 is higher than the bottom of the second end of the heating body 2. Setting the air outlet 4 at a higher position avoids the scale particles from being sprayed out from the air outlet 4 when moving with the steam toward the air outlet 4. In addition, large water droplets having a certain specific gravity can be avoided from being sprayed out from the air outlet 4, so that the spray efficiency of steam can be ensured. Moreover, the steam will move upwardly, and the center axis of the air outlet 4 is higher than the bottom of the second end of the heating body 2, which facilitates the rapid spray of the steam from the air outlet 4, instead of the circulation flow in the housing 1.

As shown in FIG. 7, the heating body 2 of the present disclosure is provided with a heating part 21 for generating heat inside the heating body 2, and the heating part 21 also extends along the direction from the first end to the second end. During the use of the steam generator, water will enter the heating chamber 11 from the water inlet 3, and then a portion of the water will boil under the action of the heating body 2, and a portion of the high temperature liquid water will be splashed out by the boiling steam, thereby forming a mixture of gaseous water and high temperature liquid water. The mixture of gaseous water and high-temperature liquid water is sufficiently heated by the heating body 2 to generate a steam with good visibility, which is sprayed out from the air outlet 4.

In order to facilitate determining the temperature of the high temperature zone 23, as shown in FIGS. 6 and 7, in an embodiment of the present disclosure, the heating body 2 is provided with a temperature detecting element 25, and a detection point 251 of the temperature detecting element 25 is set at a position of the high temperature zone 23, and is used to measure the temperature of the high temperature zone 23. Specifically, the temperature detecting element 25 may be a thermocouple detecting element or a thermistor detecting element, and the like. In a case that the temperature detecting element 25 is a thermocouple detecting element, a connection point of two heat electrodes is the detection point 251 of the thermocouple detecting element; in a case that the temperature detecting element 25 is a thermistor detecting element, the position of the thermistor is the detection point 251 of the thermistor detecting element.

Further, in an embodiment of the present disclosure, a control unit (not shown in the figures) is further provided. The control unit is configured to control a heating power of the heating body 2 and the flow rate of water from the water inlet 3 into the heating chamber 11 based on a temperature collected by the temperature detecting element 25. Specifically, when the maximum surface temperature of the high temperature zone 23 is lower than 280° C., the control unit may control the water pump to reduce the flow rate of the water entering the heating chamber 11 or increase the heating power of the heating part 21; when the maximum surface temperature of the high temperature zone 23 is higher than 580° C., the control unit may control the water pump to increase the flow rate of the water entering the heating chamber 11 or to reduce the heating power of the heating part 21 or to directly turn off the heating part 21.

In order to avoid an explosion accident due to a malfunction of the steam generator generates such as poor water intake, dry burning, or excessive heating power, as shown in FIG. 6, the housing 1 is further provided with a temperature control switch 8 and a temperature fuse 7 at the outer side, the temperature control switch 8 may turn off the heating part 21 when the temperature of the housing 1 exceeds a set temperature and restart the heating part 21 when the temperature of the housing 1 falls below the set temperature. The temperature fuse 7 may automatically fuse to cut off the power supply of the heating part 21 when the temperature of the housing 1 is higher than a melting temperature. With the temperature control switch 8 and the temperature fuse 7, the steam generator can be prevented from being overheated and causing accidents.

As shown in FIG. 6, in an embodiment of the present disclosure, in the axial direction of the steam generator, the relative position between the side wall of the scale deposit chamber 15 adjacent to the first end and the detection point 251 is within 10 mm. That is, taking the detection point 251 as a reference, the sidewall of the deposit chamber 15 adjacent to the first end is at most 10 mm closer in the direction where the first end is located, or 10 mm closer in the direction where the second end is located.

When the side wall of the deposit chamber 15 adjacent to the first end is too close to the first end of the steam generator, the mixture of gaseous water and high temperature liquid water will enter the deposit chamber 15 in large quantities before contacting the high temperature zone 23, which cause the mixture of gaseous water and high temperature liquid water not be heated up sufficiently, and will be difficult to generate steam with good visibility. When the side wall of the scale deposit chamber 15 adjacent to the first end is too close to the second end of the steam generator, scale particles in the mixture of gaseous water and high temperature liquid water will be deposited in large quantities below the high temperature zone 23 and will not be able to enter the scale deposit chamber 15, which cause the space below the high temperature zone 23 to be filled with scale quickly, and thus reduce the service life of the steam generator.

Therefore, when the relative position of the side wall of the scale deposit chamber 15 adjacent to the first end is within 10 mm with respect to the detection point 251, it can be ensured that the mixture of gaseous water and high-temperature liquid water can be sufficiently heated to generate steam with good visibility, and it can also be avoided that the space below the high-temperature zone 23 is quickly filled with scale, thus prolonging the service life of the steam generator.

In the embodiment of the present disclosure, the amount of water entering the heating chamber 11 needs to be adjusted, and if there is too much water, the temperature and area of the high temperature zone will be affected, affecting the steam effect. In addition, if there is too much water in the heating chamber 11, the boiling water will be sprayed out from the air outlet 4 along with the steam, affecting the visualization effect the steam. Based on this, in an embodiment of the present disclosure, the amount of water added to the heating chamber 11 is set so that the water does not splash out of the air outlet when it is heated to boiling in the heating chamber 11. For example, in a specific embodiment of the present disclosure, the water in the heating chamber 11 does not cover exceed one-third of the length of the heating body 2.

An intelligent device is further provided according to the present disclosure, which may be a device that needs to spray steam such as a cordless steam scrubber, a cordless steam mop, or a cordless eye smoker, and the intelligent device is provided with the aforementioned steam generator. For functions of the various structures of the steam generator, reference may be made to the above description, which will not be repeated herein.

In the existing cleaning device, in order to ensure that the water can fully contact the heating apparatus for heat exchange, the heating temperature of the heating apparatus is usually set to 100-150° C. In this case, the Leidenfrost phenomenon will not occur in the heating apparatus, thus visible water mist cannot be generated although the heating apparatus can generate steam.

A cleaning device is further provided according to the present disclosure, which includes a body, a heating apparatus and an air jet head. The heating apparatus includes a housing and a heating body, the housing has an internal chamber inside, the heating body is arranged in the internal chamber, and the internal chamber is provided with a water inlet at one end and an air outlet at the other end. During the operation of the heating apparatus of the present disclosure, water will cover only a portion of the heating body after entering the internal chamber from the water inlet, and the surface of the other portion of the heating body not covered with water will maintain at a temperature of 280-580° C. In this way, when a portion of water contacts with the other portion of the heating body not covered with water, it will be rapidly heated and atomized, and the water mist thus formed will be sprayed out from an air jet nozzle of the air jet head as the air jet head is connected with the air outlet.

Compared with existing cleaning devices, a user can clearly see the water mist sprayed from the air jet nozzle during the use of the cleaning device of the present disclosure.

For ease of understanding, the specific structure of the cleaning device of the present disclosure and its operation principle are described in detail below in connection with an embodiment with reference to FIGS. 12 to 17.

As shown in FIGS. 12 and 13, a cleaning device is provided according to the present disclosure, which includes a body 90, a heating apparatus 20, and an air jet head.

As shown in FIG. 12, the body 90 is configured as a carrier for mounting various functional elements required for the cleaning device, and the functional elements of the cleaning device include at least the heating apparatus 20 and the air jet head.

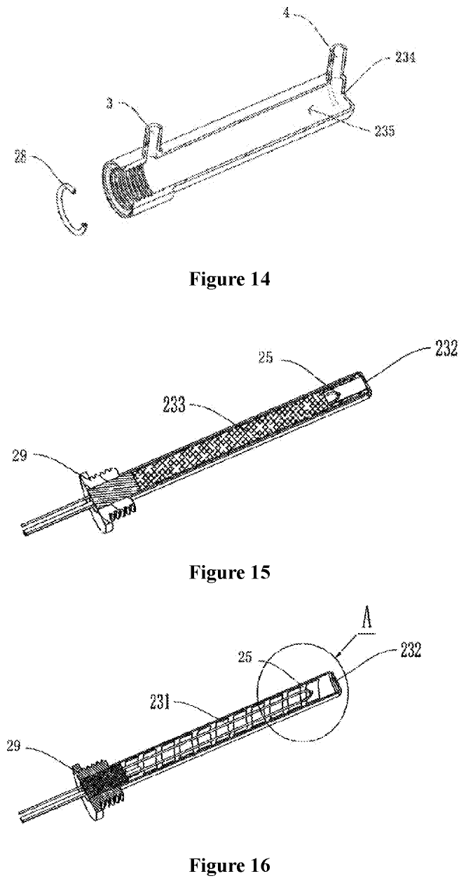

The heating apparatus 20 is arranged on the body 90, and as shown in FIGS. 13 and 14, the heating apparatus 20 includes a heating body housing 234 and a heating body 2, the heating body housing 234 has a heating body chamber 235 inside as well as a water inlet 3 and an air outlet 4 in communication with the heating body chamber 235. The heating body 2 extends from one end of the heating apparatus 20 into the heating body chamber 235 of the heating apparatus 20.

The heating apparatus 20 is configured to allow only a portion of the heating body 2 to be covered with water and to maintain the surface of the other portion of the heating body 2 not covered with water at a maximum temperature of 280-580° C., so that at least a portion of the water entering the heating apparatus 20 from the water inlet 3 is heated and atomized and then sprayed out from the air outlet 4. The surface of the other portion of the heating body 2 not covered with water maintaining at the maximum temperature of 280-580° C. means that at least a portion of the surface of the other portion of the heating body 2 not covered with water maintains at the temperature of 280-580° C., which may be that all of the surface maintains at the temperature of 280-580° C., or a portion of the surface maintains at the temperature of 280-580° C. and the temperature of another portion of the surface is less than 280° C.

The air jet head (not shown in the figure) is provided with a steam path inside the air jet head, the steam path is interconnected with the air outlet 4 of the heating apparatus 20, and the air jet head is provided with at least one air jet nozzle 902.

It will be appreciated that the cleaning device of the present disclosure may further include a water supply assembly such as a water storage tank and an infusion pump (which are not shown in the figures) and a cleaning assembly such as a roller brush for scrubbing the process surface. The infusion pump is used to pump water from the water storage tank into the heating body chamber 235 of the heating apparatus 20, and then the heating body 2 heats the water to generate a water mist.

As shown in FIG. 12, in an embodiment of the present disclosure, the air jet nozzle 902 and the roller brush 901 are arranged on the bottom surface of the body 90. When the cleaning device is performing cleaning, the heating apparatus 20 is controlled to spray water mist from the air jet nozzle 902 to brush a process surface while the roller brush 901 is controlled to rotate to scrub the process surface.

Specifically, the steam spraying process of the cleaning device of the present disclosure may include the following steps.

The cleaning device receives a command to spray steam, the infusion pump and the heating apparatus 20 are activated, and water in the reservoir is continuously pumped by the infusion pump to the water inlet 3 of the heating apparatus 20.

After entering the heating apparatus 20 from the water inlet 3, the water will cover a portion of the heating body 2, which has a low temperature, usually below 100° C., while the surface of the other portion of the heating body 2 not covered with water maintains at a maximum temperature of 280-580° C., which is higher than the Leidenfrost temperature of water. The water located in a portion of the heating body 2 covered with water will be repeatedly flushed to the other portion of the heating body 2 not covered with water during the boiling process, and since the temperature of this portion of the heating body 2 is higher than the Leidenfrost temperature of the water, this portion of the water will in a membrane boiling state on the surface of the other portion of the heating body 2 not covered with water. In the membrane boiling state, the heating body 2 is indirectly conducting heat to water inside by means of an air film attached to the surface. Since the heat conduction coefficient of steam is much smaller than the heat conduction coefficient of water, the boiling speed of water is thereby greatly reduced, so that a portion of the water is broken up into water mist during the flushing process before boiling.

The water mist flows out of the air outlet 4 of the heating apparatus 20, passes through the steam path, and is finally sprayed out from the air jet nozzle 902 of the air jet head, so that the user can see that the cleaning device is spraying water mist normally.

After a number of tests, it has been found that if the surface of the other portion of the heating body 2 not covered with water maintains at the maximum temperature of 280-580° C., the flow rate of water mist sprayed out from the air jet nozzle 902 is large, presenting a pure white water mist with high visibility, so that the user can easily observe the water mist.

Specifically, as shown in FIG. 13, in an embodiment of the present disclosure, the opposite ends of the heating body 2 are noted as a first end and a second end. The first end is higher than the second end when the cleaning device is arranged on a horizontal surface, and the first end is configured to maintain a maximum surface temperature of 280-580° C. In the operation of the heating apparatus 20 of the present disclosure, after entering the heating apparatus 20 from the water inlet 3 below, water will flow gradually upward from below. The water is continuously heated during the flow process, and when the water comes into contact with the other portion of the heating body 2 not covered with water, at least a portion of the water will be heated and atomized, and the water mist will then be sprayed along the heating apparatus, and out of the air outlet 4 above.

In order to further improve the spraying effect of water mist of the cleaning device, in an embodiment of the present disclosure, the heating apparatus 20 is configured to maintain the surface of the other portion of the heating body 2 not covered with water at the maximum temperature of 350-400° C. With a number of tests, it has found that when the heating apparatus 20 is configured to maintain the surface of the other portion of the heating body 2 not covered with water at the maximum temperature of 350-400° C., the amount of water mist sprayed out from the cleaning device is large, and a user can easily see that the cleaning device is spraying water mist normally.

As shown in FIG. 13, in an embodiment of the present disclosure, the second end is fixed to the bottom of the heating body chamber 235, and there is a spacing between the first end and the top of the heating body housing 234. In this way, the first end is in a suspended state and does not contact the top of the heating body housing 234, thereby avoiding the first end from transferring a high amount of heat to the heating body housing 234, which may cause a high temperature of the heating body housing 234 and thus burn other objects. In fact, in a case that there is water inside the heating apparatus 20, even if the first end reaches the temperature of more than 300° C., the temperature of the outer surface of the heating body housing 234 will basically not exceed 120° C.

As shown in FIG. 13, in an embodiment of the present disclosure, the heating apparatus 20 is arranged on the body 90 at an angle to the horizontal plane. In this way, during the operation of the heating apparatus 20 of the present disclosure, after entering the heating apparatus 20 from the water inlet 3 below, water will cover only a portion of the heating body 2, thereby naturally dividing the heating body 2 into a portion covered with water and another portion not covered with water without the need to set additionally.

As shown in FIGS. 15 and 16, in an embodiment of the present disclosure, the heating body 2 includes a heating wire 231, a heat-conducting rod 233, and a heating body housing 232. The heating wire 231 is wrapped around the heat-conducting rod 233, and the heating wire 231 extends from a zone of a first end to a zone of a second end. Both the heat-conducting rod 233 and the heating wire 231 are arranged in the heating body housing 232. The material of the heating body housing 232 may be stainless steel. The heat-conducting rod 233 is used to rapidly conduct the heat generated by the heating wire 231.

In an embodiment of the present disclosure, the material of the heat-conducting rod 233 may be magnesium oxide. In a case that the material of the heat-conducting rod 233 is magnesium oxide, not only the heat generated by the heating wire 231 can be rapidly transferred to the heating body housing 232, which in turn heats the water to generate water mist, but also the heating wire 231 can be effectively prevented from contacting with the heating body housing 232.

In an embodiment of the present disclosure, magnesium oxide powder is filled between the heat-conducting rod 233 and the heating body housing 232, to improve the heat conduction efficiency of the heating body 2, avoiding heat from being detained in the heating wire 231, and avoiding contact between the heating wire 231 and the heating body housing 232, which results in power leakage.

As shown in FIGS. 15 and 16, in an embodiment of the present disclosure, the end of the heating body 2 is further provided with an insulating sealing part 29. The insulating sealing part 29 is sealingly arranged at an open end of the heating body housing 234 and is fixedly connected to the second end. The insulating sealing part 29 has two purposes, one is to seal water inside the heating body housing 234 to avoid the water from flowing out of the heating body housing 234, and the other is to prevent the heating wire from conducting with the outside to avoid power leakage.

As shown in FIG. 13, in an embodiment of the present disclosure, the heating body 2 is arranged separately from the heating body housing 234. The first end is in a suspended state as previously described and does not contact with the heating body housing 234. The second end is only fixedly connected to the insulating sealing part 29 and does not contact the heating body housing 234, so as to avoid the first end and the second end from transferring heat to the heating body housing 234, preventing the heating body housing 234 from burning other objects due to the excessively high temperature. In order to further improve the sealing effect, as shown in FIG. 14, in an embodiment of the present disclosure, a sealing ring 6 may further be set in the insulating sealing part 29, and the sealing ring 6 is used to arrange the insulating sealing part 29 and the heating body housing 234 into sealing contact, further avoiding water from flowing out of the heating body housing 234.

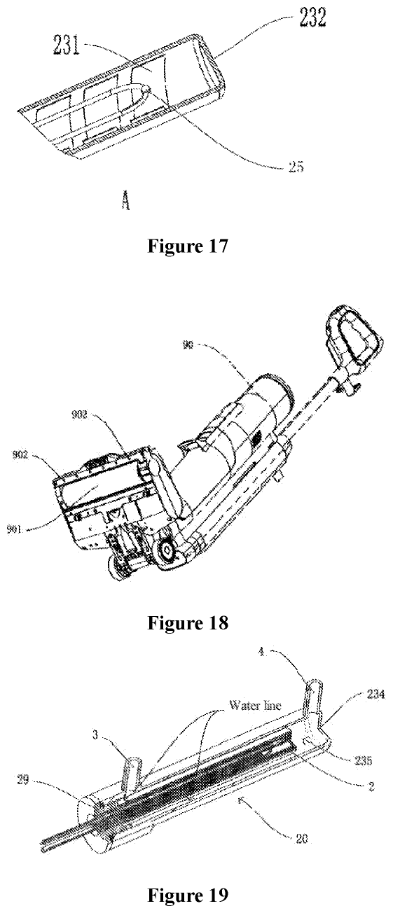

In order to control the temperature of the first end of the heating body 2, as shown in FIG. 17, in an embodiment of the present disclosure, the heating apparatus 20 further includes a temperature detecting element 25 and a control unit (not shown in the figure), the temperature detecting element 25 is configured to detect a temperature of the first end, and the control unit is configured to control a heating power of the heating body 2 based on a temperature detecting result of the temperature detecting element, so as to maintain the surface of the first end at a maximum temperature of 280-580° C.

As shown in FIG. 17, in an embodiment of the present disclosure, a detection point of the temperature detecting element 25 is set at an interior of the heat-conducting rod 233 arranged at the first end. Since the heat-conducting speed of the heating body 2 is large, the temperature measured when the temperature detecting element 25 is arranged at the interior of the heat-conducting rod 233 located at the first end may be considered as the temperature of the first end.

As shown in FIG. 17, the temperature detecting element 25 may be a thermocouple detecting element or other kinds of detecting elements. If the temperature detecting element 25 is a thermocouple detecting element, the measuring end of the thermocouple detecting element is set inside the first end.

A heating apparatus 20 is further provided according to the present disclosure, which included a heating body housing 234 and a heating body 2, the heating body housing 234 has a heating body chamber 235 inside and a water inlet 3 and an air outlet 4 that are in communication with the heating body chamber 235. The heating body 2 is arranged in the heating body chamber 235. The heating apparatus 20 is configured to allow only a portion of the heating body 2 to be covered with water and to maintain the surface of the other portion of the heating body 2 not covered with water at a maximum temperature of 280-580° C., to allow at least a portion of the water entering the heating apparatus from the water inlet 3 to be heated and atomized and then sprayed out from the air outlet 4. For the functions of the individual structures, reference may be made to the above description of the heating apparatus 20, which will not be repeated herein.

In existing cleaning devices, in order to ensure that water can fully contact with the heating apparatus for heat exchange, the heating temperature of the heating apparatus is usually set to 100-150° C. In this case, the Leidenfrost phenomenon will not occur in the heating apparatus, and visible water mist cannot be generated although the heating apparatus can generate steam.

A cleaning device is provided according to the present disclosure, the cleaning device including a body, a heating apparatus and an air jet head. The heating apparatus includes a housing and a heating body, the housing has an internal chamber inside, the heating body is arranged in the internal chamber, and the internal chamber is provided with a water inlet at one end and an air outlet at the other end. During the operation of the heating apparatus of the present disclosure, water will cover only a portion of the heating body when entering the internal chamber from the water inlet, and the surface of the other portion of the heating body not covered with water will maintain at a temperature of 280-580° C. In this way, when a portion of the water comes into contact with the other portion of the heating body not covered with water, this portion of water will be rapidly heated and atomized, and the formed water mist will be sprayed out from the air jet nozzle of the air jet head as the air jet head is connected with the air outlet.

Compared with existing cleaning devices, a user can clearly see the water mist sprayed from the air jet nozzle during the use of the cleaning device of the present disclosure.

For ease of understanding, the specific structure of the cleaning device of the present disclosure and its operation principle are described in detail below with reference to FIGS. 18 to 30 in conjunction with an embodiment.

As shown in FIGS. 18 and 19, a cleaning device is provided according to the present disclosure, which includes a body 90, a heating apparatus 20 and an air jet head.

As shown in FIG. 18, the body 90 is configured as a carrier for mounting various functional elements required for the cleaning device, and the functional elements of the cleaning device include at least the heating apparatus 20 and the air jet head.

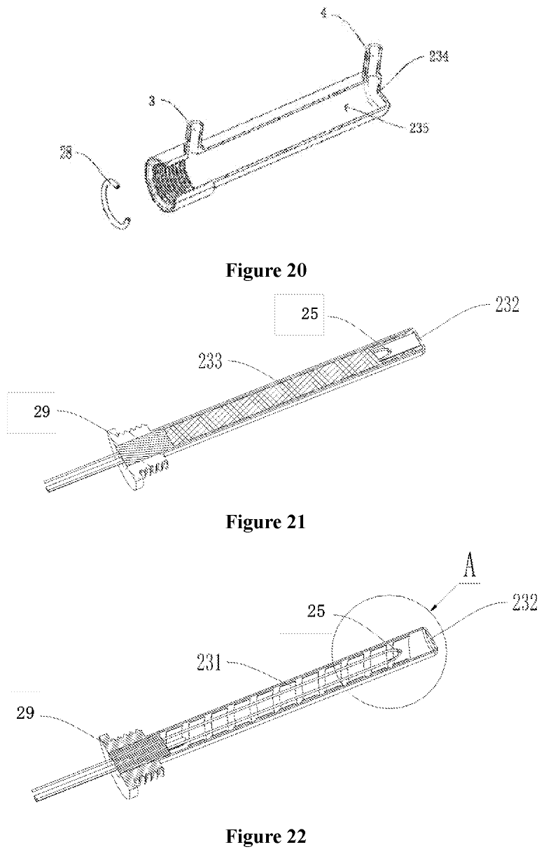

The heating apparatus 20 is arranged on the body 90, and as shown in FIGS. 19 and 20, the heating apparatus 20 includes a heating body housing 234 and a heating body 2, the heating body housing 234 has a heating body chamber 235 inside and a water inlet 3 and an air outlet 4 in communication with the heating body chamber 235. The heating body 2 extends from one end of the heating apparatus 20 into the heating body chamber 235 of the heating apparatus 20.

The heating apparatus 20 is configured to allow only a portion of the heating body 2 to be covered with water, and to maintain the surface of the other portion of the heating body 2 not covered with water at a maximum temperature of 280-580° C., so that at least a portion of the water entering the heating apparatus 20 from the water inlet 3 is heated and atomized and then sprayed out from the air outlet 4. The term “cover” in the present disclosure means that the water located in the internal chamber of the heating body housing 234 is at least in contact with the bottom of the heating body 2 at a certain axial position, or extends from the bottom to a position at the sidewall, or covers the entire surface of the heating body 2 at the axial position. It should be noted that when the temperature of the heating body 2 is increased, the water covering the heating body 2 will be boiling, and the boiling water will be in a “jumping” state in some zone of the heating body 2, which should also be understood as the water covering the heating body 2. Further, the temperature of the heating body 2 is increased as a whole, when the temperature of the heating body 2 is higher than a predetermined temperature, water is injected from the water inlet 3 to internal chamber the heating body housing 234, the injected water will in the “jumping” state when contact with the high-temperature heating body 2, which should also be understood as the water covering the heating body 2.

The surface of the other portion of the heating body 2 not covered with water maintaining at a maximum temperature of 280-580° C. means that in the axial direction of the heating body 2, in a zone that is away from the zone of the heating body covered with water, at least a portion of the surface of the other portion of the heating body 2 not covered with water maintains at the temperature of 280-580° C. The whole surface may maintain at a temperature of 280-580° C., or a portion of the surface maintains at a temperature of 280-580° C. and the other portion of the surface maintains at temperature below 280° C.

The air jet head (not shown in the figure) is provided with a steam path inside, the steam path is interconnected with the air outlet 4 of the heating apparatus 20, and the air jet head is provided with at least one air jet nozzle 902.

It will be appreciated that the cleaning device of the present disclosure may further include a water supply assembly such as a water storage tank and an infusion pump (which are not shown in the figures) and a cleaning assembly such as a roller brush for scrubbing the process surface. The infusion pump is configured to pump water from the water storage tank into the heating body chamber 235 of the heating apparatus 20, and then the heating body 2 heats the water to generate water mist.

As shown in FIG. 18, in an embodiment of the present disclosure, the air jet nozzle 902 and the roller brush 901 are arranged on the bottom of the body 90. When the cleaning device is performing cleaning, the heating apparatus 20 is controlled to spray water mist from the air jet nozzle 902 to brush the process surface while the roller brush 901 is controlled to rotate to scrub the process surface.

Specifically, the steam spraying process of the cleaning device of the present disclosure may include the following steps.

The cleaning device receives a command to spray steam, the infusion pump and the heating apparatus 20 are activated, and water in the reservoir is continuously pumped by the infusion pump to the water inlet 3 of the heating apparatus 20.

After entering the heating apparatus 20 from the water inlet 3, the water will cover a portion of the heating body 2, which has a low temperature, usually below 100° C., while the surface of the other portion of the heating body 2 not covered with water maintains a maximum temperature of 280-580° C., which is higher than the Leidenfrost temperature of water. The water located in the zone of the heating body 2 covered with water will be repeatedly flushed to the other portion of the heating body 2 not covered with water during the boiling process, and since the temperature of this portion of the heating body 2 is higher than the Leidenfrost temperature of water, this portion of water will in a membrane boiling state on the surface of the other portion of the heating body 2 not covered with water. In the membrane boiling state, the heating body 2 is indirectly conducting heat to the water inside through an air film attached to the surface. Since the heat conduction coefficient of steam is much smaller than the heat conduction coefficient of water, the boiling speed of water is thereby greatly reduced, so that a portion of the water is broken up into water mist during the flushing process before boiling.

The water mist flows out of the air outlet 4 of the heating apparatus 20, passes through the steam path, and is finally sprayed out from the air jet nozzle 902 of the air jet head, so that the user can see that the cleaning device is spraying water mist normally.

After a number of tests, it has been found that when the surface of the other portion of the heating body 2 not covered with water maintains at the maximum temperature of 280-580° C., the water mist sprayed out from the air jet nozzle 902 is large, showing a pure white water mist with high visibility, so that the user can easily observe the water mist.

Specifically, as shown in FIG. 19, in an embodiment of the present disclosure, the opposite ends of the heating body 2 are noted as a first end and a second end. The first end is higher than the second end when the cleaning device is arranged on a horizontal surface; and the first end is configured to maintain a maximum surface temperature of 280-580° C. During the operation of the heating apparatus 20 of the present disclosure, after entering the heating apparatus 20 from the water inlet 3 below, water flow gradually upward from below. The water is continuously heated during the flow process, and when the water comes into contact with the other portion of the heating body 2 not covered with water, at least a portion of the water will be heated and atomized, and the water mist will then be sprayed along the heating apparatus, and out of the air outlet 4 above.

In order to further improve the water mist spraying effect of the cleaning device, in an embodiment of the present disclosure, the heating apparatus 20 is configured to maintain the surface of the other portion of the heating body 2 not covered with water at the maximum temperature of 350-400° C. After a number of tests, it has been found that when the heating apparatus 20 is configured to maintain the surface of the other portion of the heating body 2 not covered with water at the maximum temperature of 350-400° C., the amount of water mist sprayed out from the cleaning device is large, and a user can easily see that the cleaning device is spraying water mist normally.

As shown in FIG. 19, in an embodiment of the present disclosure, the second end is fixed to the bottom of the heating body chamber 235, and there is a spacing between the first end and the top of the heating body housing 234. In this way, the first end is in a suspended state and does not contact the top of the heating body housing 234, thereby avoiding the first end from transferring a high amount of heat to the heating body housing 234, which may cause the temperature of the heating body housing 234 to be too high and burn other objects. In fact, in a case that there is water inside the heating apparatus 20, even if the temperature of the first end reaches more than 300° C., the temperature of the outer surface of the heating body housing 234 will basically not exceed 120° C.

As shown in FIG. 19, in an embodiment of the present disclosure, the heating apparatus 20 is arranged on the body 90 at an angle to the horizontal plane. In this way, during the operation of the heating apparatus 20 of the present disclosure, after entering the heating apparatus 20 from the water inlet 3 below, water will cover only a portion of the heating body 2, thereby naturally dividing the heating body 2 into a portion covered with water and another portion not covered with water without the need to set additionally.

As shown in FIG. 21, FIG. 22 and FIG. 24, in an embodiment of the present disclosure, the heating body 2 includes a heating wire 231, a heat-conducting rod 233, and a heating body housing 232. The heating wire 231 is wrapped around the heat-conducting rod 233, and the heating wire 231 extends from a zone at a first end to a zone at a second end. Both the heat-conducting rod 233 and the heating wire 231 are arranged in the heating body housing 232. The material of the heating body housing 232 may be stainless steel. The heat-conducting rod 233 is used to rapidly conduct the heat generated by the heating wire 231.

As shown in FIGS. 21 and 22, in an embodiment of the present disclosure, the end of the heating body 2 is further provided with an insulating sealing part 29. The insulating sealing part 29 is sealingly arranged at an open end of the heating body housing 234 and is fixedly connected to the second end. The insulating sealing part 29 has two purposes, one is to seal the water inside the heating body housing 234 to avoid the water from flowing out of the heating body housing 234, and the other is to prevent the heating wire from conducting with the outside to avoid power leakage.

As shown in FIG. 19, in an embodiment of the present disclosure, the heating body 2 is arranged separately from the heating body housing 234. The first end is in a suspended state as previously described and does not contact the heating body housing 234, and the second end is only fixedly connected to the insulating sealing part 29 and does not contact the heating body housing 234, so that the first end and the second end can be avoided from transferring heat to the heating body housing 234 and preventing the heating body housing 234 from burning other objects due to the excessively high temperature. In order to further improve the sealing effect, as shown in FIG. 20, in an embodiment of the present disclosure, a sealing ring 6 may further be provided in the insulating sealing part 29, and the sealing ring 6 is used to arrange the insulating sealing part 29 and the heating body housing 234 into sealing contact, further avoiding water from flowing out of the heating body housing 234.

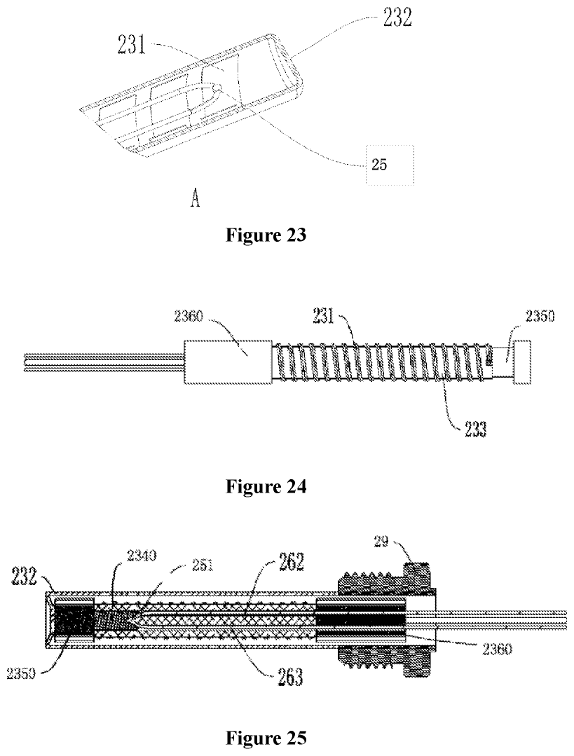

In order to control the temperature of the first end of the heating body 2, as shown in FIG. 23, in an embodiment of the present disclosure, the heating apparatus 20 further includes a temperature detecting element and a control unit (not shown in the figure), the temperature detecting element is configured to detect the temperature of the first end. The control unit is configured to control the heating power of the heating body 2 based on the temperature detecting result of the temperature detecting element, so as to maintain the surface of the first end at a maximum temperature of 280-580° C.

As shown in FIG. 23, in an embodiment of the present disclosure, a detection point of the temperature detecting element is set in the interior of the first end of the heat-conducting rod 233. Since the heat conducting speed of the heating body 2 is large, the temperature measured when the temperature detecting element is arranged in the interior of the first end of the heat-conducting rod 233 may also be considered as the temperature in the zone adjacent to the first end.

As shown in FIG. 23, the temperature detecting element may be a temperature detecting element 25 or other kinds of detecting elements. If the temperature detecting element is the temperature detecting element 25, the detection point 251 of the temperature detecting element 25 is arranged in the interior of the first end.

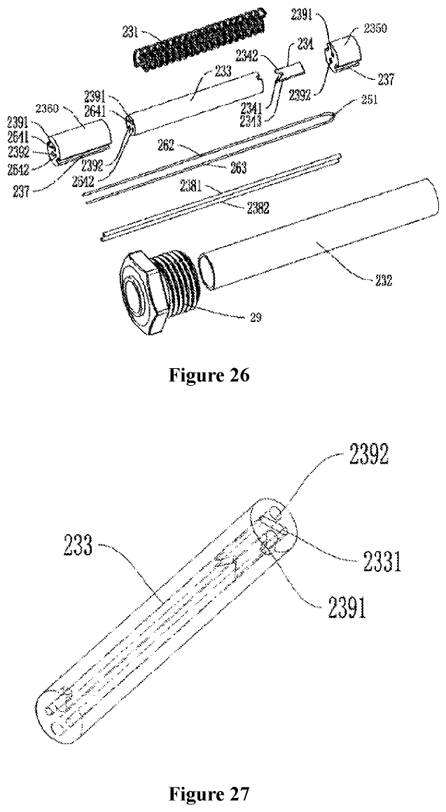

As shown in FIG. 24, FIG. 25, and FIG. 26, in an embodiment of the present disclosure, the heating body 2 further includes a front support part 2350 and a rear support part 2360. The front support part 2350 is arranged at the first end of the heat-conducting rod 233 and is configured to support the first end of the heat-conducting rod 233, the rear support part 2360 is arranged at the second end of the heat-conducting rod 233 and is configured to support the second end of the heat-conducting rod 233. Specifically, the front support part 2350 and the rear support part 2360 are arranged at the two ends of the heat-conducting rod 233, so that the heat-conducting rod 233 can be secured at both sides to avoid wobbling of the heat-conducting rod 233.

In an embodiment of the present disclosure, the heating body housing 232 is tightly fitted with the heat-conducting rod 233 after being shrunken, i.e., after the heating body housing 232 is shrunken, the heating body housing 232 may tightly fitted with the heat-conducting rod 233 as well as other components arranged in the heating body housing 232, so that the heat conduction efficiency of the heating body 2 can be effectively improved, and the stability between the various structures is also improved.

Further, as shown in FIG. 26, in an embodiment of the present disclosure, the radial dimensions of the front support part 2350 and the rear support part 2360 are larger than the radial dimension of the heat-conducting rod 233, and through grooves 237 extending in their axial directions are arranged on the outer walls of the front support part 2350 and the rear support part 2360, so that during the process of shrinking of the heating body housing 232, the front support part 2350 and the rear support part 2360 may be deformed at the through groove 237, which is conducive to the shrinking process of the heating body housing 232, and the spacing between the heating body housing 232 and each of the front support part 2350 and the rear support part 2360 can be greatly reduced, so that the front support part 2350 and the rear support part 2360 can be more tightly packed to improve the heat conduction efficiency of the front support part 2350 and the rear support part 2360 and to ensure the stability of structures between the front support part 2350 and the rear support part 2360 and the heat-conducting rod 233.

In an embodiment of the present disclosure, as shown in FIG. 26, two through grooves 237 opposite to each other and extending in their axial directions may be arranged on the front support part 2350 and the rear support part 2360, while in other embodiments of the present disclosure, four or more through grooves 237 extending in their axial directions may be arranged on the front support part 2350 and the rear support part 2360, the number of the through grooves 237 is not limited herein.

As shown in FIG. 25, in an embodiment of the present disclosure, a distance between the detection point 251 of the temperature detecting element 25 and an end surface of the first end of the heat-conducting rod 233 ranges from 5.5 to 10.5 mm. As shown in the figure, the detection point 251 of the temperature detecting element 25 is a connection point of the positive wire 262 and the negative wire 263, which is located at a distance from the end surface of the first end of the heat-conducting rod 233 in a range of 5.5-10.5 mm to better reflect the maximum temperature of the heating body 2 during operation. This is due to the fact that for the heating body 2, the heating body 2 is heated as a whole, and the temperature at its two end positions will be lower than the temperature at its middle position. When water covers a zone at one end in the axial direction of the heating body 2 and the zone at the other end is not covered with water, the temperature of the heating body 2 at that position will be lowered by the action of water, the zone at the end away from water will maintain its own temperature due to the fact of being not covered with water, and the further the distance from the water, the less the temperature of the heating body 2 will be affected by water. With the dimensional parameters of the heating body 2 of the present disclosure, the detection point 251 is set within a range of 5.5-10.5 mm from the end surface of the first end of the heat-conducting rod 233, which better reflects the maximum temperature of the heating body 2 during operation.

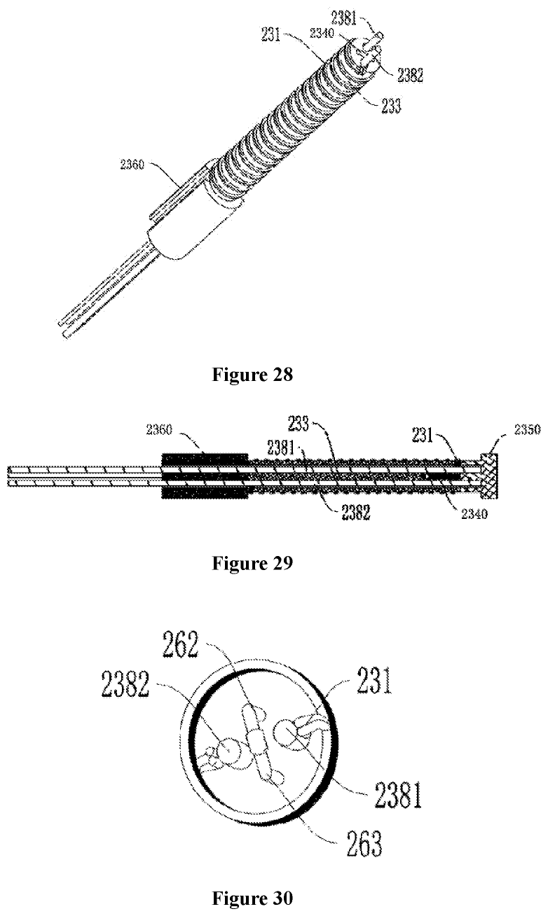

As shown in FIGS. 27 and 28, in an embodiment of the present disclosure, the heat-conducting rod 233 is provided with a thermocouple groove 2331 on the end surface of the first end, and the thermocouple groove 2331 is configured to receive a detection point 251 of the temperature detecting element 25. The detection point 251 is a connection point between two metals or alloys forming the temperature detecting element 25. The heating body 2 further includes a support body 2340, the support body 2340 is arranged in the thermocouple groove 2331, and the support body 2340 is provided with a notch 2341 for receiving the detection point 251 at an end of the support body 2340 adjacent to the detection point 251 of the temperature detecting element 25.

Specifically, as shown in FIG. 26, in an embodiment of the present disclosure, the support body 2340 is provided with a first extension part 2342 and a second extension part 2343 on opposite sides adjacent to the detection point 251. The first extension part 2342 and the second extension part 2343 enclose to form the notch 2341 and are configured to provide support to a position in the thermocouple groove 2331 corresponding to the detection point 251.

In an embodiment of the present disclosure, the section shape of the notch 2341 may be triangular or V-shaped as shown in FIGS. 25 and 26. In other embodiments of the present disclosure, the shape of the notch 2341 may also be a rectangular shape, a circular arc shape, and other shapes known to flexible pipe skilled in the art, as long as the notch can protect the detection point 251.

By providing the support body 2340 in the thermocouple groove 2331, the first extension part 2342 and the second extension part 2343 can protect the measurement point from both sides during the shrinking process, and the support body 2340 can also effectively support the heat-conducting rod 233 during the shrinking process, preventing the heat-conducting rod 233 from collapsing due to shrinking, which may result in short-circuit between the heating wire 231 and the temperature detecting element 25.

As shown in FIG. 26, in an embodiment of the present disclosure, the support body 2340 is in the form of a sheet, and the thermocouple groove 2331 is configured to have an adapted shape with the support body 2340. Since the support body 2340 is in the form of a sheet, the support body 2340 can well match the shape of the temperature detecting element 25, which can enable the support body 2340 to better support the heat-conducting rod 233 during the shrinking process, thereby preventing the collapse of the heat-conducting rod 233 due to the shrinking.

In an embodiment of the present disclosure, the support body 2340 is configured to be made of the same material as the heat-conducting rod 233. After the heating body housing 232 is shrunk, the support body 2340 is extruded to one piece with the heat-conducting rod 233. The support body 2340 being extruded to one piece with the heat-conducting rod 233 means that there is no longer a spacing between the support body 2340 and the heat-conducting rod 233, or there is no longer a clear boundary between the support body 2340 and the heat-conducting rod 233. In a case that the support body 2340 is extruded to one piece with the heat-conducting rod 233, the heat conduction efficiency of the heat-conducting rod 233 can be effectively improved.

Further, in an embodiment of the present disclosure, the heat-conducting rod 233, the support body 2340, the front support part 2350, and the rear support part 2360 are all made of the material of magnesium oxide. In a case that the heat-conducting rod 233, the support body 2340, the front support part 2350 and the rear support part 2360 are made of the material of magnesium oxide, the heat generated by the heating wire 231 can be rapidly transferred to the heating body housing 232, which in turn heats the water to generate water mist, thereby improving the utilization efficiency of the heat generated by the heating wire 231, and avoiding the heat retained in the interior of the heating body 2, so that the heating body 2 can operate normally.

In an embodiment of the present disclosure, magnesium oxide powder is filled in the space between the heating body housing 232, the heat-conducting rod 233, the front support part 2350 and the rear support part 2360. The heating body housing 232 is configured to be processed by shrinking. By filling the space between the heating body housing 232, the heat-conducting rod 233, the front support part 2350 and the rear support part 2360 with the magnesium oxide powder, the heat conduction efficiency of the heating body 2 can be improved, avoiding that the heat is retained in the heating wires 231, and avoiding that the heating wire 231 come into contact with the heating body housing 232, resulting in power leakage. By shrinking the heating body housing 232, the magnesium oxide powder and the heat-conducting rod 233, the front support part 2350 and the rear support part 2360 in the heating body housing 232 can be made tighter, thereby improving the overall density of the magnesium oxide powder and the heat-conducting rod 233, the front support part 2350 and the rear support part 2360 in the heating body housing 232, avoiding voids that are not easily conductive to heat, thereby improving the heat conduction coefficient of the heating body 2.

As shown in FIGS. 25 and 26, in an embodiment of the present disclosure, the temperature detecting element 25 includes a positive wire 262 and a negative wire 263, the positive wire 262 and the negative wire 263 are two different metals or alloys forming the temperature detecting element 25, e.g., for the K-type temperature detecting element 25, the positive wire 262 and the negative wire 263 may be nickel-chromium and nickel-silicon alloys, respectively. The rear support part 2360 and the portion of the heat-conducting rod 233 near the rear support part 2360 are provided with a positive wire channel 2641 and a negative wire channel 2642, the positive wire channel 2641 and the negative wire channel 2642 are used to receive the positive wire 262 and the negative wire 263, respectively, and the positive wire channel 2641 and the negative wire channel 2642 in the heat-conducting rod 233 are connected to the thermocouple groove 2331, thereby enabling the positive wire 262 and the negative wire 263 to extend from the outside of the second end of the heating body 2 to the thermocouple groove 2331, and are fixedly connected with each other in the thermocouple groove 2331.

As shown in FIGS. 26 and 29, in an embodiment of the present disclosure, the heating body 2 further includes a first wire 2381 and a second wire 2382, and the first wire 2381 and the second wire 2382 are used for connecting an external power source and the heating wire 231, so as to supply power to the heating wire 231. Specifically, the first wire channel 2391 and the second wire channel 2392 are formed on the heat-conducting rod 233, the two ends of the heating wire 231 extend into the first wire channel 2391 and the second wire channel 2392 on the heat-conducting rod 233, respectively. The first wire 2381 and the second wire 2382 are penetrates from the rear support part 2360 into the first wire channel 2391 and the second wire channel 2392 of the heat-conducting rod 233 and extend into the front support part 2350. The first wire 2381 and the second wire 2382 are in contact fit with the portions of the heating wire 231 arranged in the first wire channel 2391 and the second wire channel 2392.

Since both ends of the heating wire 231 extend into the first wire channel 2391 and the second wire channel 2392, the heating wire 231 has a good contact with the first wire 2381 in the first wire channel 2391 or the second wire 2382 in the second wire channel 2392, so as to avoid that the heating wire 231 fails to operate properly due to poor contact.

As shown in FIG. 30, in the cross-section of the heating body 2, a line between the positive wire channel 2641 and the negative wire channel 2642 is perpendicular to a line between the first wire channel 2391 and the second wire channel 2392. Since the line between the positive wire channel 2641 and the negative wire channel 2642 is perpendicular to the line between the first wire channel 2391 and the second wire channel 2392, the distance between the positive wire 262 or the negative wire 263 and the first wire 2381 or the second wire 2382 can be maximized, so that the positive wire 262 or the negative wire 263 can be effectively avoided from coming into contact with the first wire 2381 or the second wire 2382, which may cause the heating wire 231 or the temperature detecting element 25 to fail to operate normally.

As the positive wire 262 and the negative wire 263 extend from the outside of the second end of the heating body 2 to the thermocouple groove 2331 on the heat-conducting rod 233 and are fixedly connected with each other in the thermocouple groove 2331, the first wire 2381 and the second wire 2382 penetrate from the rear support part 2360 into the first wire channel 2391 and the second wire channel 2392 of the heat-conducting rod 233, and extend to the front support part 2350, in a case that the front support part 2350, the heat-conducting rod 233 and the rear support part 2360 are mounted into the heating body housing 232, the positive wire 262 or the negative wire 263 and the first wire 2381 or the second wire 2382 can effectively restrict the heat-conducting rod 233 from sliding relative to the front support part 2350 or the rear support part 2360 to ensure that the heat-conducting rod 233 has a good concentricity relative to the front support part 2350 or the rear support part 2360, thereby effectively avoiding contact between the heating wire 231 and the heating body housing 232, which may cause power leakage of the heating body 2.

A heating apparatus 20 is further provided according to the present disclosure, which includes a heating body housing 234 and a heating body 2, the heating body housing 234 has a heating body chamber 235 inside, and a water inlet 3 and an air outlet 4 that are in communication with the heating body chamber 235. The heating body 2 is arranged in the heating body chamber 235. The heating apparatus 20 is configured to allow only a portion of the heating body 2 to be covered with water and to maintain the surface of the other portion of the heating body 2 not covered with water at a maximum temperature of 280-580° C., to allow at least a portion of water entering the heating apparatus from the water inlet 3 to be heated and atomized and then sprayed out from the air outlet 4. For functions of various structures, reference may be made to the above description of the heating apparatus 20, which will not be repeated herein.

A steam generator is provided according to the present disclosure, which includes a housing and a heating body. The housing is provided with a heating chamber inside, and a water inlet and a water outlet that are in communication with the heating chamber. The heating body is arranged in the heating chamber, and the heating body extends inside the heating chamber in the axial direction along the steam generator, and a space above the heating body is larger than a space below the heating body in the heating chamber.

When the steam generator of the present disclosure is applied in an external device, the steam generator is installed in the external device in a transverse manner, i.e., the extension direction or the axial direction of the steam generator or the heating body is approximately in the horizontal direction, or has an angle to the horizontal plane. The space above the heating body refers to a zone between the upper surface of the heating body and the housing, and the space below the heating body refers to a zone between the lower surface of the heating body and the housing. When water is injected into the heating chamber of the housing from the water inlet, the water will flow toward the space below the heating body under the effect of gravity.

During the use of the steam generator, water enters the heating chamber from the water inlet and is then heated and atomized under the action of the heating body, and the formed water mist is sprayed out from the air outlet in the extension direction of the heating chamber. Since the heating body 2 continuously heats the water in the heating chamber 11 during the use of the steam generator, the water containing soluble calcium and magnesium compounds will have insoluble calcium or magnesium salts precipitating out, that is, scale particles, after boiling, and the scale particles in the water mist may adhere to the chamber wall of the heating chamber 11 after contacting the chamber wall of the heating chamber 11. In this way, with the continuous use of the steam generator, the scale on the chamber wall of the heating chamber 11 or on the heating body 2 will accumulate thicker and thicker.

Since the specific gravity of water mist is smaller than the specific gravity of scale particles, even if the bottom of the heating body is filled with scale, the water mist formed by the heating body can reach the air outlet from the top of the heating body and be sprayed out from the air outlet as long as there is still space above the heating body. Thereby, the time required for the scale to fill the space above the heating body is prolonged, which also prolongs the service life of the steam generator, thereby reducing the frequency of replacement of the steam generator, thus reducing the using cost of the external equipment.

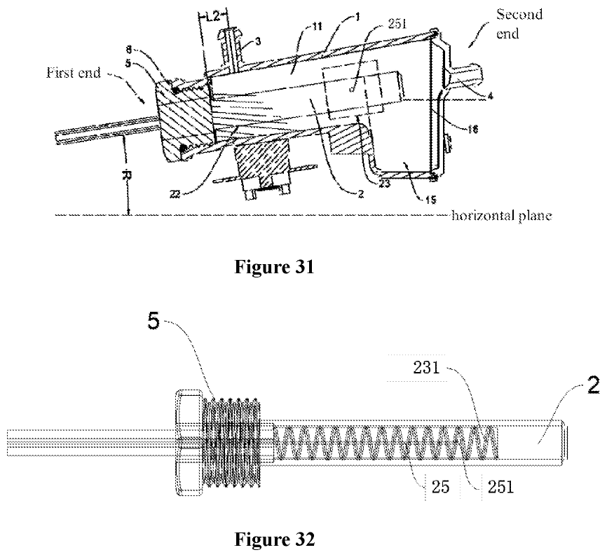

For ease of understanding, the specific structure of the steam generator of the present disclosure and its operation principle are described in detail below with reference to FIGS. 31 to 36, in conjunction with an embodiment.

A steam generator is provided according to the present disclosure, which may be used on various devices that need to generate steam, such as a cordless steam scrubber, a cordless steam mop, and a cordless eye smoker. As shown in FIG. 31, the steam generator includes a housing 1 and a heating body 2. The housing 1 may be made of aluminum alloy, a heating chamber 11 is formed inside the housing 1, and the housing 1 is provided with a water inlet 3 and an air outlet 4 that are in communication with the heating chamber 11. Thereby, the heating chamber 11 may be injected with water through the water inlet 3, and the water entering the heating chamber 11 from the water inlet 3 is configured to be heated and atomized under the action of the heating body 2, and then is sprayed out from the air outlet 4.

The term “heat and atomize” of the present disclosure is different from the conventional ultrasonic atomization and high-pressure atomization, the “heat and atomize” of the present disclosure refers to that water is heated to generate steam, and when the amount of steam is sufficiently large and the steam contacts with air and condenses, the steam will crystallize into tiny water droplets, which may be observed by the user.

The steam generator of the present disclosure is arranged in a transverse manner, i.e., the extension direction or axial direction of the steam generator and the heating body 2 inside is approximately in the horizontal direction or is at an angle to the horizontal plane. As shown in FIG. 31, along the axial direction of the steam generator, the steam generator has opposite first end and second end. The heating body 2 is arranged in the heating chamber 11, and the heating body 2 extends in the heating chamber 11 in the direction from the first end to the second end. Specifically, the heating body 2 is fixed with a flange 5 at a position adjacent to the first end, and the heating body 2 is connected to an open end of the housing 1 by the flange 5, whereby the heating body 2 can extend in the heating chamber 11 and be suspended in the heating chamber 11, and there is a certain spacing between the outer surface of the heating body 2 and the inside wall of the heating chamber 11.

The flange 5 may be fixed to the surface of the first end of the heating body 2 by welding or in a manner known to those skilled in the art, the outer surface of the flange 5 is provided with an external thread, and the open end of the housing 1 may be provided with an internal thread, whereby the flange 5 may be fixed to the open end of the housing 1. In order to ensure the sealing effect between the flange 5 and the housing 1, as shown in FIG. 31, a sealing ring 6 may further be provided on the flange 5, the sealing ring 6 is used for sealing the gap between the flange 5 and the housing 1, avoiding water from flowing out of the housing 1.

It is to be understood that the water inlet 3 on the housing 1 may be connected to a water storage tank and a water pump, and the water pump may pump water from the water storage tank to the heating chamber 11 via the water inlet 3. The air outlet can be connected to the air jet head, so that the water mist generated by the steam generator can be delivered to the air jet head and then dispersed to various air jet nozzles to be sprayed out.

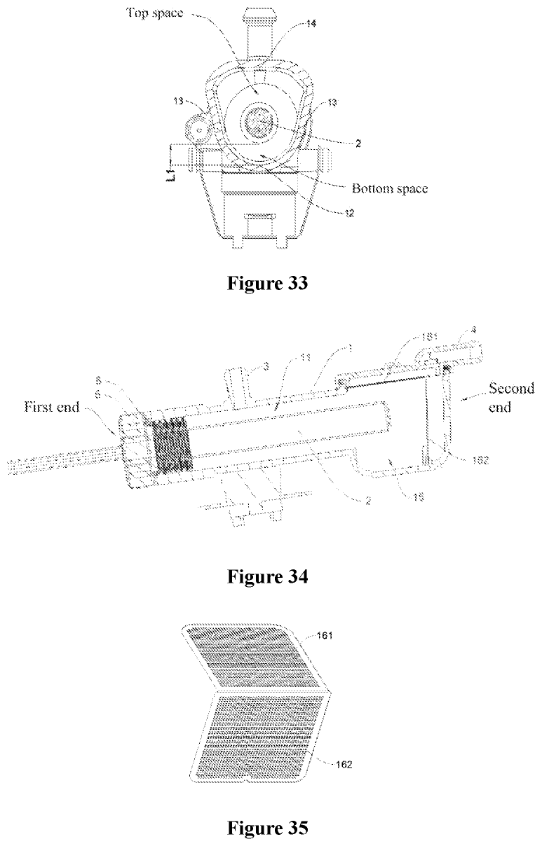

As shown in FIG. 33, in the heating chamber 11 of the steam generator of the present disclosure, the space above the heating body 2 is larger than the space below the heating body 2. The space above the heating body refers to a zone between the upper surface of the heating body and the housing, and the space below the heating body refers to a zone between the lower surface of the heating body and the housing. When water is injected into the heating chamber of the housing from the water inlet, the water will flow toward the space below the heating body under the action of gravity. Since the heating body 2 continuously heats the water in the heating chamber 11 during the use of the steam generator, the water containing soluble calcium and magnesium compounds will have insoluble calcium or magnesium salts precipitating out, that is, scale particles, after boiling, and the scale particles in the water mist may adhere to the chamber wall of the heating chamber 11 when contacting the chamber wall of the heating chamber 11. In this way, with the continuous use of the steam generator, the scale on the chamber wall of the heating chamber 11 or on the heating body 2 will accumulate thicker and thicker.

Since the specific gravity of the water mist is less than the specific gravity of the scale particles, even if the space below the heating body 2 is filled with scale, as long as there is still space above the heating body 2, the water mist formed on the heating body 2 can reach the air outlet 4 from the top of the heating body 2 and be sprayed out from the air outlet 4. This extends the time required for the scale to fill the space above the heating body 2, and extends the service life of the steam generator, thereby reducing the frequency of replacement of the steam generator, thus reducing the using cost of the steam generator.

In an embodiment of the present disclosure, as shown in FIG. 33, the housing 1 includes a first enclosure part 12 arranged below the heating body 2, and a flaring part 13 connected to the first enclosure part 12 and inclined to an outer side of the heating body 2 from a position connected to the first enclosure part 12, and further includes a second enclosure part 14 arranged above the heating body 2 and connected to the flaring part 13. The first enclosure part 12, the flaring part 13 and second enclosure part 14 enclose to form the heating chamber 11, and may be integrally molded. As the flaring part 13 is inclined to the outside of the heating body 2, an internal space enclosed by the flaring part 13 and the second enclosure part 14 is significantly larger than an internal space located below the heating body 2 that is enclosed by the flaring part 13 and the first enclosure part 12, so that it can be effectively ensured that the space above the heating body 2 is larger than the space below the heating body 2.

As shown in FIG. 33, in an embodiment of the present disclosure, the first enclosure part 12, the second enclosure part 14 are in a circular arc shape, and the radius of curvature of the first enclosure part 12 is smaller than the radius of curvature of the second enclosure part 14. As the first enclosure part 12 is circular arc-shaped, and the cross-section of the heating body 2 is circular, the center of the first enclosure part 12 can coincide with the center of the heating body 2, which ensures that the distances between the various positions of the first enclosure part 12 and the heating body 2 are equal, so that the water entering the bottom of the heating body 2 can contact with the heating body 2 more quickly. From another perspective, a small amount of water can contact with the heating body 2 to avoid the need to add more water due to the large space below the heating body 2, which affects the heating efficiency of the steam generator. That is, all the water located in the first enclosure part 12 can be well heated to form a mixture of gaseous water and high temperature liquid water.

The second enclosure part 14 located above the heating body 2 has a circular arc shape. Since the flaring part 13 is inclined to the outer side of the heating body 2, the distance between the ends of the second enclosure part 14 is larger than the distance between the ends of the first enclosure part 12, in order to maximize the space above the heating part without increasing the overall dimension of the housing 1, the second enclosure part 14 is required to have a circular arc shape, and the radius of curvature of the second enclosure part 14 is larger than the radius of curvature of the first enclosure part 12, so that the space above the heating body 2 can be increased while minimizing the size of the steam generator.

As shown in FIG. 33, in an embodiment of the present disclosure, the distance L1 between the bottom of the heating body 2 and the first enclosure part 12 meets the following relationship: 1.5 mm≤L1≤4.5 mm. If L1 is too small, heat generated by the heating body 2 will be transferred to the surface of the housing 1 and emitted to the outside, which affects the heating efficiency of the heating body 2. If L1 is too large, it is required to add too much water to the heating chamber 11 to contact the water with the heating body 2, and too much water will seriously affect the efficiency of generating steam. In the embodiment of the present disclosure, the distance L1 between the bottom of the heating body 2 and the first enclosure part 12 is between 1.5 mm and 4.5 mm, which can avoid the heat of the heating body 2 from being transferred to the surface of the housing 1, and can also enable a small amount of water to contact the surface of the heating body 2, so as to ensure the heating efficiency of the heating body 2, and ensure the generation rate of steam.

Further, as shown in FIG. 33, in an embodiment of the present disclosure, opposite sides of the first enclosure part 12 extend at least above the bottom of the heating body 2. This ensures that the heating body 2 is at an equal distance from each position of the first enclosure part 12, which facilitates the water located in the first enclosure part 12 to come into contact with the heating body 2 quickly. It should be noted herein that the present disclosure divides the enclosing side wall of the heating chamber 11 into a first enclosure part 12, a flaring part 13 and a second enclosure part 14 only for the sake of convenience of description. In fact, when the housing 1 is molded in one piece, the adjacent two parts are continuous with each other.

In order for the steam generator to generate sufficient amount of water mist, in an embodiment of the present disclosure, the steam generator is configured to allow only a portion of the heating body 2 to be covered with water, and to maintain the surface of the other portion of the heating body 2 not covered with water at a maximum temperature of 280-580° C., so that at least a portion of water entering the steam generator from the water inlet 3 is heated and atomized and then sprayed out of the air outlet 4.

The term “cover” in the present disclosure means that water in the heating chamber 11 is in contact with at least the bottom of the heating body 2 at an axial position, or extends from the bottom to a position at the sidewall, or covers the entire surface of the heating body 2 at that axial position. It should be noted that, when the temperature of the heating body 2 increases, the water covering the position of the heating body 2 will be boiling, the boiling water will be in a “jumping” state at some zone of the heating body 2, the state should also be understood as water covering the heating body 2. That is, the heating body 2 is heated as a whole, when the heating body 2 is raised to a predetermined temperature, water is injected into the heating chamber 11 through the water inlet 3, and the injected water will in a “jumping” state when coming into contact with the high temperature heating body 2, and this state should also be understood as water covering the heating body 2.

The surface of the other portion of the heating body 2 not covered with water maintaining at a maximum temperature of 280-580° C. means that in the axial direction of the heating body 2, in the surface away from the zone of the heating body 2 covered with water, at least a portion of the surface of the other portion of the heating body 2 not covered with water maintains at the temperature of 280-580° C.; it can be that the entire surface maintains at a temperature of 280-580° C., or it can be that a portion of the surface maintains at a temperature of 280-580° C. while the other portion of the surface maintains at a temperature lower than 280° C.

After a number of tests, it has been found that when the surface of the other portion of the heating body 2 not covered with water has a maximum temperature of 280-580° C., the flow rate of the formed steam is large, showing pure white steam with high visibility, thus the user can easily observe the steam.

In order to further improve the water mist spray effect of the steam generator, in an embodiment of the present disclosure, the steam generator is configured to maintain the surface of the other portion of the heating body 2 not covered with water at a maximum temperature of 350-400° C. After a number of tests, it has been found that when the surface of the other portion of the heating body 2 not covered with water maintains at the maximum temperature of 350-400° C., the amount of water mist sprayed by the steam generator is large, thus the user can easily see that the steam generator is spraying water mist normally.

As shown in FIG. 31, in an embodiment of the present disclosure, when the steam generator is in use, the heating body 2 is gradually inclined upward in a direction from the first end to the second end, i.e., the height of the first end of the heating body 2 is lower than the height of the second end. The zone located on the first end of the heating body 2 and covered with water is recorded as a heating zone 22, and a zone on the second end of the heating body 2 and not covered with water is recorded as a high-temperature zone 23, and the water inlet 3 is arranged on the side of the heating zone 22 and the outlet 4 is arranged on the side of the high-temperature zone 23.

In this way, during use of the steam generator, due to the difference in specific gravity between the scale particles and the water, and the gradual upward inclination of the heating body 2 in the direction from the first end to the second end, scale particles will be deposited downwardly as the water mist mixed with scale particles move from the heating zone 22 to the high temperature zone 23. When the water mist reaches the air outlet 4, the content of the scale particles in the water mist has been greatly reduced, so that the scale particles can be prevented from flowing out of the air outlet 4, which in turn will subsequently clog the air jet nozzles and other structures.

As shown in FIG. 31, in an embodiment of the present disclosure, the water inlet 3 is arranged on the housing 1 at a position higher than the heating body 2. In this way, water can fall onto the heating body 2 from above the heating body 2. Since the specific gravity of the scale particles is large, the water inlet 3 is arranged above the heating body 2 to effectively prevent a large number of scale particles from being deposited into the water inlet 3, thereby avoiding a malfunction of the steam generator due to the rapid clogging of the water inlet 3, and thus prolonging the service life of the steam generator.

In an embodiment of the present disclosure, the distance between the center axis of the water inlet 3 and the end surface of the flange 5 meets 0 mm≤L2≤30 mm. Since 0 mm≤L2≤30 mm, it can be effectively avoided that the water falling from the water inlet 3 is too close to the high-temperature zone 23 of the heating body 2, thereby ensuring that the water entering from the water inlet 3 can be effectively heated by the heating zone 22, which can effectively generate a mixture of gaseous water and high-temperature liquid water. The mixture of gaseous water and high-temperature liquid water then forms a water mist with good visibility after the mixture of gaseous water and high-temperature liquid water reaches the high-temperature zone 23.

Further, as shown in FIG. 31, in an embodiment of the present disclosure, the housing 1 is provided with a scale deposit chamber 15 at least extending downwardly at a position corresponding to the high-temperature zone 23 of the heating body 2, the scale deposit chamber 15 is in communication with the heating chamber 11, and the bottom of the scale deposit chamber 15 is configured to be lower than the bottom of the heating chamber 11. The water mist has a certain momentum during the flow towards the air outlet 4, so that scale particles will be deposited in the scale deposit chamber 15 by gravity during the flow process of the water mist mixed with scale particles towards the air outlet 4, thereby slowing down the deposition rate of scale on the surface of the heating body 2 or on the inside wall of the heating chamber 11, and thus prolonging the service life of the steam generator. In addition, water boils at the position of the heating zone 22, and this boiling water pushes or bounces scale into the scale deposit chamber 15, thereby reducing scale deposit on the heating chamber 11 and the heating body 2.

Further, as shown in FIG. 31, in an embodiment of the present disclosure, in the direction from the first end to the second end, the inclination angle R of the heating body 2 with respect to the horizontal plane meets the following relationship: 3°≤R≤15°. Since R is greater than or equal to 3°, thereby a low temperature zone covering the heating body 2 and a high temperature zone not covered with water can be formed in the heating chamber 11 by controlling the amount of water, avoiding the flow of water to the bottom of the entire heating body 2. In addition, R is less than or equal to 15°, which prevents scale particles from failing to move into the scale deposit chamber 15 as the insufficiently powered water mist.

As shown in FIGS. 31 and 34, in an embodiment of the present disclosure, the air outlet 4 is arranged on the housing 1 at a position corresponding to the scale deposit chamber 15. A filter assembly 16 is arranged in the scale deposit chamber 15, and the heated and atomized water is configured to be sprayed out from the air outlet 4 after passing through the filter assembly 16. As the filter assembly 16 is arranged in the scale deposit chamber 15, scale particles that fail to deposit and have a particle size larger than the mesh diameter of the filter are retained by the filter assembly 16 when the water mist pass through the filter assembly 16, so as to avoid that the water sprayed out from the air outlet 4 carries scale particles with a larger particle size, which may cause the clogging of the subsequent air jet nozzles.

As shown in FIG. 31, in an embodiment of the present disclosure, the air outlet 4 is arranged on an end surface of the second end of the housing 1, and the filter assembly 16 is configured to cover the air outlet 4, and the filter assembly 16 can effectively retaining scale particles that fail to deposit and have a particle size larger than the mesh diameter of the filter, preventing some of the scale particles from being sprayed out from the air outlet 4 bypassing the filter assembly 16.

As shown in FIGS. 34 and 35, in another embodiment of the present disclosure, the air outlet 4 is arranged at a top position adjacent to the second end of the housing 1. The filter assembly 16 includes a first filter 161 arranged above the scale deposit chamber 15 and covering the air outlet 4, and a second filter 162 connected to the first filter 161 and extending to the bottom of the scale deposit chamber 15. As the filter assembly 16 includes a first filter 161 located above and covering the air outlet 4, and a second filter 162 connected to the first filter 161 and extending to the bottom of the scaling chamber 15, the area of the overall filter assembly 16 is larger as compared with the area of the filter assembly 16 with only a single filter, which slows down the clogging rate of the filter assembly 16, thereby prolonging the service life of the steam generator.

As shown in FIGS. 31 and 34, in an embodiment of the present disclosure, there is a spacing between the filter assembly 16 and the inside wall of the housing 1. In this way, as compared with the arrangement that the filter assembly 16 covers the air outlet 4, when a portion of the filter assembly 16 is clogged with scale particles, the water mist can pass through other zones of the filter assembly 16 to be sprayed out from the air outlet 4, thereby slowing down the rate at which the entire filter is clogged with scale particles, thereby prolonging the service life of the filter assembly 16.

As shown in FIGS. 31 and 34, in an embodiment of the present disclosure, the center axis of the air outlet 4 is higher than the bottom of the second end of the heating body 2. The air outlet 4 is arranged at a higher position, so that the scale particles are avoided from being sprayed out from the air outlet 4 during the movement of the water mist in the direction toward the air outlet 4. In addition, large water droplets having a certain specific gravity can be avoided from being sprayed out from the air outlet 4, so that the spray efficiency of steam can be ensured. Moreover, the water mist will move upwardly, and the center axis of the air outlet 4 is higher than the bottom of the second end of the heating body 2, which facilitates the water mist to be sprayed out from the air outlet 4 quickly, instead of circulating in the housing 1.

As shown in FIG. 32, the heating body 2 of the present disclosure is provided with a heating wire 231 for generating heat inside the heating body 2, and the heating wire 231 also extends along the direction from the first end to the second end. During the use of the steam generator, water will enter the heating chamber 11 from the water inlet 3, and then a portion of the water will boil under the action of the heating body 2, and a portion of the high temperature liquid water will be splashed out by the boiling steam, thereby forming a mixture of gaseous water and high temperature liquid water. The mixture of gaseous water and high-temperature liquid water is sufficiently heated by the heating body 2 to generate a water mist with good visibility, which is sprayed out from the air outlet 4.

In order to facilitate determining the temperature of the high temperature zone 23, as shown in FIGS. 31 and 32, in an embodiment of the present disclosure, the heating body 2 is provided with a temperature detecting element 25, and a detection point 251 of the temperature detecting element 25 is set at the position of the high temperature zone 23, and is used to measure the temperature of the high temperature zone 23. Specifically, the temperature detecting element 25 may be a thermocouple detecting element or a thermistor detecting element, and so on. In a case that the temperature detecting element 25 is a thermocouple detecting element, the connection point of the two heat electrodes is the detection point 251 of the thermocouple detecting element, and in a case that the temperature detecting element 25 is a thermistor detecting element, the position of the thermistor is the detection point 251 of the thermistor detecting element.

Further, in an embodiment of the present disclosure, a control unit (not shown in the figure) is further provided, the control unit is configured to control a heating power of the heating body 2 and a flow rate of water from the water inlet 3 into the heating chamber 11 based on a temperature collected by the temperature detecting element 25. Specifically, when the maximum surface temperature of the high temperature zone 23 is lower than 280° C., the control unit may control the water pump to reduce the flow rate of water into the heating chamber 11 or increase the heating power of the heating wire 231; when the maximum surface temperature of the high temperature zone 23 is higher than 580° C., the control unit may control the water pump to increase the flow rate of water into the heating chamber 11 or reduce the heating power of the heating wire 231, or to directly turn off the heating wire 231.

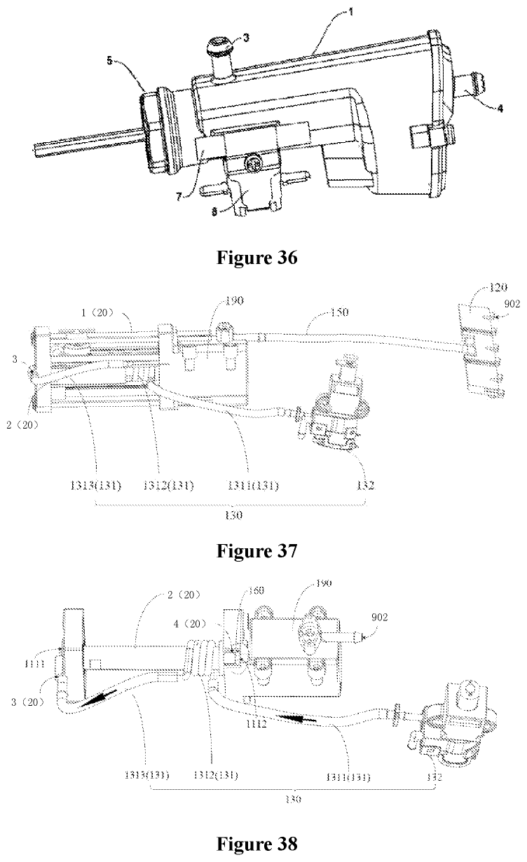

In order to avoid an explosion accident due to a malfunction of the steam generator generates such as poor water intake, dry burning, or excessive heating power, as shown in FIG. 36, the housing 1 is further provided with a temperature control switch 8 and a temperature fuse 7 at the outer side, the temperature control switch 8 may turn off the heating wire 21 when the temperature of the housing 1 exceeds a set temperature and restart the heating wire 21 when the temperature of the housing 1 falls below the set temperature. The temperature fuse 7 may automatically fuse to cut off the power supply of the heating part 21 when the temperature of the housing 1 is higher than a melting temperature. With the temperature control switch 8 and the temperature fuse 7, the steam generator can be prevented from being overheated and causing accidents.

As shown in FIG. 31, in an embodiment of the present disclosure, in the axial direction of the steam generator, the relative position between the side wall of the scale deposit chamber 15 adjacent to the first end and the detection point 251 is within 10 mm. That is, taking the detection point 251 as a reference, the sidewall of the deposit chamber 15 adjacent to the first end is at most 10 mm closer in the direction where the first end is located, or 10 mm closer in the direction where the second end is located.

When the side wall of the deposit chamber 15 adjacent to the first end is too close to the first end of the steam generator, the mixture of gaseous water and high temperature liquid water will enter the deposit chamber 15 in large quantities before contacting the high temperature zone 23, which cause the mixture of gaseous water and high temperature liquid water be heated up insufficiently, and will be difficult to generate water mist with good visibility. When the side wall of the scale deposit chamber 15 adjacent to the first end is too close to the second end of the steam generator, scale particles in the mixture of gaseous water and high temperature liquid water will be deposited in large quantities below the high temperature zone 23 and will not be able to enter the scale deposit chamber 15, which cause the space below the high temperature zone 23 to be filled with scale very quickly, and thus reduce the service life of the steam generator.

Therefore, when the relative position of the side wall of the scale deposit chamber 15 adjacent to the first end is within 10 mm with respect to the detection point 251, it can be ensured that the mixture of gaseous water and high-temperature liquid water can be sufficiently heated to generate water mist with good visibility, and it can also be avoided that the space below the high-temperature zone 23 is quickly filled with scale, thus prolonging the service life of the steam generator.

An intelligent device is further provided according to the present disclosure, which may be a device that needs to spray steam such as a cordless steam scrubber, a cordless steam mop, or a cordless eye smoker, and the intelligent device is provided with the aforementioned steam generator. For functions of the various structures of the steam generator, reference may be made to the above description, which will not be repeated herein.

A cleaning device, a cleaning assembly and a cleaning method are provided according to the present disclosure, which are described in detail below. It should be noted that the order of description of the following embodiments does not serve as a limitation on the order of preferred embodiments of the present disclosure. Moreover, in the following embodiments, the description of each embodiment has its own focus, and the parts that are not described in detail in a certain embodiment can be referred to relevant descriptions of other embodiments. A cleaning device is provided according to an embodiment of the present disclosure, the cleaning device may be a device that performing cleaning via steam, such as a steam scrubber.

Referring to FIG. 37, the cleaning device includes a body (not shown), a heating apparatus 20, an air jet head 120 and a cooling apparatus 130.

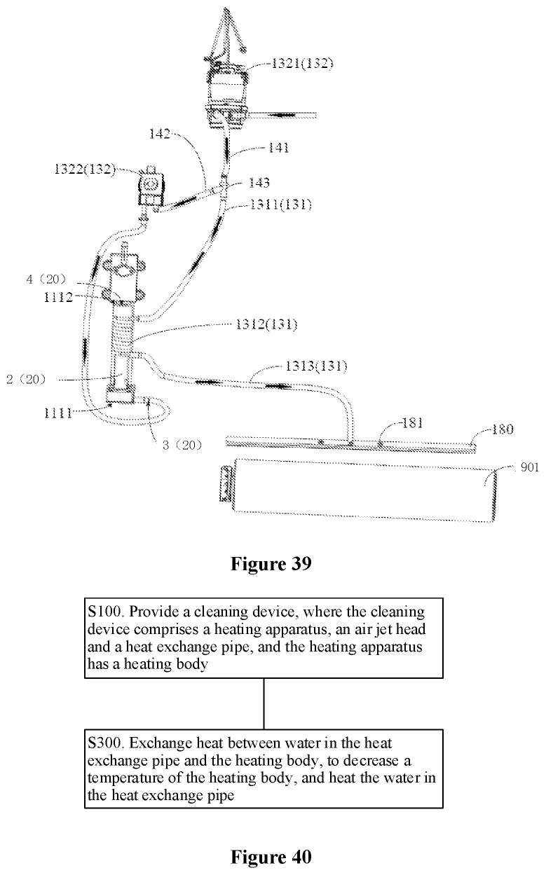

The body is a foundation for carrying other structures. The body may further be provided with a reservoir (not shown), the reservoir is connected to the heating apparatus 20 to provide the heating apparatus 20 with a cleaning medium, the cleaning medium is usually water, including pure water and water containing cleaning fluid, etc. However, in other embodiments, when the body is further provided with components such as a water spray assembly 180 (see FIG. 39) or other components that require a water supply, the reservoir may also be connected to the corresponding components to realize water supply. Moreover, in other embodiments, it is also possible to obtain water supply from an external water source without the reservoir, which is not limited in this embodiment. In addition, the body may be provided with a grip lever for operation by a user, and a structure such as a roller brush 901 may be arranged at the bottom of the body.

The heating apparatus 20 is arranged on the body for heating water entering the heating apparatus 20 into steam, which will subsequently be supplied to the air jet head 120. Herein, referring to FIG. 38, the heating apparatus 20 has a heating body 2, the heating body 2 has an internal chamber (not shown in the figure) as well as a water inlet 3 and an air outlet 4 that are in communication with the internal chamber. Herein, the water inlet 3 is used to connect to a reservoir or other water source to access water. The heating body 2 is used to heat and atomize the water entering the internal chamber. The air outlet 4 is used to spray out the atomized steam. Here, referring to FIG. 37, the heating apparatus 20 may further include a housing 1, the housing 1 is arranged on the outside of the heating body 2 to realize protection and heat conduction insulation, thus ensuring the safe use of the heating body 2.

Referring further to FIG. 37, the air jet head 120 is attached to the body, which may normally be arranged at a position near the front side at the bottom of the body, which is not limited in this embodiment. The air jet head 120 is connected to the air outlet 4 in order to spray the steam formed by heating and atomization outwardly by the air jet head 120 for cleaning. Herein, the heating apparatus 20 is connected to the air jet head 120 through an outlet pipe.

In an example, referring to FIG. 37, the air jet head 120 is substantially plate-shaped, and a number of air jet nozzles 902 are arranged in the air jet head 120. Referring again to FIG. 38, the air outlet 4 of the heating apparatus 20 is connected to a filter box 190, the filter box 190 has a chamber (not shown in the figures) inside in which a filter assembly such as a filter is provided (not shown in the figures), and the air jet head 120 is connected to the filter box 190 through a flexible pipe 150. Herein, the filter box 190 and the flexible pipe 150 form the air outlet pipe, atomized steam supplied by the air outlet 4 is filtered after passing through the filter box 190, and then is supplied through the flexible pipe 150 to the air jet head 120 and sprayed outwardly by the air jet nozzle 902. Both ends of the flexible pipe 150 may be provided with sealing members such as sealing rings to realize a sealed connection, exemplarily, a sealing ring 160 is arranged at the air outlet 4 to make a sealed connection between the filter box 190 and the air outlet pipe. Herein, the flexible pipe 150 may be easily bent and adjusted according to the structure and position of the body and other components to enable connection and installation, although a rigid pipe may be arranged in other embodiments.

However, the specific structure of the air jet head 120 and the specific connection structure between the heating apparatus 20 and the air jet head 120 is not limited to the above example, and is not limited in this embodiment. Exemplarily, the air outlet pipe may be a pipe, which is connected between the air outlet 4 of the heating apparatus 20 and the air jet head 120. Exemplarily again, the air outlet pipe is a buttress structure arranged between the air outlet 4 and the air jet head 120, between which the buttress structure is connected. Exemplarily again, the air outlet pipe is formed by other components connected between the air outlet 4 and the air jet head 120, such as the above-described filter box 190 and flexible pipe 150.

Here, the heating apparatus 20 will sometimes have a high heating temperature. Exemplarily, in order for the water mist from the air jet nozzle 902 to have a high visibility for a user to observe the operation state of the cleaning device, the heating apparatus 20 needs to heat the water into a membrane boiling state. Therefore, at least a portion of the heating body of the heating apparatus 20 needs to maintain at a temperature above the Leidenfrost temperature of water, e.g. a maximum temperature of at least a portion of the surface of the heating body is higher than 400° C., preferably the maximum temperature of a portion of the surface of the heating body maintains in the range of 400-700° C., and exemplary may maintain in the range of 400° C.-550° C., 550° C.-700° C. and the like. When the heating body is in the high temperature range, damage to peripheral parts may result. For example, referring to FIG. 38, for the sealing member 160 such as a sealing ring arranged close to the air outlet 4 of the heating apparatus 20 in the preceding example, which is typically made of a material such as silicone, the heating body 2 having a high temperature exceeds a temperature resistance value of the material such as silicone, which in turn will lead to a more rapid aging or even scorching damage of the sealing ring. Here, the aging and damage of the sealing ring will affect the sealing effect at the air outlet 4 of the heating apparatus 20, which in turn affects the use safety of the cleaning device and makes the cleaning device less effective.

Therefore, in order to decrease the temperature of the heating body 2 of the heating apparatus 20, in an embodiment of the present disclosure, the cooling apparatus 130 is arranged on the body, the cooling apparatus 130 is configured to drive a cooling medium to exchange heat with the heating body 2 to decrease the temperature of the heating body 2.

Exemplarily, in a first example, referring to FIG. 38, the cooling apparatus 130 includes a heat exchange pipe 131 and a drive mechanism 132. The heat exchange pipe 131 is connected to the heating apparatus 20. Specifically, the heat exchange pipe 131 includes a first segment 1311, a first heat exchange segment 1312, and a second segment 1313 connected in sequence. The drive mechanism 132 is configured in the heat exchange pipe 131, such as at an upstream of the first segment 1311, for pumping water through the first segment 1311, the first heat exchange segment 1312 and second segment 1313 into the heating apparatus 20.

The first segment 1311 is connected to the downstream of a reservoir for accessing water.

The first heat exchange segment 1312 is wrapped around the heating body 2. Specifically, the heating body 2 has opposite first end 1111 and second end 1112, the water inlet 3 is proximate to the first end 1111, the air outlet 4 is proximate to the second end 1112, and the first heat exchange segment 1312 is wrapped around the circumferential surface of the heating body 2 proximate to the second end 1112 to decrease the temperature of the heating body 2 at the second end 1112. However, in other embodiments, the first heat exchange segment 1312 may also be wrapped around the heating body 2 at other positions to cool other positions, which is not limited in this embodiment.

When water flows through the first heat exchange segment 1312, the lower temperature water can absorb the heat of the heating body 2, so that the temperature of the heating body 2 can be decreased, to avoid the high temperature heating body 2 from affecting the sealing member 160 arranged at the second end 1112. Herein, the first heat exchange segment 1312 is made of a material with a high heat exchange coefficient in order to increase the heat exchange efficiency, for example, copper or other metals may be used.

The second segment 1313 is connected to the water inlet 3 to supply water to the heating apparatus 20. Herein, the first segment 1311 and the second segment 1313 may be flexible pipes in order to facilitate connection. Moreover, water is preheated by heat exchange with the heating body 2 as it flows through the first heat exchange segment 1312, and the preheated water continues through the second segment 1313 and enters the internal chamber of the heating apparatus 20 through the water inlet 3 to be heated. Herein, since water exchanges heat with the heating body 2 in the first heat exchange segment 1312 and is thus preheated, the subsequent heating body 2 can heat the water to the preset temperature more quickly, which improves the heating efficiency of the heating body 2, and reduce the energy consumption required by the heating body 2 to heat the water.

It is appreciated that herein, the heat exchange pipe 131 connects the reservoir with the water inlet 3 of the heating body 2, and the heat exchange pipe 131 is configured to supply water to the heating apparatus 20 while acting as a heat exchange pipe 131 of the cooling apparatus 130. Further, the water which is conveyed to the heating body 2 via the heat exchange pipe 131 absorbs the heat of the heating body 2, which realizes the cooling of the heating body 2 while being preheated, realizing the efficient use of energy.

It will be appreciated that in the above example, a portion of the heat exchange pipe 131 is wrapped around the heating body 2. In other embodiments, the heat exchanger pipe 131 may not be arranged in a different way from being wrapped around the heating body 2, and heat exchange may be realized simply by arranging the heat exchanger pipe 131 in contact with the heating body 2. However, the arrangement of winding makes a larger heat exchange area between the heat exchanger pipe 131 and the heating body 2, and thus the heat exchange effect is better.

Exemplarily, in a second example, referring to FIG. 39, the cleaning device further includes a roller brush 901 and a water spray assembly 180 arranged on a body, the water spray assembly 180 has at least one water spray nozzle 181, the water spray nozzle 181 is arranged in a direction proximate to the roller brush 901 for spraying water onto the roller brush 901 for wetting the roller brush 901. Herein, the cleaning device also includes a water supply pipe 140, the water supply pipe 140 includes a first pipe 141 and a second pipe 142, the first pipe 141 is arranged at an upstream of the second pipe 142 and the heat exchange pipe 131 and is connected to a reservoir for accessing water. The first pipe 141, the second pipe 142 and the heat exchanger pipe 131 are connected to each other by a three-way pipe 143. The second pipe 142 is connected to the water inlet 3 for supplying water to the heating apparatus 20. The heat exchanger pipe 131 is connected to the water spray nozzle 181 for supplying water to the water spray nozzle 181. However, it will be appreciated that, in other embodiments, the first pipe 141 may be not arranged and the second pipe 142 and heat exchange pipe 131 are connected directly to the reservoir for accessing water.

Here, the heat exchange pipe 131 is configured to supply water to the water spray nozzle 181 while cooling the heating body 2. In other embodiments, it is also possible to wrap the second pipe 142 around the heating body 2, either alone or simultaneously, in order to configure the second pipe 142 as a portion of the heat exchange pipe 131. In this embodiment, specifically, the heat exchanger pipe 131 includes a first segment 1311, a first heat exchange segment 1312 and a second segment 1313 connected in sequence, the first segment 1311 is connected to the first pipe 141 via the three-way pipe 143 to access water, the first heat exchange segment 1312 is wrapped around the heating body 2 and the second segment 1313 is connected to the water spray nozzle 181.

In addition, the drive mechanism 132 of the cooling apparatus 130 includes a first pump body 1321 and a second pump body 1322, the first pump body 1321 is configured in the first pipe 141 in communication with the heat exchanger pipe 131, and the second pump body 1322 is configured in the second pipe 142 in communication with the heat exchanger pipe 131, i.e., the drive mechanism is indirectly configured in the heat exchanger pipe 131 and regulates the flow rate of the heat exchanger pipe 131 by regulating the flow rate of the first pipe 141 and the second pipe 142. However, in other embodiments, the drive mechanism 132 may also be configured in the heat exchanger pipe 131.

When in use, the first pump body 1321 drives the water into the first pipe 141, the second pump body 1322 drives the water into the second pipe 142 and regulates the flow rate thereof, so that a portion of the water flows into the second pipe 142, and the remaining portion of the water continues to flow into the heat exchanger pipe 131 under the drive of the first pump body 1321. When the water passes through the first heat exchanger pipe 1312, the low temperature water can absorb the heat of the heating body 2, so that the temperature of the heating body 2 can be decreased, so as to avoid that the heating body 2 which has too high temperature from affecting the sealing member 160 arranged at the air outlet 4. Moreover, the water is heated by heat exchange with the heating body 2 when flowing through the first heat exchange segment 1312, and the heated water continues through the third segment 1313 and enters into the water spray assembly 180 and is sprayed outwardly through the water spray nozzle 181 of the water spray assembly 180. Herein, the water exchanges heat with the heating body 2 in the first heat exchange segment 1312 and then is heated, and the heated water will have a better cleaning effect. In addition, there is no need to provide an additional heating assembly in the cleaning device to make the water sprayed outwardly by the water spray assembly 180 have a certain temperature, which helps to save energy.

In the above embodiment, the cooling apparatus 130 is configured to use the cleaning medium (i.e. water) of the cleaning device as a cooling medium to exchange heat with the heating body 2, and the heat exchange pipe 131 of the cooling apparatus 130 is also used to supply water to the other components. Thereby, the heat of the heating body 2 is absorbed by water in order to avoid damage to the sealing member 160 or other components due to the high temperature heating body 2. In addition, the water is heated due to the absorption of heat, after which the water can be used as a cleaning medium, thereby saving the electrical energy required to heat the cleaning medium.

Herein, in some embodiments, the cleaning device also has a power supply (not shown in the figure), the power supply is arranged on the body and connected to the heating apparatus 20. Compared with a cleaning device connected to an external power supply, cordless cleaning device having an on-board power supply has better convenience, but has higher energy saving needs in order to improve the endurance. Therefore, applying the heating apparatus 20 to such a cleaning device having an on-board power supply will have a better beneficial effect, which will help to improve the endurance of the cleaning device, so as to provide the user with a better experience in using the cleaning device. Furthermore, in other embodiments, the cooling apparatus 130 may also not use a cleaning medium such as water as a cooling medium, i.e. additionally arrange a cooling medium and heat exchange pipe 131, etc. In an example, the cooling apparatus 130 may be an air-cooled structure, the air-cooled structure is used to provide cooling air to the heating body 2 to decrease the temperature of the heating body 2. In another example, the cooling apparatus 130 may be a water-cooled structure, the water-cooled structure includes a heat exchanger pipe 131 and a pump body configured in the heat exchanger pipe 131, the heat exchanger pipe 131 is in contact with the heating body 2 in order to absorb heat. The pump body is used to drive the water or other cooling medium to flow in the heat exchanger pipe 131 to realize the cooling of the heating body 2.

Accordingly, in order to better realize the technical effect of the present disclosure, a cleaning assembly is further provided according to an embodiment of the present disclosure. The cleaning assembly is used to clean the device to achieve a cleaning effect. Herein, the cleaning assembly includes a heating apparatus 20 and a cooling apparatus 130. The heating apparatus 20 has a heating body 2, the heating body 2 has an internal chamber, and a water inlet 3 and an air outlet 4 that are in communication with the internal chamber, and the water supply pipe 140 is connected to the water inlet 3. The cooling apparatus 130 is used to decrease the temperature of the heating body 2 so as to avoid the impact of the heating body 2 on the other components in close thereto.

In some embodiments, the cooling apparatus 130 includes a heat exchanger pipe 131 and a drive mechanism 132 configured in the heat exchanger pipe 131, the drive mechanism 132 is used to drive a cooling medium to move along the heat exchanger pipe 131, at least a portion of the heat exchanger pipe 131 is in contact with the heating body 2.

In some embodiments, the heat exchanger pipe 131 is connected to the water inlet 3 for supplying water to the heating apparatus. In some embodiments, the cleaning assembly further includes an air jet nozzle and a water spray nozzle 181, the air outlet 4 is connected to the air jet nozzle, and the outlet of the heat exchange pipe 131 is connected to the water spray nozzle 181.

Accordingly, referring to FIG. 40, in order to better realize the technical effect of the present disclosure, a cleaning method is further provided according to an embodiment of the present disclosure, the cleaning method includes the following steps S100-S300.

In step S100, a cleaning device is provided, the cleaning device includes a heating apparatus 20, an air jet head 120 and a heat exchange pipe 131, the heating apparatus 20 has a heating body 2. Herein, at least a portion of the heat exchange pipe 131 is wrapped around the heating body 2.

In step S300, water in the heat exchanger pipe 131 exchanges heat with the heating body 2 to decrease the temperature of the heating body 2, and to heat water in the heat exchanger pipe 131.

In some embodiments, in step S100, the provided heat exchanger pipe 131 is connected to the heating apparatus 20 to supply water to the heating apparatus 20, and the heating apparatus 20 is connected to the air jet head 120.

Correspondingly, in step S300, heat of the water in the heat exchanger pipe 131 is absorbed by the heating body 2 and thus the water is preheated, and the preheated water is heated and atomized by the heating apparatus 20 and sprayed out from the air jet head 120.

In some embodiments, in step S100, the provided cleaning device further includes a water supply pipe 140 and a water spray nozzle 181. The water supply pipe 140 is connected to the heating apparatus 20 for supplying water to the heating apparatus 20, and the heating apparatus 20 is connected to the air jet head 120. The heat exchange pipe 131 is connected to the water spray nozzle 181 for supplying water to the water spray nozzle 181, and the heat exchange pipe 131 is at least partially wrapped around the heating body 2.

Correspondingly, in step S300, heat of the water in the heat exchanger pipe 131 is absorbed by the heating body 2 and thus the water is heated, and the heated water is sprayed out by the water spray nozzle 181.

A cleaning device and a heating body are provided according to the present disclosure, the cleaning device includes a heating apparatus which is provided with a heating body, the heating body includes a heating body housing, a heat-conducting rod, a heating wire, a thermocouple detecting element and a support body.

The heat-conducting rod is pressed into a chamber of the heating body housing, and the heat-conducting rod is wrapped with a heating wire for heating. In a case that two opposite ends of the heat-conducting rod are noted as a first end and a second end, a thermocouple groove is formed on an end surface of the heat-conducting rod at the first end, and a measurement point of the thermocouple detecting element is arranged in the thermocouple groove. The thermocouple groove is provided with a support body for supporting the heat-conducting rod, and a notch is formed at an end of the support body adjacent to an end of the measurement point, and the measurement point of the thermocouple detecting element is arranged in the notch.

With the cleaning device of the present disclosure, the support body and the thermocouple groove fit together, and the measurement point of the thermocouple detecting element is arranged in the notch at the end of the support body. This allows the support body to not only provide support for the thermocouple groove of the heat-conducting rod, but also protects the measurement point from being damaged due to the collapse of the heat-conducting rod during manufacture of the heating body, or from contact with the heating wire causing a short circuit.

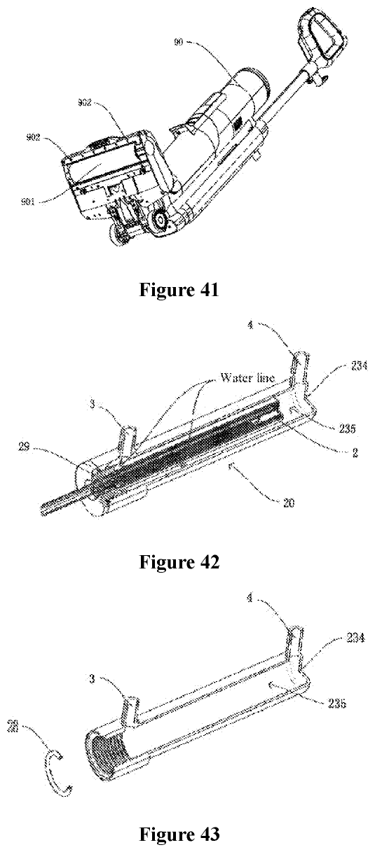

For ease of understanding, the specific structure of the cleaning device of the present disclosure and its operation principle are described in detail below with reference to FIGS. 41 to 53 in conjunction with an embodiment.

As shown in FIGS. 41 and 42, a cleaning device is provided according to the present disclosure, which includes a body 90, a heating apparatus 20 and an air jet head.

As shown in FIG. 41, the body 90 is configured as a carrier for mounting various functional elements required for the cleaning device, and the functional elements of the cleaning device include at least the heating apparatus 20 and the air jet head.

The heating apparatus 20 is arranged on the body 90, and as shown in FIGS. 42 and 43, the heating apparatus 20 includes a housing 1 and a heating body 2, the housing 1 has a heating body chamber 235 inside, and further includes a water inlet 3 and an air outlet 4 in communication with the heating body chamber 235, and the heating body 2 extends from one end of the heating apparatus 20 into the heating body chamber 235 of the heating apparatus 20.

The heating apparatus 20 is configured to allow only a portion of the heating body 2 to be covered with water, and to maintain the surface of the other portion of the heating body 2 not covered with water at a maximum temperature of 280-580° C., so that at least a portion of water entering the heating apparatus 20 from the water inlet 3 is heated and atomized and then sprayed out from the air outlet 4. The term “cover” in the present disclosure means that the water in the internal chamber of the housing 1 is at least in contact with the bottom of the heating body 2 at a certain axial position, or extends from the bottom to a position at the sidewall, or covers the entire surface of the heating body 2 at the axial position. It should be noted that when the temperature of the heating body 2 is increased, the water covering the heating body 2 will be boiling, and the boiling water will be in a “jumping” state in some zone of the heating body 2, which should also be understood as the water covering the heating body 2. Further, the temperature of the heating body 2 is increased as a whole, when the temperature of the heating body 2 is higher than a predetermined temperature, water is injected from the water inlet 3 to internal chamber the housing 1, the injected water will in the “jumping” state when contact with the high-temperature heating body 2, which should also be understood as the water covering the heating body 2.

The surface of the other portion of the heating body 2 not covered with water maintaining at a maximum temperature of 280-580° C. means that in the axial direction of the heating body 2, in a zone that is away from the zone of the heating body covered with water, at least a portion of the surface of the other portion of the heating body 2 not covered with water maintains at the temperature of 280-580° C. The whole surface may maintain at a temperature of 280-580° C., or a portion of the surface maintains at a temperature of 280-580° C. and the other portion of the surface maintains at temperature below 280° C.

The air jet head (not shown in the figure) is provided with a steam path inside, the steam path is interconnected with the air outlet 4 of the heating apparatus 20, and the air jet head is provided with at least one air jet nozzle 902.

It will be appreciated that the cleaning device of the present disclosure may further include a water supply assembly such as a water storage tank and an infusion pump (which are not shown in the figures) and a cleaning assembly such as a roller brush for scrubbing the process surface. The infusion pump is configured to pump water from the water storage tank into the heating body chamber 235 of the heating apparatus 20, and then the heating body 2 heats the water to generate water mist.

As shown in FIG. 41, in an embodiment of the present disclosure, the air jet nozzle 902 and the roller brush 901 are arranged on the bottom of the body 90. When the cleaning device is performing cleaning, the heating apparatus 20 is controlled to spray water mist from the air jet nozzle 902 to brush the process surface while the roller brush 901 is controlled to rotate to scrub the process surface.

Specifically, the steam spraying process of the cleaning device of the present disclosure may include the following steps.

The cleaning device receives a command to spray steam, the infusion pump and the heating apparatus 20 are activated, and water in the reservoir is continuously pumped by the infusion pump to the water inlet 3 of the heating apparatus 20.

After entering the heating apparatus 20 from the water inlet 3, the water will cover a portion of the heating body 2, which has a low temperature, usually below 100° C., while the surface of the other portion of the heating body 2 not covered with water maintains a maximum temperature of 280-580° C., which is higher than the Leidenfrost temperature of water. The water in the zone of the heating body 2 covered with water will be repeatedly flushed to the other portion of the heating body 2 not covered with water during the boiling process, and since the temperature of this portion of the heating body 2 is higher than the Leidenfrost temperature of water, this portion of water will in a membrane boiling state on the surface of the other portion of the heating body 2 not covered with water. In the membrane boiling state, the heating body 2 is indirectly conducting heat to the water inside through an air film attached to the surface. Since the heat conduction coefficient of steam is much smaller than the heat conduction coefficient of water, the boiling speed of water is thereby greatly reduced, so that a portion of the water is broken up into water mist during the flushing process before boiling.

The water mist flows out of the air outlet 4 of the heating apparatus 20, passes through the steam path, and is finally sprayed out from the air jet nozzle 902 of the air jet head, so that the user can see that the cleaning device is spraying water mist normally.

After a number of tests, it has been found that when the surface of the other portion of the heating body 2 not covered with water maintains at the maximum temperature of 280-580° C., the flow rate of the water mist sprayed out from the air jet nozzle 902 is very large, showing a pure white water mist with high visibility, so that the user can easily observe the water mist.

Specifically, as shown in FIG. 42, in an embodiment of the present disclosure, the opposite ends of the heating body 2 are noted as a first end and a second end. The first end is higher than the second end when the cleaning device is arranged on a horizontal surface; and the first end is configured to maintain a maximum surface temperature of 280-580° C. During the operation of the heating apparatus 20 of the present disclosure, after entering the heating apparatus 20 from the water inlet 3 below, water flow gradually upward from below. The water is continuously heated during the flow process, and when the water comes into contact with the other portion of the heating body 2 not covered with water, at least a portion of the water will be heated and atomized, and the water mist will then be sprayed along the heating apparatus, and out of the air outlet 4 above.

In order to further improve the water mist spraying effect of the cleaning device, in an embodiment of the present disclosure, the heating apparatus 20 is configured to maintain the surface of the other portion of the heating body 2 not covered with water at the maximum temperature of 350-400° C. After a number of tests, it has been found that when the heating apparatus 20 is configured to maintain the surface of the other portion of the heating body 2 not covered with water at the maximum temperature of 350-400° C., the amount of water mist sprayed out from the cleaning device is large, and a user can easily see that the cleaning device is spraying water mist normally.

As shown in FIG. 42, in an embodiment of the present disclosure, the second end is fixed to the bottom of the heating body chamber 235, and there is a spacing between the first end and the top of the housing 1. In this way, the first end is in a suspended state and does not contact the top of the housing 1, thereby avoiding the first end from transferring a high amount of heat to the housing 1, which may cause the temperature of the housing 1 to be too high and burn other objects. In fact, in a case that there is water inside the heating apparatus 20, even if the temperature of the first end reaches more than 300° C., the temperature of the outer surface of the housing 1 will basically not exceed 120° C.

As shown in FIG. 42, in an embodiment of the present disclosure, the heating apparatus 20 is arranged on the body 90 at an angle to the horizontal plane. In this way, during the operation of the heating apparatus 20 of the present disclosure, after entering the heating apparatus 20 from the water inlet 3 below, water will cover only a portion of the heating body 2, thereby naturally dividing the heating body 2 into a portion covered with water and another portion not covered with water without the need to set additionally.

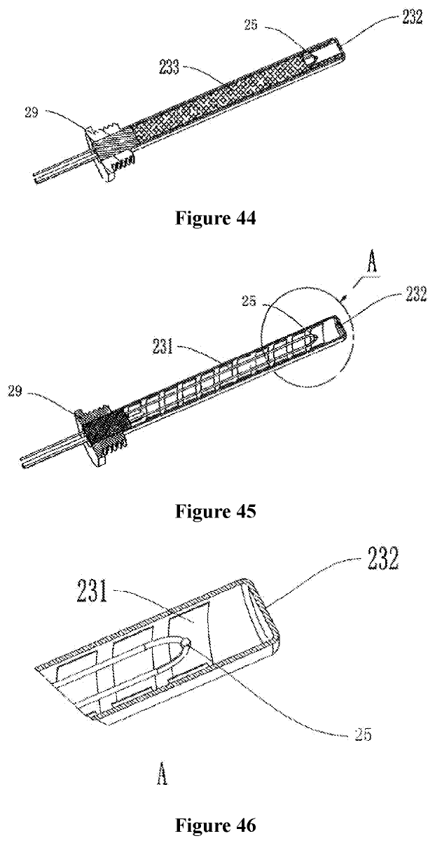

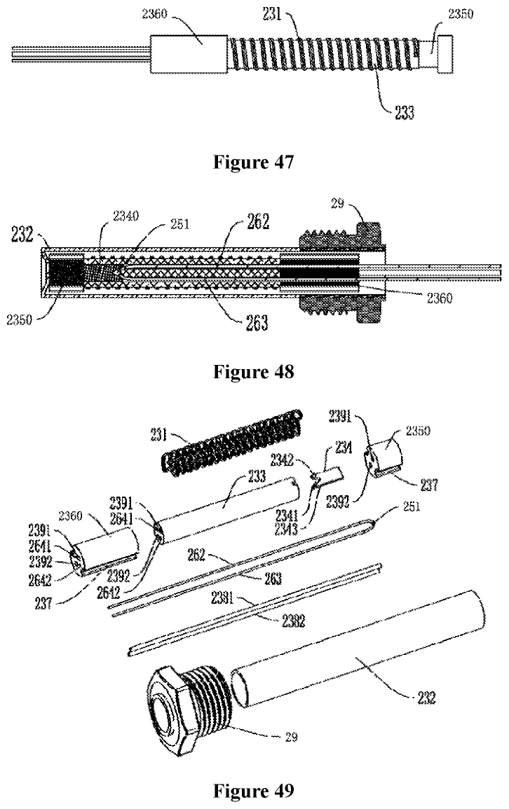

As shown in FIG. 44, FIG. 45, and FIG. 47, in an embodiment of the present disclosure, the heating body 2 includes a heating wire 231, a heat-conducting rod 233, and a heating body housing 232. The heating wire 231 is wrapped around the heat-conducting rod 233, and the heating wire 231 extends from a zone at a first end to a zone at a second end. Both the heat-conducting rod 233 and the heating wire 231 are arranged in the heating body housing 232. The material of the heating body housing 232 may be stainless steel. The heat-conducting rod 233 is used to rapidly conduct the heat generated by the heating wire 231.

As shown in FIGS. 44 and 45, in an embodiment of the present disclosure, the end of the heating body 2 is further provided with an insulating sealing part 29. The insulating sealing part 29 is sealingly arranged at an open end of the heating body housing 234 and is fixedly connected to the second end. The insulating sealing part 29 has two purposes, one is to seal the water inside the housing 1 to avoid the water from flowing out of the housing 1, and the other is to prevent the heating wire from conducting with the outside to avoid power leakage.

As shown in FIG. 42, in an embodiment of the present disclosure, the heating body 2 is arranged separately from the housing 1. The first end is in a suspended state as previously described and does not contact the housing 1, and the second end is only fixedly connected to the insulating sealing part 29 and does not contact the housing 1, so that the first end and the second end can be avoided from transferring heat to the housing 1 and preventing the housing 1 from burning other objects due to the excessively high temperature. In order to further improve the sealing effect, as shown in FIG. 43, in an embodiment of the present disclosure, a sealing ring 6 may further be provided in the insulating sealing part 29, and the sealing ring 6 is used to arrange the insulating sealing part 29 and the housing 1 into sealing contact, further avoiding water from flowing out of the housing 1.

In order to control the temperature of the first end of the heating body 2, as shown in FIG. 46, in an embodiment of the present disclosure, the heating apparatus 20 further includes a temperature detecting element and a control unit (not shown in the figure), the temperature detecting element is configured to detect the temperature of the first end. The control unit is configured to control the heating power of the heating body 2 based on the temperature detecting result of the temperature detecting element, so as to maintain the surface of the first end at a maximum temperature of 280-580° C.

As shown in FIG. 46, in an embodiment of the present disclosure, a detection point of the temperature detecting element is set in the interior of the first end of the heat-conducting rod 233. Since the heat conducting speed of the heating body 2 is large, the temperature measured when the temperature detecting element is arranged in the interior of the first end of the heat-conducting rod 233 may also be considered as the temperature in the zone adjacent to the first end.

As shown in FIG. 46, the temperature detecting element may be a temperature detecting element 25 or other kinds of detecting elements. If the temperature detecting element is the temperature detecting element 25, the measurement point 261 of the temperature detecting element 25 is arranged in the interior of the first end.

As shown in FIG. 47, FIG. 48, and FIG. 49, in an embodiment of the present disclosure, the heating body 2 further includes a front support part 2350 and a rear support part 2360. The front support part 2350 is arranged at the first end of the heat-conducting rod 233 and is configured to support the first end of the heat-conducting rod 233, the rear support part 2360 is arranged at the second end of the heat-conducting rod 233 and is configured to support the second end of the heat-conducting rod 233. Specifically, the front support part 2350 and the rear support part 2360 are arranged at the two ends of the heat-conducting rod 233, so that the heat-conducting rod 233 can be secured at both sides to avoid wobbling of the heat-conducting rod 233.

In an embodiment of the present disclosure, the heating body housing 232 is tightly fitted with the heat-conducting rod 233 after being shrunken, i.e., after the heating body housing 232 is shrunken, the heating body housing 232 may tightly fitted with the heat-conducting rod 233 as well as other components arranged in the heating body housing 232, so that the heat conduction efficiency of the heating body 2 can be effectively improved, and the stability between the various structures is also improved.

Further, as shown in FIG. 49, in an embodiment of the present disclosure, the radial dimensions of the front support part 2350 and the rear support part 2360 are larger than the radial dimension of the heat-conducting rod 233, and through grooves 237 extending in their axial directions are arranged on the outer walls of the front support part 2350 and the rear support part 2360, so that during the process of shrinking of the heating body housing 232, the front support part 2350 and the rear support part 2360 may be deformed at the through groove 237, which is conducive to the shrinking process of the heating body housing 232, and the spacing between the heating body housing 232 and each of the front support part 2350 and the rear support part 2360 can be greatly reduced, so that the front support part 2350 and the rear support part 2360 can be more tightly packed to improve the heat conduction efficiency of the front support part 2350 and the rear support part 2360 and to ensure the stability of structures between the front support part 2350 and the rear support part 2360 and the heat-conducting rod 233.

In an embodiment of the present disclosure, two through grooves 237 opposite to each other and extending in their axial directions may be arranged on the front support part 2350 and the rear support part 2360 as shown in FIG. 49, while in other embodiments of the present disclosure, four or more through grooves 237 extending in their axial directions may be arranged on the front support part 2350 and the rear support part 2360, the number of the through grooves 237 is not limited herein.

As shown in FIG. 48, in an embodiment of the present disclosure, a distance between the detection point 251 of the temperature detecting element 25 and an end surface of the first end of the heat-conducting rod 233 ranges from 5.5-10.5 mm. As shown in the figure, the detection point 251 of the temperature detecting element 25 is a connection point of the positive wire 262 and the negative wire 263, which is located at a distance from the end surface of the first end of the heat-conducting rod 233 in a range of 5.5-10.5 mm to better reflect the maximum temperature of the heating body 2 during operation. This is due to the fact that for the heating body 2, the heating body 2 is heated as a whole, and the temperature at its two end positions will be lower than the temperature at its middle position. When water covers a zone at one end in the axial direction of the heating body 2 and the zone at the other end is not covered with water, the temperature of the heating body 2 at that position will be lowered by the action of water, the zone at the end away from water will maintain its own temperature due to the fact of being not covered with water, and the further the distance from the water, the less the temperature of the heating body 2 will be affected by water. With the dimensional parameters of the heating body 2 of the present disclosure, the detection point 251 is set within a range of 5.5-10.5 mm from the end surface of the first end of the heat-conducting rod 233, which better reflects the maximum temperature of the heating body 2 during operation.

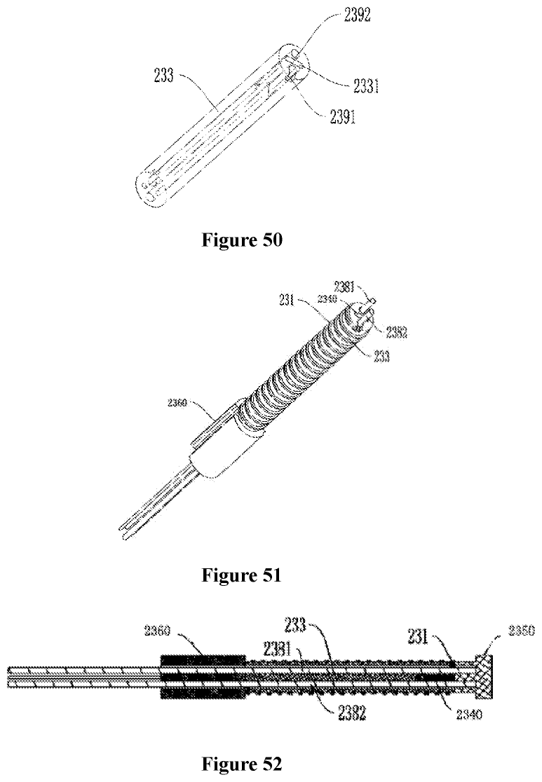

As shown in FIGS. 50 and 51, in an embodiment of the present disclosure, the heat-conducting rod 233 is provided with a thermocouple groove 2331 on the end surface of the first end, and the thermocouple groove 2331 is configured to receive a measurement point 261 of the temperature detecting element 25. The measurement point 261 is a connection point between two metals or alloys forming the temperature detecting element 25. The heating body 2 further includes a support body 2340, the support body 2340 is arranged in the thermocouple groove 2331, and the support body 2340 is provided with a notch 2341 for receiving the measurement point 261 at an end of the support body 2340 adjacent to the measurement point 261 of the temperature detecting element 25.

Specifically, as shown in FIG. 49, in an embodiment of the present disclosure, the support body 2340 is provided with a first extension part 2342, a second extension part 2343 on opposite sides adjacent to the measurement point 261, and the first extension part 2342 and the second extension part 2343 enclose to form the notch 2341 and are configured to provide support to a position in the thermocouple groove 2331 corresponding to the measurement point 261.

In an embodiment of the present disclosure, the section shape of the notch 2341 may be triangular or V-shaped as shown in FIGS. 48 and 49. In other embodiments of the present disclosure, the shape of the notch 2341 may also be a rectangular shape, a circular arc shape, and other shapes known to flexible pipe skilled in the art, as long as the notch can protect the measurement point 261.

By providing the support body 2340 in the thermocouple groove 2331, the first extension part 2342 and the second extension part 2343 can protect the measurement point from both sides during the shrinking process, and the support body 2340 can also effectively support the heat-conducting rod 233 during the shrinking process, preventing the heat-conducting rod 233 from collapsing due to shrinking, which may result in short-circuit between the heating wire 231 and the temperature detecting element 25.

As shown in FIG. 49, in an embodiment of the present disclosure, the support body 2340 is in the form of a sheet, and the thermocouple groove 2331 is configured to have an adapted shape with the support body 2340. Since the support body 2340 is in the form of a sheet, the support body 2340 can well match the shape of the temperature detecting element 25, which can enable the support body 2340 to better support the heat-conducting rod 233 during the shrinking process, thereby preventing the collapse of the heat-conducting rod 233 due to the shrinking.

In an embodiment of the present disclosure, the support body 2340 is configured to be made of the same material as the heat-conducting rod 233. After the heating body housing 232 is shrunk, the support body 2340 is extruded to one piece with the heat-conducting rod 233. The support body 2340 being extruded to one piece with the heat-conducting rod 233 means that there is no longer a spacing between the support body 2340 and the heat-conducting rod 233, or there is no longer a clear boundary between the support body 2340 and the heat-conducting rod 233. In a case that the support body 2340 is extruded to one piece with the heat-conducting rod 233, the heat conduction efficiency of the heat-conducting rod 233 can be effectively improved.

Further, in an embodiment of the present disclosure, the heat-conducting rod 233, the support body 2340, the front support part 2350, and the rear support part 2360 are all made of the material of magnesium oxide. In a case that the heat-conducting rod 233, the support body 2340, the front support part 2350 and the rear support part 2360 are made of the material of magnesium oxide, the heat generated by the heating wire 231 can be rapidly transferred to the heating body housing 232, which in turn heats the water to generate water mist, thereby improving the utilization efficiency of the heat generated by the heating wire 231, and avoiding the heat retained in the interior of the heating body 2, so that the heating body 2 can operate normally.

In an embodiment of the present disclosure, magnesium oxide powder is filled in the space between the heating body housing 232, the heat-conducting rod 233, the front support part 2350 and the rear support part 2360. The heating body housing 232 is configured to be processed by shrinking. By filling the space between the heating body housing 232, the heat-conducting rod 233, the front support part 2350 and the rear support part 2360 with the magnesium oxide powder, the heat conduction efficiency of the heating body 2 can be improved, avoiding that the heat is retained in the heating wires 231, and avoiding that the heating wire 231 come into contact with the heating body housing 232, resulting in power leakage. By shrinking the heating body housing 232, the magnesium oxide powder and the heat-conducting rod 233, the front support part 2350 and the rear support part 2360 in the heating body housing 232 can be made tighter, thereby improving the overall density of the magnesium oxide powder and the heat-conducting rod 233, the front support part 2350 and the rear support part 2360 in the heating body housing 232, avoiding voids that are not easily conductive to heat, thereby improving the heat conduction coefficient of the heating body 2.

As shown in FIGS. 48 and 49, in an embodiment of the present disclosure, the temperature detecting element 25 includes a positive wire 262 and a negative wire 263, the positive wire 262 and the negative wire 263 are two different metals or alloys forming the temperature detecting element 25, e.g., for the K-type temperature detecting element 25, the positive wire 262 and the negative wire 263 may be nickel-chromium and nickel-silicon alloys, respectively. The rear support part 2360 and the portion of the heat-conducting rod 233 near the rear support part 2360 are provided with a positive wire channel 2641 and a negative wire channel 2642, the positive wire channel 2641 and the negative wire channel 2642 are used to receive the positive wire 262 and the negative wire 263, respectively, and the positive wire channel 2641 and the negative wire channel 2642 in the heat-conducting rod 233 are connected to the thermocouple groove 2331, thereby enabling the positive wire 262 and the negative wire 263 to extend from the outside of the second end of the heating body 2 to the thermocouple groove 2331, and are fixedly connected with each other in the thermocouple groove 2331.

As shown in FIG. 49 and FIG. 52, in an embodiment of the present disclosure, the heating body 2 further includes a first wire 2381 and a second wire 2382, and the first wire 2381 and the second wire 2382 are used for connecting an external power source and the heating wire 231, so as to supply power to the heating wire 231. Specifically, the first wire channel 2391 and the second wire channel 2392 are formed on the heat-conducting rod 233, the two ends of the heating wire 231 extend into the first wire channel 2391 and the second wire channel 2392 on the heat-conducting rod 233, respectively. The first wire 2381 and the second wire 2382 penetrates from the rear support part 2360 into the first wire channel 2391 and the second wire channel 2392 of the heat-conducting rod 233 and extend into the front support part 2350. The first wire 2381 and the second wire 2382 are respectively in contact fit with the portions of the heating wire 231 arranged in the first wire channel 2391 and the second wire channel 2392.

Since both ends of the heating wire 231 extend into the first wire channel 2391 and the second wire channel 2392, the heating wire 231 has a good contact with the first wire 2381 in the first wire channel 2391 or the second wire 2382 in the second wire channel 2392, so as to avoid that the heating wire 231 fails to operate properly due to poor contact.

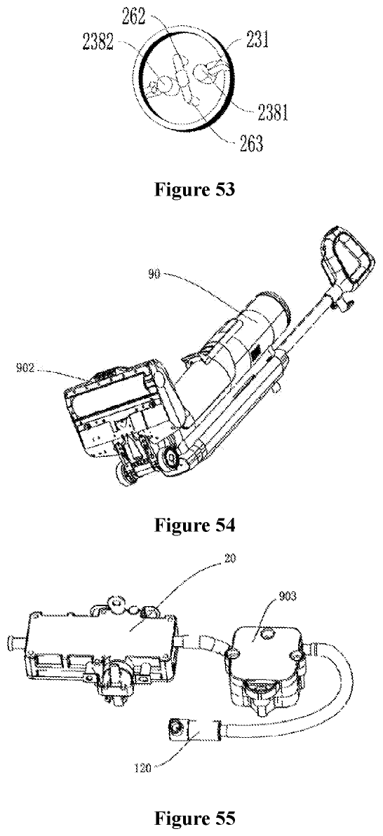

As shown in FIG. 53, in the cross-section of the heating body 2, a line between the positive wire channel 2641 and the negative wire channel 2642 is perpendicular to a line between the first wire channel 2391 and the second wire channel 2392. Since the line between the positive wire channel 2641 and the negative wire channel 2642 is perpendicular to the line between the first wire channel 2391 and the second wire channel 2392, the distance between the positive wire 262 or the negative wire 263 and the first wire 2381 or the second wire 2382 can be maximized, so that the positive wire 262 or the negative wire 263 can be effectively avoided from coming into contact with the first wire 2381 or the second wire 2382, which may cause the heating wire 231 or the temperature detecting element 25 to fail to operate normally.

As the positive wire 262 and the negative wire 263 extend from the outside of the second end of the heating body 2 to the thermocouple groove 2331 on the heat-conducting rod 233 and are fixedly connected with each other in the thermocouple groove 2331, the first wire 2381 and the second wire 2382 penetrate from the rear support part 2360 into the first wire channel 2391 and the second wire channel 2392 of the heat-conducting rod 233, and extend to the front support part 2350, in a case that the front support part 2350, the heat-conducting rod 233 and the rear support part 2360 are mounted into the heating body housing 232, the positive wire 262 or the negative wire 263 and the first wire 2381 or the second wire 2382 can effectively restrict the heat-conducting rod 233 from sliding relative to the front support part 2350 or the rear support part 2360 to ensure that the heat-conducting rod 233 has a good concentricity relative to the front support part 2350 or the rear support part 2360, thereby effectively avoiding contact between the heating wire 231 and the heating body housing 232, which may cause power leakage of the heating body 2.

A heating apparatus 20 is further provided according to the present disclosure, which includes a housing 1 and a heating body 2, the housing 1 has a heating body chamber 235 inside, and a water inlet 3 and an air outlet 4 that are in communication with the heating body chamber 235, and the heating body 2 is arranged in the heating body chamber 235. The heating apparatus 20 is configured to allow only a portion of the heating body 2 to be covered with water and to maintain the surface of the other portion of the heating body 2 not covered with water at a maximum temperature of 280-580° C., to allow at least a portion of water entering the heating apparatus from the water inlet 3 to be heated and atomized and then sprayed out from the air outlet 4. For functions of various structures, reference may be made to the above description of the heating apparatus 20, which will not be repeated herein.

A cleaning device is provided according to the present disclosure, which includes a body, a heating apparatus and an air jet head. The heating apparatus is configured to heat water to generate steam. The air jet head is provided with at least one air jet nozzle and an outlet enclosure part, the air jet head is connected to the heating apparatus and sprays steam through the air jet nozzle. The outlet enclosure part encircles the air jet nozzle, and a cross-sectional area of the gathering chamber enclosed by the outlet enclosure part is larger than a cross-sectional area of the air jet nozzle.

Compared with the existing cleaning device, a user can visibly see the water mist sprayed from the air jet nozzles during the use of the cleaning device of the present disclosure.

Since the cleaning device of the present disclosure has an additional air outlet enclosure part, and the cross-sectional area of the gathering chamber enclosed by the air outlet enclosure part is larger than the cross-sectional area of the air jet nozzle, the high-temperature and high-pressure steam generated by the heating apparatus expands when entering the air outlet enclosure part from the air jet nozzle, and the pressure and temperature are decreased, and a portion of the steam condenses into droplets, thereby generating water mist.

Moreover, the air outlet enclosure part also has a certain gathering effect, thereby increasing the density of the droplets in the water mist, thus enabling the user to more easily see the water mist sprayed from the air jet nozzles.

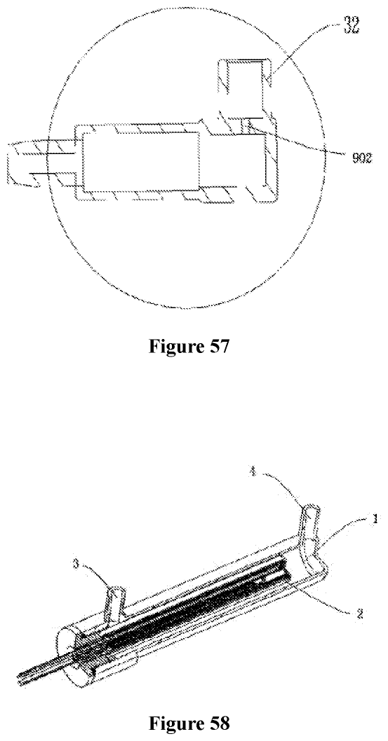

For ease of understanding, the specific structure of the cleaning device of the present disclosure and its operation principle are described in detail below with reference to FIGS. 54 to 57 in connection with an embodiment.

In a first aspect of the present disclosure, a cleaning device is provided, which includes a body 90, a heating apparatus 20 and an air jet head 120.

As shown in FIG. 54, the body 90 is configured as a carrier for mounting various functional elements required for the cleaning device, and the functional elements of the cleaning device include at least the heating apparatus 20 and the air jet head 120.

The heating apparatus 20 is arranged on the body 90 and is configured to heat water to generate steam. The heating apparatus 20 may be a boiler as in FIG. 55, or may contain other forms of construction as long as it is capable of heating all of the water injected from the water inlet into steam.

It will be appreciated that the body 90 is also provided with a water storage tank and an infusion pump (which are not shown in the figures), the infusion pump pumps the water from the water storage tank into the heating apparatus 20, which then heats the water to generate steam.

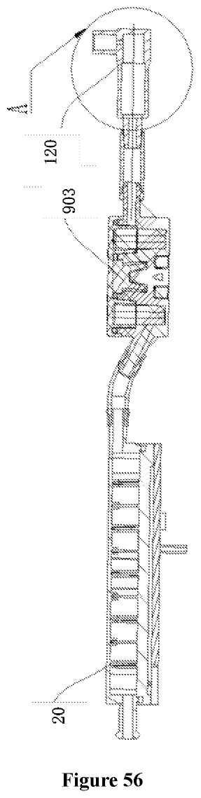

As shown in FIGS. 55 and 56, the air jet head 120 is provided with a steam path inside the air jet head 120, and the steam path is connected with the air outlet of the heating apparatus 20.

The air jet head 120 is provided with at least one air jet nozzle 902 and an outlet enclosure part 32, the outlet enclosure part 32 surrounds the air jet nozzle 902, and a cross-sectional area of the gathering chamber enclosed by the outlet enclosure part 32 is larger than a cross-sectional area of the air jet nozzle 902, the air jet nozzle 902 refers to the air jet nozzle 902 surrounded by the outlet enclosure part 32.

It will be appreciated that the cleaning device of the present disclosure, when performing cleaning, needs to spray water mist out onto the process surface to be cleaned.

In order to improve the cleaning effect, the cleaning device of the present disclosure may also include functional components such as cleaning brushes, rollers, and the like for scrubbing the process surface. As shown in FIG. 54, in an embodiment of the present disclosure, both the air jet nozzle 902 and the roller are arranged on the bottom surface of the body 90. When the cleaning device is performing cleaning, the heating apparatus 20 is controlled to spray water mist from the air jet nozzle 902 to brush the process surface while the roller is controlled to rotate to scrub the process surface.

Specifically, the steam spraying process of the cleaning device of the present disclosure may include the following steps.

The cleaning device receives a command to spray steam, the infusion pump and the heating apparatus 20 are activated, and water in the reservoir is continuously pumped by the infusion pump to the heating apparatus 20 and heated by the heating apparatus 20 to generate steam.

The steam flows out of the air outlet of the heating apparatus 20, passes through the steam path, and is finally sprayed out from the air jet nozzle 902 of the air jet head 120.

The steam forms a water mist as it is sprayed out from the air jet nozzle 902 of the air jet head 120, so that the user can see that the cleaning device is spraying water mist normally.

Compared with the existing cleaning device, the user can clearly see the water mist being sprayed out from the air jet nozzle 902 during the use of the cleaning device of the present disclosure.

As previously mentioned, since the cleaning device of the present disclosure is provided with an air outlet enclosure part 32, and the cross-sectional area of the gathering chamber enclosed by the air outlet enclosure part 32 is larger than the cross-sectional area of the air jet nozzle 902, the high-temperature and high-pressure steam generated by the heating apparatus 20 expands when it enters the air outlet enclosure part 32 from the air jet nozzle 902, and the pressure and temperature are decreased, and a portion of the steam condenses into droplets, thus generating water mist.

Moreover, the air outlet enclosure part 32 also has a certain gathering effect, thereby increasing the density of the droplets in the water mist, thereby enabling the user to more easily see the water mist sprayed out from the air jet nozzle.

Since the water in the water storage tank is not necessarily pure water, there may be impurities such as gravel and rust in it, and hard water containing more calcium and magnesium ions will also form scale particles that are difficult to dissolve in water after boiling.

In order to avoid the impurities or scale particles from clogging the air jet nozzle 902, as shown in FIGS. 55 and 56, in an embodiment of the present disclosure, the cleaning device of the present disclosure further includes a filter apparatus 903.

The filter apparatus 903 is arranged between the heating apparatus 20 and the air jet head 120 and is configured to filter impurities in the steam.

When the steam flows through the filter apparatus 903, impurities such as sand, rust or scale therein are filtered out, so that the steam flowing out of the outlet of the filter apparatus 903 will no longer contain impurities anymore, thereby avoiding the impurities from clogging the air jet nozzle 902.

In order to improve the air jet effect of the cleaning device, in an embodiment of the present disclosure, the parameters of the cleaning device meet the following Expression (1):

$$\frac{L}{ρ A} \geq 272 m / s \qquad Expression ( 1 )$$

where, L represents a flow rate (in a unit of g/s) of the water inlet of the heating apparatus 20. Since the infusion pump pumps water from the water storage tank into the heating apparatus 20, i.e., the reduction rate of water in the water storage tank is equal to the flow rate L of the water inlet of the heating apparatus 20, the flow rate L of the water inlet of the heating apparatus 20 may be obtained by measuring the reduction rate of water in the water storage tank;
ρ represents the density of steam (in a unit of g/m3) in the air jet head 120. When the cleaning device is steadily spraying steam, the density p of the steam in the air jet head 120 is equal to the density of the steam in the entire steam path from the heating apparatus 20 to the air jet nozzle 902, i.e., the mass of the steam in the entire steam path divided by the volume of the steam path. However, the volume of the steam path is difficult to determine, and the density of the steam may be obtained based on the pressure and temperature of the steam, so the density p of the steam in the air jet head 120 may be obtained indirectly by setting a barometer and a thermometer in the air jet head 120 and using the obtained pressure and temperature of the steam.

A represents the sum of the cross-sectional areas (in a unit of m2) of the various air jet nozzles 902.

After repeated tests and a large number of simulations, when the parameters of the cleaning device are adjusted to meet the Expression (1), the cleaning device can spray a large amount of water mist, and the effect is obvious.

As previously mentioned, since the density p of the steam inside the air jet head 120 is equal to the mass of the steam inside the entire steam path divided by the volume of the steam path, and the volume of the entire steam path from the heating apparatus 20 to the air jet nozzle 902 is unchanged, the density of the steam inside the air jet head 120 is then proportional to the mass of the steam inside the entire steam path.

Further, since the heating apparatus 20 is may heat all of the water entering from the water inlet into steam, the density of the steam in the air jet head 120 is then proportional to the flow rate L of the water inlet of the heating apparatus 20. Thus, the infusion pump can adjust the value of

$$\frac{L}{ρ A}$$

by adjusting the flow rate of the pumped water so that the parameters of the cleaning device meet the Expression (1).

As shown in FIGS. 55 to 57, in an embodiment of the present disclosure, the gathering chamber is cylindrical. The cylindrical gathering chamber is not only less difficult to process, but also allows for a more uniform distribution of the sprayed water mist, which can improve the cleaning effect.

In order to improve the water mist spraying effect of the cleaning device, in an embodiment of the present disclosure, the cross-sectional area of the air jet nozzle 902 is 0.35-1.35 mm2. After many tests and simulation simulations, when the cross-sectional area of the air jet nozzle 902 is 0.35-1.35 mm2, the flow rate of the water mist sprayed out from the air jet nozzle 902 is large, the visibility is very high, and the user can easily observe the water mist.

In order to improve the water mist spraying effect of the cleaning device, in an embodiment of the present disclosure, the cross-sectional area of the gathering chamber is 3-50 mm2. After many tests and simulations, when the cross-sectional area of the gathering chamber is 3-50 mm2, the visibility of the water mist sprayed out from the cleaning device is also very high, and the user can easily observe the water mist.

In order to further improve the water mist spraying effect of the cleaning device, in an embodiment of the present disclosure, the cross-sectional area of the gathering chamber is 3-30 mm2. After many tests and simulations, when the cross-sectional area of the gathering chamber is 3-30 mm2, the amount of the water mist sprayed out from the cleaning device is high, and the visibility of the water mist is good.

In order to further improve the water mist spraying effect of the cleaning device, in an embodiment of the present disclosure, the height of the outgassing enclosure part 32 is 5-15 mm.

After many tests and simulations, when the height of the air outlet enclosure part 32 is 5-15 mm, not only is the water mist sprayed by the cleaning device more visible, but the coverage area of the water mist sprayed out from the air jet nozzle 902 is also large, and the cleaning effect is better.

Further, in order to improve the water mist spraying effect of the cleaning device, in an embodiment of the present disclosure, the air outlet enclosure part 32 surrounds at least two air jet nozzles 902. When the air outlet enclosure part 32 surrounds at least two air jet nozzles 902, the distribution of water mist sprayed out from each of the air outlet enclosure part 32 is more uniform.

As shown in FIGS. 54 through 56, a cleaning device is also provided in a second aspect of the present disclosure, which includes a body 90, a heating apparatus 20 and an air jet head 120.

As above described, the body 90 is configured as a carrier for mounting various functional elements required for the cleaning device, and the functional elements of the cleaning device include at least the heating apparatus 20 and the air jet head 120.

The heating apparatus 20 is arranged on the body 90, and the heating apparatus 20 is provided with an internal chamber is arranged inside, and a water inlet 3 and an air outlet 4 in communication with the internal chamber. in order to realize the heating function, the heating apparatus 20 further includes a heating body 2.

The heating apparatus 20 is configured to allow only a portion of the heating body 2 to be covered with water and to maintain a surface of the other portion of the heating body 2 not covered with water at a temperature of 280-580° C., so that at least a portion of the water entering the heating apparatus 20 from the water inlet 3 is heated and atomized and then sprayed out from the air outlet 4.

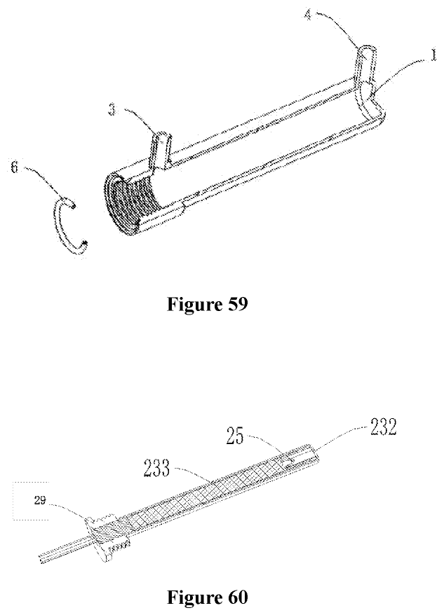

Specifically, as shown in FIGS. 58 to 62, in an embodiment of the present disclosure, the heating apparatus 20 of the present disclosure includes a housing 1 and a heating body 2.

As shown in FIGS. 58 to 60, the housing 1 has an internal chamber, and the heating body 2 extends into the internal chamber.

The heating body 2 includes a heating wire 231, a heat-conducting rod 233 and a heating body housing 232. The heating wire 231 is wrapped around the heat-conducting rod 233. In order to ensure both heat conduction and insulating properties, the material of the heat-conducting rod 233 may be magnesium oxide. The heating wire 231 and the heat-conducting rod 233 are arranged inside the heating body housing 232.

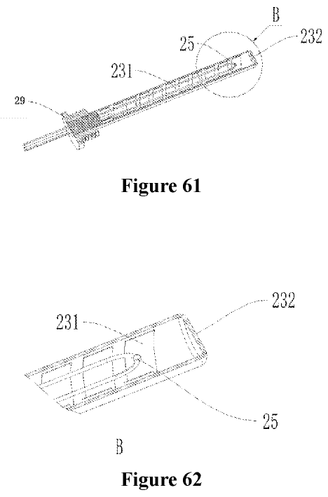

As shown in FIGS. 60 and 61, the heating body 2 is further provided with an insulating sealing part 29 at the end. The insulating sealing part 29 is used for two purposes, one is to seal the water inside the housing 1 to avoid the water from flowing out of the housing 1, and the other is to prevent the heating wire from conducting with the outside to avoid power leakage. In order to further improve the sealing effect, a sealing ring 6 may also be set in the insulating sealing part 29.

Specifically, as shown in FIGS. 58 to 62, the opposite ends of the heating body 2 are noted as a first end and a second end, the first end is higher than the second end, and the first end is configured to maintain a surface temperature of 280-580° C.

In this way, during the operation of the heating apparatus 20 of the present disclosure, after entering the heating apparatus 20 from the water inlet 3 below, water may flow gradually upwardly from below. The water is continuously heated during the process of flowing, and when the water contacts the other portion of the heating body 2 not covered with water, at least a portion of the water will be heated and atomized, and the water mist will then be sprayed out along the heating apparatus, and out of the air outlet 4 above.

It will be appreciated that the body 90 is further provided with a water storage tank and an infusion pump (which are not shown in the figures), and the infusion pump pumps water from the water storage tank into the internal chamber of the heating apparatus 20, and then the heating body 2 heats the water in order to generate water mist. As shown in FIGS. 55 and 56, a steam path is arranged in the air jet head 120, the steam path is interconnected with the air outlet 4 of the heating apparatus 20, and at least one air jet nozzle 902 is arranged on the air jet head 120. The cleaning device of the present disclosure sprays out water mist from the air jet nozzle 902 onto the process surface to be cleaned when performing cleaning.

In order to control the temperature of the first end of the heating body 2, as shown in FIG. 62, in an embodiment of the present disclosure, a temperature detecting element 25 is arranged inside the heating body 2 at the top, and the cleaning device of the present disclosure further includes a control unit (not shown in the figure).

The temperature detecting element 25 is used to detect the temperature of the top of the heating body 2. Since the heat conducting speed of the heating body 2 is fast, although the temperature detecting element 25 is arranged at the top of the heating body 2, the measured temperature may also be considered as the surface temperature of another portion of the heating body 2 not covered with water. As shown in FIGS. 61 and 62, the temperature detecting element 25 may be a thermocouple thermometer or other kinds of thermometers.

The control unit is configured to control the heating power of the heating body 2 based on the temperature detection result of the temperature detecting element 25, so as to maintain the surface of the other portion of the heating body 2 not covered with water at a temperature of 280-580° C.

Specifically, the steam spraying process of the cleaning device of the present disclosure may include the following steps.

The cleaning device receives a command to spray steam, the infusion pump and the heating apparatus 20 are activated, and water in the reservoir is continuously pumped by the infusion pump to the water inlet 3 of the heating apparatus 20.

After entering the heating apparatus 20 from the water inlet 3, water will cover a portion of the heating body 2, which has a low temperature, usually less than 100° C. After the water comes into contact with the heating body 2, which maintains a surface temperature of 280-580° C., at least a portion of the water will be heated and atomized, thereby forming water mist.

The water mist flows out of the air outlet 4 of the heating apparatus 20, passes through the steam path, and is finally sprayed out from the air jet nozzle 902 of the air jet head 120, so that the user can see that the cleaning device is spraying water mist normally.

After many tests, when the surface temperature of the first end of the heating body 2 is 280-580° C., the flow rate of the water mist sprayed out from the air jet nozzle 902 is high, the visibility is high, so that the user can easily observe the water mist.

Since the water can only be heated up to 100° C., when the surface of a portion of the heating body 2 maintains at a temperature of 280-580° C., water will be in a membrane boiling state on the high temperature surface. In the membrane boiling state, the surface is indirectly conducting heat to the water inside through the steam film attached to the surface. As the heat conduction coefficient of steam is much smaller than the heat conduction coefficient of water, thus greatly reducing the speed of boiling water, in such a state, the boiling speed of water is slowed down, the air film on the high temperature surface repeatedly impact water that has not boiled, so that a portion of the water is broken up into water mist before boiling.

In existing cleaning device, taking into account the power consumption control, safety and other factors of the whole machine, the heating temperature of the heating apparatus is usually set to 100-150° C. In this case, although the heating apparatus can generate steam, but cannot generate visible water mist. Compared with the existing cleaning device, during the operation of the cleaning device of the present disclosure, when the water entering into the heating apparatus 20 comes into contact with the surface temperature of the other portion of the heating body 2 not covered with water, at least a portion of the water will be heated and atomized, and the user can visibly see the water mist sprayed from the air jet nozzles 902.

In order to further improve the water mist spraying effect of the cleaning device, in an embodiment of the present disclosure, the heating apparatus 20 is configured to maintain the surface of the other portion of the heating body 2 not covered with water at a temperature of 350-400° C.

After a number of tests, when the heating apparatus 20 is configured to maintain the surface of the other portion of the heating body 2 not covered with water at a temperature of 350-400° C., the amount of water mist sprayed by the cleaning device is large and the user can easily see that the cleaning device is spraying water mist normally.

However, in an embodiment of the present disclosure, the air jet head 120 may be further provided with the aforementioned air jet enclosure part, the air outlet enclosure part 32 surrounds the air jet nozzle 902, and the cross-sectional area of the gathering chamber enclosed by the air outlet enclosure part 32 is larger than the cross-sectional area of the air jet nozzle 902.

In this way, when the water mist is sprayed out from the air jet nozzles 902, a portion of the steam can also condense again, thereby forming more water mist.

Similarly, in an embodiment of the present disclosure, the cleaning device of the present disclosure may also include the aforementioned filter apparatus 903 to filter out impurities in the steam to avoid the impurities from clogging the air jet nozzle 902.

The technical solution in the present disclosure is described below in connection with specific application scenarios to facilitate understanding.

### Application Scenario One

The user turns on a switch of the intelligent device according to the present disclosure, and when the intelligent device is turned on, the steam generator and the water pump are controlled to start. Water in the reservoir is continuously pumped by the water pump to the inlet 91 of the pre-heating pipe 9.

Water will first enter into the pre-heating pipe 9, and pre-heated in the pre-heating pipe 9, then the water enters into the heating chamber 11 from the water inlet 3. The water entering from the water inlet 3 will first contact the heating zone 22 of the heating body 2, and then be heated into steam by the heating zone 22, and the formed steam continuously moves upwardly in an inclined direction along the extension direction of the heating body 2, passes through the high-temperature zone 23, and is secondarily heated into high-temperature steam by the high-temperature zone 23. After passing through the high-temperature zone 23, the high-temperature steam is finally sprayed out from the air outlet 4 at the second end of the steam generator. As the steam is secondarily heated in the high temperature zone 23, the situation in which the steam condenses into water and flows out of the pipe when it flows in the pipe, which results in a large loss of steam, can be avoided. In addition, after the high temperature steam is sprayed out from the air outlet 4 of the steam generator, the temperature difference with the outside air is greater, and more water mist with better visibility can be generated, thus improving the visual effect of the sprayed steam. In addition, the high temperature steam will also vaporize the moisture in the air, thus further forming more water mist.

### Application Scenario Two

The user turns on a switch of the intelligent device according to the present disclosure, and when the intelligent device is turned on, the steam generator and the water pump are controlled to start. Water in the reservoir is continuously pumped by the water pump to the water inlet 3 of the steam generator.

During the use of the steam generator, water will enter the heating chamber 11 from the water inlet 3, and then a portion of the water will boil at the heating zone 22 under the action of the heating body 2, and a portion of the high-temperature water will be sputtered out by the boiling steam, thereby forming a mixture of gaseous water and high-temperature liquid water. The mixture of gaseous water and high-temperature liquid water will be sufficiently heated by the high-temperature zone 23 to generate steam with good visibility, which will be sprayed out from the air outlet 4.

During the boiling of the water, scale particles are precipitated, during the movement of the mixture of gaseous water and high-temperature liquid water as well as the steam in the heating body, the scale particles may adhere to the chamber wall of the heating chamber 11 after coming into contact with the chamber wall of the heating chamber 11. Since the specific gravity of the steam is smaller than the specific gravity of the scale particles, the heating body 2 is gradually inclined upwardly in the direction from the first end to the second end, and the high temperature zone 23 of the heating body 2 is arranged below the scale deposit chamber 15, when the steam mixed with the scale particles moves above the scale deposit chamber 15, more scale particles will be deposited in the scale deposit chamber 15, and less scale will be deposited on the top of the heating body 2. As the space above the heating body 2 for receiving the scale is larger, the time required for the scale to fill the space above the heating body 2 is extended.

When the steam mixed with scale particles passes through the filter assembly 16, because the filter assembly 16 is arranged in the scale deposit chamber 15, scale particles that fail to deposit and have a particle size larger than the mesh diameter of the filter may be retained by the filter assembly 16 when the steam passes through the filter assembly 16, which in turn reduces the particle size of the scale particles of the steam that flows out of the air outlet 4 considerably and avoids clogging of the subsequent air jet nozzle and other structures.

### Application Scenario Three

A user turns on a switch of the cleaning device according to the present disclosure.

The cleaning device receives a jet command, the infusion pump and the heating apparatus 20 are activated, and water in the reservoir is continuously pumped by the infusion pump to the water inlet 3 of the heating apparatus 20.

After entering the heating apparatus 20 from the water inlet 3, the water will cover a portion of the heating body 2, which has a low temperature, usually below 100° C., while the surface of the other portion of the heating body 2 not covered with water maintains at a maximum temperature of 280-580° C., which is higher than the Leidenfrost temperature of water. The boiled water will be repeatedly flushed to the other portion of the heating body 2 not covered with water during the boiling process, and since the temperature of this portion of the heating body 2 is higher than the Leidenfrost temperature of the water, this portion of the water will in a membrane boiling state on the surface of the other portion of the heating body 2 not covered with water. In the membrane boiling state, the heating body 2 is indirectly conducting heat to water inside via an air film attached to the surface. Since the heat conduction coefficient of steam is much smaller than the heat conduction coefficient of water, the boiling speed of water is thereby greatly reduced, so that a portion of the water is broken up into water mist during the flushing process before boiling.

The water mist flows out of the air outlet 4 of the heating apparatus 20, passes through the steam path, and is finally sprayed out from the air jet nozzle 902 of the air jet head, so that the user can see that the cleaning device is spraying water mist normally.

The user may then simultaneously turn on the roller brush 901, and control the heating apparatus 20 to spray water mist from the air jet nozzles 902 to brush the process surface while controlling the roller brush 901 to rotate to scrub the process surface.

### Application Scenario Four

A user turns on a switch of the cleaning device according to the present disclosure.

The cleaning device receives a jet command, the infusion pump and the heating apparatus 20 are activated, and water in the reservoir is continuously pumped by the infusion pump to the water inlet 3 of the heating apparatus 20.

After entering the heating apparatus 20 from the water inlet 3, the water will cover a portion of the heating body 2, which has a low temperature, usually below 100° C., while the surface of the other portion of the heating body 2 not covered with water maintains at a maximum temperature of 280-580° C., which is higher than the Leidenfrost temperature of water. The boiled water will be repeatedly flushed to the other portion of the heating body 2 not covered with water during the boiling process, and since the temperature of this portion of the heating body 2 is higher than the Leidenfrost temperature of the water, this portion of the water will in a membrane boiling state on the surface of the other portion of the heating body 2 not covered with water. In the membrane boiling state, the heating body 2 is indirectly conducting heat to water inside via an air film attached to the surface. Since the heat conduction coefficient of steam is much smaller than the heat conduction coefficient of water, the boiling speed of water is thereby greatly reduced, so that a portion of the water is broken up into water mist during the flushing process before boiling.

The water mist flows out of the air outlet 4 of the heating apparatus 20, passes through the steam path, and is finally sprayed out from the air jet nozzle 902 of the air jet head, so that the user can see that the cleaning device is spraying water mist normally.

The user may then simultaneously turn on the roller brush 901, and control the heating apparatus 20 to spray water mist from the air jet nozzles 902 to brush the process surface while controlling the roller brush 901 to rotate to scrub the process surface.

### Application Scenario Five

The heating body of the present disclosure includes a heating body housing 232, a heat-conducting rod 233, a heating wire 231, a temperature detecting element 25, and a support body 2340. A thermocouple groove 2331 is formed on the end surface of the heat-conducting rod 233 at a first end, and a detection point 251 of the temperature detecting element 25 is set in the thermocouple groove 2331. The thermocouple groove 2331 is provided with a support body 2340 for supporting the heat-conducting rod 233, and a notch 2341 is formed at an end of the support body 2340 adjacent to one end of the detection point 251, and the detection point 251 of the temperature detecting element 25 is set in the notch 2341.

When the heating body housing 232 is shrunk, since the support body 2340 is cooperated with the thermocouple groove 2331, this allows the support body 2340 to support the position of the thermocouple groove 2331, avoiding collapsing of the heat-conducting rod 233 at the position of the thermocouple groove 2331 after shrinking. In addition, the detection point 251 of the temperature detecting element 25 is located in the notch 2341 of the support body, which allows the support body 2340 to provide good protection for the detection point 251, avoiding damage to the detection point 251 due to the collapse of the heat-conducting rod 233, as well as avoiding a short-circuit caused by the detection point 251 in contact with the heating wire 231 due to the collapsing of the heat-conducting rod 233.

### Application Scenario Six

The user turns on a switch of the intelligent device according to the present disclosure, and when the intelligent device is turned on, the steam generator and the water pump are controlled to start. Water in the reservoir is continuously pumped by the water pump to the water inlet 3 of the steam generator.

During the use of the steam generator, water will enter the heating chamber 11 from the water inlet 3, and then a portion of the water will boil at the heating zone 22 under the action of the heating body 2, and a portion of the high-temperature water will be sputtered out by the boiling steam, thereby forming a mixture of gaseous water and high-temperature liquid water. The mixture of gaseous water and high-temperature liquid water will be sufficiently heated by the high-temperature zone 23 to generate steam with good visibility, which will be sprayed out from the air outlet 4.

During the boiling of the water, scale particles are precipitated, during the movement of the mixture of gaseous water and high-temperature liquid water as well as the steam in the heating body, the scale particles may adhere to the chamber wall of the heating chamber 11 after coming into contact with the chamber wall of the heating chamber 11. Since the specific gravity of the steam is smaller than the specific gravity of the scale particles, the heating body 2 is gradually inclined upwardly in the direction from the first end to the second end, and the high temperature zone 23 of the heating body 2 is arranged below the scale deposit chamber 15, when the steam mixed with the scale particles moves above the scale deposit chamber 15, more scale particles will be deposited in the scale deposit chamber 15, and less scale will be deposited on the top of the heating body 2. As the space above the heating body 2 for receiving the scale is larger, the time required for the scale to fill the space above the heating body 2 is extended.

When the steam mixed with scale particles passes through the filter assembly 16, because the filter assembly 16 is arranged in the scale deposit chamber 15, scale particles that fail to deposit and have a particle size larger than the mesh diameter of the filter may be retained by the filter assembly 16 when the steam passes through the filter assembly 16, which in turn reduces the particle size of the scale particles of the steam that flows out of the air outlet 4 considerably and avoids clogging of the subsequent air jet nozzle and other structures.

### Application Scenario Seven

In a first application example, a steam scrubber is provided, the steam scrubber including a heat exchanger pipe 131, a heating apparatus 20 and an air jet head 120. The heating apparatus 20 has a heating body 2, the heating body 2 has an air outlet 4, a sealing rubber sleeve is arranged at the air outlet 4, and at least a portion of the heat exchanger pipe 131 is wrapped around the heating body 2. Cold water supplied by the heat exchange pipe 131 exchange heat with the heating body 2 of the heating apparatus 20 to cool the heating body 2 and to keep the temperature of the heating body 2 below the temperature resistance value of the sealing rubber sleeve. In addition, the water in the heat exchange pipe 131 absorbs heat from the heating body 2, and thus the temperature of the water is raised.

### Application Scenario Eight

In a second application example, a structure of a steam scrubber provided is substantially the same as that in first application example, with the difference that the heat exchange pipe 131 includes a first segment 1311, a first heat exchange segment 1312, and a second segment 1313 sequentially connected, the first segment 1311 is configured with a pump body, the first heat exchange segment 1312 is wrapped around the end of the heating body 2, the second segment 1313 is connected to the heating apparatus 20. In use, cold water is pumped through the pump body, and the cold water passes through the first segment 1311, the first heat exchange segment 1312 and the second segment 1313 in turn, and then enters into the heating apparatus 20 and is heated to be as steam and is sprayed out. Here, the surface temperature of the heating body 2 after the heating apparatus 20 is energized can reach 400-700° C. Cold water can play a cooling role when entering the first heat exchange segment 1312, so that the surface temperature at the end of the heating body 2 is decreased to about 100° C., in order to satisfy the temperature-resistant value of the sealing rubber sleeve arranged on the heating body 2, so that the sealing rubber sleeve will not be burnt and damaged. Further, the heat of the heating body 2 is absorbed by the cold water, so that the temperature of the cold water through the first heat exchange segment 1312 is increased to about 60° C. Further, the water that has been preheated to 60° C. enters into the heating apparatus 20 for heating, which can shorten the time for forming steam, thus improving the heating efficiency of the heating apparatus 20.

### Application Scenario Nine

In a third application example, a structure of a steam scrubber is substantially the same as that in the first application example, with the difference that the steam scrubber further includes a water supply pipe 140, a roller brush 901 and a water spray nozzle 181 provided towards the roller brush 901. The water supply pipe 140 is connected to a water inlet 3 of the heating apparatus 20 to supply water to the heating apparatus 20. The heat exchanger pipe 131 includes a first segment 1311, a first heat exchange segment 1312, a second segment 1313 connected in sequence, the first heat exchange segment 1312 is wrapped around the end of the heating body 2, the second segment 1313 is connected to the water spray nozzle 181. Herein, the water supply pipe 140 is a steam water pipe for supplying water to the heating apparatus 20, which when energized will heat water to a steam state. The heat exchanger pipe 131 is a water spray water pipe, when cold water enters the first heat exchange segment 1312 wrapped around the heating body 2, it will absorb the waste heat on the surface of the heating body 2, and then the cold water will be heated into hot water at 70° C. and flow to the water spray nozzle 181, the water spray nozzle 181 sprays the hot water to the roller brush 901, which helps to increase the cleaning efficiency and the cleaning ability of the roller brush 901 for dealing with scales.

### Application Scenario Ten

In a fourth application example, on the basis of the steam scrubber provided in the second application example or the third application example, the steam scrubber is configured in a cordless form, i.e., a power supply assembly is arranged on the body of the steam scrubber, and the power supply assembly is used to supply power to a drive mechanism 132, such as a pump, in the heating apparatus 20 and the cooling apparatus 130. Herein, since the waste heat of the heating apparatus 20 is utilized to heat the cold water in the water supply pipe 140, power consumption of the heating apparatus 20 for heating the cold water is saved, thus increasing the duration of the whole machine. It is understood that in the above-described embodiments, each term has the same meaning, and the realization details that are not described in a certain embodiment can be referred to the descriptions in the other embodiments, and the exemplary descriptions and technical effects shown in the foregoing embodiments can be realized correspondingly, and the present specification will not repeat the repetitive contents further. The cleaning device, the cleaning assembly and the cleaning method according to the present disclosure are described in detail above, and specific examples are applied herein to illustrate the principles and implementation of the present disclosure, and the description of the above embodiments is only used to assist in the understanding of the method of the present disclosure and its core ideas. Further, for those skilled in the art, based on the ideas of the present disclosure, there will be changes in the specific embodiments and application scopes. Therefore, the specification should be considered as limiting the present disclosure.

### Application Scenario Eleven

A user turns on a switch of the cleaning device according to the present disclosure.

The cleaning device receives a jet command, the infusion pump and the heating apparatus 20 are activated, and water in the reservoir is continuously pumped by the infusion pump to the water inlet 3 of the heating apparatus 20.

After entering the heating apparatus 20 from the water inlet 3, the water will cover a portion of the heating body 2, which has a low temperature, usually below 100° C., while the surface of the other portion of the heating body 2 not covered with water maintains at a maximum temperature of 280-580° C., which is higher than the Leidenfrost temperature of water. The boiled water will be repeatedly flushed to the other portion of the heating body 2 not covered with water during the boiling process, and since the temperature of this portion of the heating body 2 is higher than the Leidenfrost temperature of the water, this portion of the water will in a membrane boiling state on the surface of the other portion of the heating body 2 not covered with water. In the membrane boiling state, the heating body 2 is indirectly conducting heat to water inside via an air film attached to the surface. Since the heat conduction coefficient of steam is much smaller than the heat conduction coefficient of water, the boiling speed of water is thereby greatly reduced, so that a portion of the water is broken up into water mist during the flushing process before boiling.

The water mist flows out of the air outlet 4 of the heating apparatus 20, passes through the steam path, and is finally sprayed out from the jet nozzle 902 of the air jet head, so that the user can see that the cleaning device is spraying water mist normally.

The user may then simultaneously turn on the roller brush 901, and control the heating apparatus 20 to spray water mist from the air jet nozzle 902 to brush the process surface while controlling the roller brush 901 to rotate to scrub the process surface.

### Application Scenario Twelve

The heating body of the present disclosure includes a heating body housing 232, a heat-conducting rod 233, a heating wire 231, a temperature detecting element 25, and a support body 2340. A thermocouple groove 2331 is formed on the end surface of the heat-conducting rod 233 at a first end, and a measurement point 261 of the temperature detecting element 25 is set in the thermocouple groove 2331. The thermocouple groove 2331 is provided with a support body 2340 for supporting the heat-conducting rod 233, and a notch 2341 is formed at an end of the support body 2340 adjacent to one end of the measurement point 261, and the measurement point 261 of the temperature detecting element 25 is set in the notch 2341.

When the heating body housing 232 is shrunk, since the support body 2340 is cooperated with the thermocouple groove 2331, this allows the support body 2340 to support the position of the thermocouple groove 2331, avoiding collapsing of the heat-conducting rod 233 at the position of the thermocouple groove 2331 after shrinking. In addition, the measurement point 261 of the temperature detecting element 25 is located in the notch 2341 of the support body, which allows the support body 2340 to provide good protection for the measurement point 261, avoiding damage to the measurement point 261 due to the collapse of the heat-conducting rod 233, as well as avoiding a short-circuit caused by the measurement point 261 in contact with the heating wire 231 due to the collapsing of the heat-conducting rod 233.

### Application Scenario Thirteen

A user turns on a switch of the cleaning device provided in the first aspect of the present disclosure.

The cleaning device receives a jet command, the infusion pump and the heating apparatus 20 are activated, water in the reservoir is continuously pumped by the infusion pump to the heating apparatus 20, and the heating apparatus 20 heats the water to generate steam.

The steam flows out of the outlet of the heating apparatus 20, passes through the steam path, and is finally sprayed over the air jet nozzle 902 of the air jet head 120.

Since the cleaning device of the present disclosure is provided with an air outlet enclosure part 32, and the cross-sectional area of the gathering chamber enclosed by the air outlet enclosure part 32 is larger than the cross-sectional area of the air jet nozzle 902, the high temperature and high pressure steam generated by the heating apparatus 20 expands when it enters the air outlet enclosure part 32 from the air jet nozzle 902, and the pressure and temperature decreases, and a portion of the steam condenses into droplets, thus generating a water mist.

Moreover, the air outlet enclosure part 32 also has a certain gathering effect, thereby increasing the density of the droplets in the water mist, thereby enabling the user to easily see the water mist sprayed out from the air jet nozzle 902.

### Application Scenario Fourteen

The user turns on a switch of the cleaning device provided in the second aspect of the present disclosure.

The cleaning device receives a jet command, the infusion pump and the heating apparatus 20 are activated, and water in the reservoir is continuously pumped by the infusion pump into the water inlet 3 of the heating apparatus 20.

Since the water can only be heated up to 100° C., when the surface of a portion of the heating body 2 maintains at a temperature of 280-580° C., water will be in a membrane boiling state on the high temperature surface. In the membrane boiling state, the surface indirectly conducts heat to the water inside through the steam film attached to the surface. As the heat conduction coefficient of steam is much smaller than the heat conduction coefficient of water, thus greatly reducing the speed of boiling water, in such a state, the boiling speed of water is slowed down, the air film on the high temperature surface repeatedly impact water that has not boiled, so that a portion of the water is broken up into water mist before boiling.

The water mist in the heating apparatus 20 will flow out of the outlet 4, pass through the steam path, and is finally sprayed out from the air jet nozzle 902 of the air jet head 120, so that the user can see that the cleaning device is spraying water mist normally.

Item A1. A steam generator, including a heating body, a heating chamber, and a water inlet and an air outlet that are in communication with the heating chamber, where
the heating body is configured to heat water entering into the heating chamber from the water inlet; and
the heating body includes a heating zone covered with water, and a high temperature zone not covered with water; the water on the heating zone is heated to form steam, and the steam is sprayed out from the air outlet after passing through the high temperature zone.

Item A2. The steam generator according to Item A1, where at least a portion of entire circumferential sidewall of the heating body is configured to be not covered with water, to form the high temperature zone.

Item A3. The steam generator according to Item A1, where the heating body includes a heat-conducting part and a heating part, and a hollow internal chamber of the heat-conducting part serves as the heating chamber; and
the heating part is configured to be wrapped around at least a portion of an outer surface of the heat-conducting part.

Item A4. The steam generator according to Item A3, where the steam generator includes a first end and a second end that are opposite to each other along an axial direction of the steam generator;
the water inlet is arranged at the first end of the steam generator, and the air outlet is arranged at the second end of the steam generator; and
the heating body is configured to gradually incline upwardly from the first end to the second end, the heating zone is at a position adjacent the first end of the heating body.

Item A5. The steam generator according to Item A4, where in a direction from the first end to the second end, an inclination angle R of the heating body with respect to a horizontal plane meets the following relationship: 5°≤R≤60°.

Item A6. The steam generator according to Item A4, where the steam generator further includes a housing, the heat-conducting part is arranged in an internal chamber of the housing, and a water injection pipe joint of the water inlet is arranged at a first end of the housing.

Item A7. The steam generator according to Item A6, where the heating part is configured to have a predetermined distance in an axial direction of the heat-conducting part respectively from a first end and a second end of the heat-conducting part.

Item A8. The steam generator according to Item A7, further including:
a pre-heating pipe, being wrapped around the heat-conducting part at a position adjacent to the second end of the heat-conducting part, where
an inlet of the pre-heating pipe is configured to be connected to an outside water source, and an outlet of the pre-heating pipe is configured to be connected to the water inlet via a pipe.

Item A9. The steam generator according to Item A8, where the pre-heating pipe is wrapped around the heat-conducting part at a position staggered from the heating part.

Item A10. The steam generator according to Item A1, where the steam generator includes a housing, an internal chamber of the housing serves as the heating chamber; the heating body is arranged in the heating chamber and is configured to extend in the heating chamber along a direction from a first end to a second end, and where a space above the heating body is larger than a space below the heating body in the heating chamber.

Item A11. The steam generator according to Item A10, where the housing includes:
a first enclosure part arranged below the heating body,
a flaring part connected to the first enclosure part and inclined outwardly from a position of connection with the first enclosure part to outside of the heating body; and
a second enclosure part arranged above the heating body and connected to the flaring part.

Item A12. The steam generator according to Item A11, where the first enclosure part and the second enclosure part are in a circular arc shape, and a radius of curvature of the first enclosure part is smaller than a radius of curvature of the second enclosure part.

Item A13. The steam generator according to Item A1, where the high temperature zone maintains at a temperature of 280-580° C.

Item A14. The steam generator according to any one of Items A1 to 13, where the steam generator is provided with a scale deposit chamber in communication with the heating chamber, the scale deposit chamber is arranged on a side adjacent to the high temperature zone and is configured to receive scale.

Item A15. The steam generator according to Item A14, where the air outlet is arranged on the steam generator at a position corresponding to the scale deposit chamber, a filter assembly is arranged in the scale deposit chamber, the filter assembly is configured to cover the air outlet.

Item A16. An intelligent device, including the steam generator according to any one of Items A1 to A15.

Item B1. A cleaning device, including:
a body;
a heating apparatus, where the heating apparatus includes a housing and a heating body, the housing has an internal chamber inside as well as a water inlet and an air outlet that are in communication with the internal chamber, the heating body is arranged in the internal chamber, and the heating apparatus is configured to allow only a portion of the heating body to be covered with water and to maintain a surface of the other portion of the heating body not covered with water to be at a maximum temperature of 280-580° C., to allow at least a portion of water entering the heating apparatus from the water inlet to be heated and atomized and sprayed out from the air outlet; and
an air jet head, connected to the air outlet to spray water mist out.
Item B2. The cleaning device according to Item B1, where the heating body includes a first end and a second end that are opposite to each other, in a case that the cleaning device is arranged in a horizontal plane, the first second is located higher than the first end and configured to be not covered with water in the heating body; and the air outlet is arranged on the housing at a position opposite to the second end.

Item B3. The cleaning device according to Item B2, where the heating apparatus is configured to maintain the surface of another portion of the heating body not covered with water at a maximum temperature of 350-400° C.

Item B4. The cleaning device according to Item B2, where the first end is fixed to a bottom of the internal chamber and there is a spacing between the second end and the top of the housing.

Item B5. The cleaning device according to Item B2, where the heating apparatus is arranged on the body and has at an angle with respect to the horizontal plane.

Item B6. The cleaning device according to Item B2, where the heating body includes:
a heat-conducting rod;
a heating wire, wrapped around the heat-conducting rod and extending from a zone at the first end to a zone at the second end; and
a heating body housing, where the heat-conducting rod and the heating wire are both arranged in the heating body housing.

Item B7. The cleaning device according to Item B6, where the heat-conducting rod is made of a material of magnesium oxide.

Item B8. The cleaning device according to Item B7, where magnesium oxide powder is filled between the heat-conducting rod and the heating body housing.

Item B9. The cleaning device according to Item B6, where the heating apparatus further includes:
a temperature detecting element, configured to detect a temperature of the second end; and
a control unit, configured to control a heating power of the heating body based on a temperature detection result of the temperature detecting element, to maintain a surface of the second end at a maximum temperature of 280-580° C.

Item B10. The cleaning device according to Item B9, where a detection point of the temperature detecting element is set inside the heat-conducting rod at the second end.

Item B11. The cleaning device according to Item B10, where the temperature detecting element includes a thermocouple detecting element, and a measuring end of the thermocouple detecting element is set inside the second end.

Item B12. The cleaning device according to Item B2, where the heating apparatus further includes:
an insulating sealing part, sealingly arranged at an open end of the housing and fixedly connected to the second end.

Item B13. The cleaning device according to Item B12, where the heating body is arranged separately from the housing.

Item B14. The cleaning device according to Item B12, the heating apparatus further includes:
a sealing ring, sleeved on the insulating sealing part and configured to set the insulating sealing part and the housing into sealing contact.

Item B15. A heating apparatus, including a housing and a heating body, the housing has an internal chamber inside as well as a water inlet and an air outlet that are in communication with the internal chamber, the heating body is arranged in the internal chamber; the heating apparatus is configured to allow only a portion of the heating body to be covered with water and to maintain a surface of another portion of the heating body not covered with water at a maximum temperature of 280-580° C., to allow at least a portion of water entering the heating apparatus from the water inlet to be heated and atomized and sprayed out from the air outlet.

Item C1. A cleaning device, including:
a body;
a heating apparatus, where the heating apparatus includes a housing and a heating body, the housing has an internal chamber inside as well as a water inlet and an air outlet that are in communication with the internal chamber, the heating body is arranged in the internal chamber; the heating apparatus is configured to allow only a portion of the heating body to be covered with water and to maintain a surface of another portion of the heating body not covered with water at a maximum temperature of 280-580° C., to allow at least a portion of water entering the heating apparatus from the water inlet to be heated and atomized and sprayed out from the air outlet; and
an air jet head, connected to the air outlet to spray water mist out.

Item C2. The cleaning device according to Item C1, where the heating body includes a first end and a second end that are opposite to each other, in a case that the cleaning device is arranged in a horizontal plane, the second end is located higher than the first end and configured to be not covered with water; and the air outlet is arranged on the housing at a position corresponding to the second end.

Item C3. The cleaning device according to Item C2, where the heating apparatus is configured to maintain the surface of the heating body not covered with water at a maximum temperature of 350-400° C.

Item C4. The cleaning device according to Item C2, where the heating apparatus is configured to be arranged on the body and has an angle with respect to a horizontal plane.

Item C5. The cleaning device according to Item C2, where the heating body includes:
a heat-conducting rod;
a heating wire, the heating wire is wrapped around the heat-conducting rod and extends from a zone at a first end to a zone at a second end; and
a heating body housing, the heat-conducting rod and the heating wire are both arranged in the heating body housing.

Item C6. The cleaning device according to Item C5, where the heating apparatus further includes:
a temperature detecting element, configured to detect a temperature of the second end; and
a control unit, configured to control a heating power of the heating body based on a temperature detection result of the temperature detecting element, to maintain a surface of the second end at a maximum temperature of 280-580° C.

Item C7. The cleaning device according to Item C6, where the temperature detecting element includes a thermocouple detecting element, a measurement point of the thermocouple detecting element is set inside the heat-conducting rod.

Item C8. The cleaning device according to Item C7, where a distance between the measurement point of the thermocouple detecting element and an end surface of the second end of the heat-conducting rod ranges from 5.5 mm to 10.5 mm.

Item C9. The cleaning device according to Item C7, where a thermocouple groove is formed on an end surface of the second end of the heat-conducting rod, the thermocouple groove is configured to receive the measurement point of the thermocouple detecting element; and
the heating body further includes a support body, the support body is configured to cooperate with the thermocouple groove; the support body is provided with a notch at an end adjacent to the measurement point, the measurement point is set in the notch.

Item C10. The cleaning device according to Item C9, where the heating body further includes a front support part and a rear support part; and
the front support part is arranged at the second end of the heat-conducting rod and is configured to support the second end of the heat-conducting rod, the rear support part is arranged at the first end of the heat-conducting rod and is configured to support the first end of the heat-conducting rod.

Item C11. The cleaning device according to Item C10, where the heat-conducting rod, the support body, the front support part, and the rear support part are all made of a material of magnesium oxide.

Item C12. The cleaning device according to Item C10, where the thermocouple detecting element includes a positive wire and a negative wire;
the rear support part and a portion of the heat-conducting rod near the rear support part are respectively provided with a positive wire channel and a negative wire channel, and the positive wire channel and negative wire channel in the heat-conducting rod are in communication with the thermocouple groove; and
the positive wire and the negative wire each extend from an outside of the first end of the heating body to the thermocouple groove, and are connected with each other in the thermocouple groove to form the measurement point.

Item C13. The cleaning device according to Item C12, where the heat-conducting rod is provided with a first wire channel and a second wire channel; two ends of the heating wire respectively extend into the first wire channel and the second wire channel on the heat-conducting rod; and
the heating body further includes a first wire and a second wire, the first wire and the second wire penetrate from the rear support part respectively into the first wire channel and the second wire channel of the heat-conducting rod and extend into the front support part; the first wire and the second wire contact and cooperate with portions of the heating wire respectively in the first wire channel and the second wire channel.

Item C14. The cleaning device according to Item C13, where in a cross-section of the heating body, a line between the positive wire channel and the negative wire channel is perpendicular to a line between the first wire channel and the second wire channel.

Item C15. The cleaning device according to Item C13, where magnesium oxide powder is filled in a space between the heating body housing, the heat-conducting rod, the front support part and the rear support part, and the heating body housing is configured to be shrunk-processed.

Item C16. A heating apparatus, including a housing and a heating body, the housing has an internal chamber inside as well as a water inlet and an air outlet that are in communication with the internal chamber, the heating body is arranged in the internal chamber; the heating apparatus is configured to allow only a portion of the heating body to be covered with water, and to maintain a surface of another portion of the heating body not covered with water at a maximum temperature of 280-580° C., to allow at least a portion of water entering the heating apparatus from the water inlet to be heated and atomized and sprayed out from the air outlet.

Item D1. A steam generator, where the steam generator has a first end and a second end that are opposite to each other along an axial direction of the steam generator; where the steam generator includes:
a housing, where the housing is provided with a heating chamber inside as well as a water inlet and an air outlet that are in communication with the heating chamber; and
a heating body, arranged inside the heating chamber and configured to extend in the heating chamber along a direction from the first end to the second end; water entering the heating chamber from the water inlet is configured to be heated and atomized under the action of the heating body and sprayed out from the air outlet;
where a space above the heating body is larger than a space under the heating body in the heating chamber.

Item D2. The steam generator according to Item D1, where the housing includes:
a first enclosure part arranged below the heating body;
a flaring part connected to the first enclosure part and inclined outwardly from a position connected to the first enclosure part to the outside of the heating body; and
a second enclosure part arranged above the heating body and connected to the flaring part.

Item D3. The steam generator according to Item D2, where the first enclosure part and the second enclosure part are in a circular arc shape, and a radius of curvature of the first enclosure part is smaller than a radius of curvature of the second enclosure part.

Item D4. The steam generator according to Item D3, where opposite sides of the first enclosure part extend at least above a bottom of the heating body.

Item D5. The steam generator according to Item D3, where a distance L1 between a bottom of the heating body and the first enclosure part meets the following relationship: 1.5 mm≤L1≤4.5 mm.

Item D6. The steam generator according to Item D1, where the steam generator is configured to allow only a portion of the heating body to be covered with water and to maintain a surface of another portion of the heating body not covered with water at a maximum temperature of 280-580° C., to allow at least a portion of water entering the steam generator from the water inlet to be heated and atomized and sprayed out from the air outlet.

Item D7. The steam generator according to Item D6, where the steam generator is configured so that, when in use, the heating body gradually inclines upwardly in a direction from the first end to the second end, where a low temperature zone represents a zone of the heating body covered with water and a high temperature zone represents a zone not covered with water.

Item D8. The steam generator according to Item D7, where in the direction from the first end to the second end, an inclination angle R of the heating body with respect to the horizontal plane meets to the following relationship: 3°≤R≤15°.

Item D9. The steam generator according to Item D7, where the housing is provided with at least a scale deposit chamber extending downwardly at a position corresponding to the high temperature zone of the heating body, the scale deposit chamber is in communication with the heating chamber, and a bottom of the scale deposit chamber is configured to be lower than a bottom of the heating chamber.

Item D10. The steam generator according to Item D9, where the heating body includes a temperature detecting element, a detection point of the temperature detecting element is set at the high temperature zone and is used to measure a temperature of the high temperature zone; and in an axial direction of the steam generator, a relative position between the detection point and a side wall of the scale deposit chamber adjacent to the first end is within 10 mm.

Item D11. The steam generator according to Item D9, where the air outlet is arranged on the housing at a position corresponding to the scale deposit chamber; a filter assembly is arranged in the scale deposit chamber, and water heated and atomized is sprayed out from the air outlet after passing through the filter assembly.

Item D12. The steam generator according to Item D11, where a central axis of the air outlet is located higher than a bottom of the second end of the heating body.

Item D13. The steam generator according to Item D12, where the air outlet is arranged on an end surface of the second end of the housing; the filter assembly is configured to cover the air outlet.

Item D14. The steam generator according to Item D12, where the air outlet is arranged at a top position of the housing adjacent to the second end; the filter assembly includes a first filter arranged above the scale deposit chamber and covering the air outlet, and a second filter connected to the first filter and extending to the bottom of the scale deposit chamber.

Item D15. The steam generator according to Item D1, where the water inlet is arranged on the housing at a position of above the heating body.

Item D16. The steam generator according to Item D15, where the heating body is fixed with a flange at a position adjacent to the first end, and the heating body is connected to an open end of the housing by the flange; and a distance L2 between a central axis of the water inlet and an end surface of the flange meets the following relationship: 0 mm≤L2≤30 mm.

Item D17. The steam generator according to Item D10, further including a control unit, where the control unit is configured to control a heating power of the heating body and a flow rate of water from the inlet into the heating chamber based on a temperature collected by the temperature detecting element.

Item D18. An intelligent device, including the steam generator according to any one of Items D1 to D17.

Item E1. A cleaning device, including,
a body;
a heating apparatus, arranged on the body and having a heating body, where the heating body has an internal chamber as well as a water inlet and an air outlet that are in communication with the internal chamber, a surface of a portion of the heating body maintains at a maximum temperature of more than 400° C.;
an air outlet pipe, connected to the air outlet;
a sealing member, arranged at the air outlet to sealingly connect the air outlet pipe and the air outlet;
an air jet head, connected to the air outlet pipe; and
a cooling apparatus, arranged on the body for decreasing a temperature of the heating body.

Item E2. The cleaning device according to Item E1, where the cooling apparatus includes a heat exchanger pipe and a drive mechanism, the drive mechanism is arranged in the heat exchanger pipe to drive a cooling medium to flow along the heat exchanger pipe, at least a portion of the heat exchanger pipe is in contact with the heating body to enable the cooling medium to absorb heat from the heating body.

Item E3. The cleaning device according to Item E2, where the heat exchanger pipe is in communication with the water inlet to supply water to the heating body.

Item E4. The cleaning device according to Item E3, where the heating body has a first end and a second end that are opposite to each other, the water inlet is proximate to the first end, the air outlet is proximate to the second end, and at least a portion of the heat exchanger pipe is wrapped around a surface of the heating body proximate to the second end.

Item E5. The cleaning device according to Item E2, further including a roller brush, a water spray nozzle arranged toward the roller brush, and a water supply pipe, where the water supply pipe is in communication with the water inlet to supply water to the heating body; and
the heat exchange pipe is in communication with the water spray nozzle to supply water to the water spray nozzle, and at least a portion of the heat exchange pipe is wrapped around a surface of the heating body proximate the sealing member.

Item E6. The cleaning device according to Item E5, where the water supply pipe includes a first pipe and a second pipe, the first pipe is in communication with the second pipe and the upstream of the heat exchange pipe, and where
the drive mechanism includes:
   a first pump body, arranged in the first pipe; and
   a second pump body, arranged in the second pipe or the heat exchange pipe.

Item E7. The cleaning device according to Item E1, further including a power supply assembly and a reservoir arranged on the body, the power supply assembly is connected to the heating apparatus and the cooling apparatus.

Item E8. A cleaning assembly for use in a cleaning device, where the cleaning assembly includes:
a heating apparatus having a heating body, where the heating body has an internal chamber as well as a water inlet and an air outlet that are in communication with the internal chamber; and
a cooling apparatus, configured to decrease a temperature of the heating body.

Item E9. The cleaning assembly according to Item E8, where the cooling apparatus includes a heat exchange pipe and a drive mechanism arranged in the heat exchange pipe, the drive mechanism is configured to drive a cooling medium to move along the heat exchange pipe, at least a portion of the heat exchange pipe is in contact with the heating body.

Item E10. The cleaning assembly according to Item E9, where the heat exchange pipe is connected to the water inlet to supply water to the heating apparatus.

Item E11. The cleaning assembly according to Item E9, further including a water supply pipe, an air jet nozzle and a water spray nozzle, the water supply pipe is in communication with the water inlet, the air outlet is connected to the air jet nozzle, and an outlet of the heat exchange pipe is connected to the water spray nozzle.

Item E12. A cleaning method, including:
providing a cleaning device, where the cleaning device includes a heating apparatus, an air jet head and a heat exchange pipe, and the heating apparatus has a heating body; and
exchanging heat between water in the heat exchange pipe and the heating body, to decrease a temperature of the heating body, and to heat the water in the heat exchange pipe.

Item F1. A cleaning device, including a heating body, where the heating body includes:
a heating body housing;
a heat-conducting rod, where the heat-conducting rod includes a first end and a second end that are opposite to each other; the heat-conducting rod is configured to be pressed inside a chamber of the heating body housing, the heat-conducting rod is provided with a thermocouple groove at an end surface of the first end;
a heating wire, where the heating wire is wrapped around the heat-conducting rod and is configured for heating;
a thermocouple detecting element, where a measurement point of the thermocouple detecting element is set in the thermocouple groove; and
a support body, where the support body is configured to cooperate with the thermocouple groove; the support body is provided with a notch at an end adjacent the measurement point, and the measurement point is set in the notch.

Item F2. The cleaning device according to Item F1, where the support body is provided with a first extension part and a second extension part respectively on opposite sides of the support body, the first extension part and the second extension part enclose to form the notch and are configured to support at a position in the thermocouple groove corresponding to the measurement point.

Item F3. The cleaning device according to Item F2, where the support body is in a form of a sheet and the thermocouple groove is configured to have a shape adapted to the support body.

Item F4. The cleaning device according to Item F1, where the heating body housing is shrunk to fit tightly with the heat-conducting rod.

Item F5. The cleaning device according to Item F4, where the support body is made of the same material as the heat-conducting rod, after the heating body housing is shrunk, the support body and heat-conducting rod are pressed into one piece.

Item F6. The cleaning device according to Item F1, where the heating body includes a front support part and a rear support part; and the front support part is arranged at a first end of the heat-conducting rod and is configured to support the first end of the heat-conducting rod; the rear support part is arranged at a second end of the heat-conducting rod and is configured to support the second end of the heat-conducting rod.

Item F7. The cleaning device according to Item F6, where the heat-conducting rod, the support body, the front support part and the rear support part are all made of a material of magnesium oxide.

Item F8. The cleaning device according to Item F7, where a radial dimension of each of the front support part and the rear support part is larger than a radial dimension of the heat-conducting rod, and each of the front support part and rear support part is provided with a through groove extending in its axial direction at the outer wall.

Item F9. The cleaning device according to Item F7, where the thermocouple detecting element includes a positive wire and a negative wire;
the rear support part and a portion of the heat-conducting rod near the rear support part are respectively provided with a positive wire channel and a negative wire channel, and the positive wire channel and negative wire channel are in communication with the thermocouple groove inside the heat-conducting rod; and
the positive wire and the negative wire extend from outside of the second end of the heating body to the thermocouple groove, and connected to each other in the thermocouple groove to form the measurement point.

Item F10. The cleaning device according to Item F9, where the heat-conducting rod is provided with a first wire channel and a second wire channel; two ends of the heating wire respectively extend into the first wire channel and the second wire channel on the heat-conducting rod;
the heating body further includes a first wire and a second wire, the first wire and the second wire penetrate from the rear support part respectively into the first wire channel and the second wire channel of the heat-conducting rod and extend into the front support part; the first wire and the second wire contact and cooperate with portions of the heating wire respectively in the first wire channel and the second wire channel.

Item F11. The cleaning device according to Item F10, where in a cross-section of the heating body, a line between the positive wire channel and negative wire channel is perpendicular to a line between the first wire channel and the second wire channel.

Item F12. The cleaning device according to Item F11, where a space between the heating body housing and the heat-conducting rod, the front support part and the rear support part is filled with magnesium oxide powder.

Item F13. The cleaning device according to Item F1, where the heating wire extends from a zone at the first end to a zone at the second end, and the thermocouple detecting element is configured to detect a temperature of a position of the heat-conducting rod adjacent the zone at the first end.

Item F14. The cleaning device according to Item F13, where a distance between a measurement point of the thermocouple detecting element and an end surface of the first end of the heat-conducting rod ranges from 5.5 to 10.5 mm.

Item F15. A heating body, including:
a heating body housing;
a heat-conducting rod, where the heat-conducting rod includes a first end and a second end that are opposite to each other; the heat-conducting rod is configured to be pressed into a chamber of the heating body housing, the heat-conducting rod is provided with a thermocouple groove on an end surface of the first end;
a heating wire, where the heating wire is wrapped around the heat-conducting rod and is configured for heating;
a thermocouple detecting element, where a measurement point of the temperature thermocouple element is set in the thermocouple groove; and
a support body, configured to cooperate with the thermocouple groove, where the support body is provided with a notch at an end adjacent to the measurement point, the measurement point is set in the notch.

Item G1. A cleaning device, including:
a body;
a heating apparatus, configured to heat water to generate steam; and
an air jet head, provided with at least one air jet nozzle and an air outlet enclosure part, where the air jet head is in communication with the heating apparatus and sprays the steam through the air jet nozzle, where
the air outlet enclosure part surrounds the air jet nozzle, and a cross-sectional area of a gathering chamber enclosed by the air outlet enclosure part is greater than a cross-sectional area of the air jet nozzle.

Item G2. The cleaning device according to Item G1, where parameters of the cleaning device meet the following Expression (1):

$$\frac{L}{ρ A} \geq 272 m / s \qquad Expression ( 1 )$$

where L represents a flow rate of water at the water inlet of the heating apparatus, p represents a density of steam in the air jet head, and A represents a sum of cross-sectional areas of air jet nozzles.

Item G3. The cleaning device according to Item G2, further including:
a water storage tank; and
an infusion pump, configured to pump water from the water storage tank into the heating apparatus and to enable the parameters of the cleaning device to meet the Expression (1) by adjusting the flow rate of the pumped water.

Item G4. The cleaning device according to Item G1, where the gathering chamber is cylindrical.

Item G5. The cleaning device according to any one of Items G1 to G4, where the air jet nozzle has a cross-sectional area of 0.35-1.35 mm2.

Item G6. The cleaning device according to any one of Items G1 to G4, where the gathering chamber has a cross-sectional area of 3-50 mm2.

Item G7. The cleaning device according to Item G6, where the gathering chamber has a cross-sectional area of 3-30 mm2.

Item G8. The cleaning device according to any one of Items G1 to G4, where the air outlet enclosure part has a height of 5-15 mm.

Item G9. The cleaning device according to any one of Items G1 to G4, where the air outlet enclosure part surrounds at least two air jet nozzles.

Item G10. The cleaning device according to any one of Items G1 to G4, further including:
a filter apparatus, arranged between the heating apparatus and the air jet head and configured to filter impurities in the steam.

Item G11. A cleaning device, including:
a body;
a heating apparatus, where the heating apparatus includes an internal chamber as well as a water inlet and an air outlet that are in communication with the internal chamber, and the heating apparatus further includes a heating body, the heating apparatus is configured to allow only a portion of the heating body to be covered with water and to maintain a surface of another portion of the heating body not covered with water at a temperature of 280-580° C., to allow at least a portion of water entering the heating apparatus from the water inlet to be heated and atomized and sprayed out from the air outlet; and an air jet head, in communication with the air outlet to spray water mist out.

Item G12. The cleaning device according to Item G11, where the heating apparatus further includes:
a housing, where the housing has the internal chamber, and the heating body extends into the internal chamber, where
the heating body includes a first end and a second end that are opposite to each other, the first end is located higher than the second end, and a surface of the heating body maintains at a temperature of 280-580° C.; and the air outlet is arranged on the housing at a position corresponding to the first end.

Item G13. The cleaning device according to Item G11, where the heating apparatus is configured to maintain a surface of another portion of the heating body not covered with water at a temperature of 350-400° C.

Item G14. The cleaning device according to any one of Items G11 to G13, where the air jet head is provided with at least one air jet nozzle and air outlet enclosure part, the air jet head is in communication with the heating apparatus and spraying water mist through the air jet nozzle; and
the air outlet enclosure part surrounds the air jet nozzle, and a cross-sectional area of a gathering chamber enclosed by the air outlet enclosure part is greater than a cross-sectional area of the air jet nozzle.

1. A steam generator, comprising a heating body, a heating chamber, and a water inlet and an air outlet that are in communication with the heating chamber, wherein
the heating body is configured to heat water entering into the heating chamber from the water inlet; and
the heating body comprises a heating zone covered with water, and a high temperature zone not covered with water; the water on the heating zone is heated to form steam, and the steam is sprayed out from the air outlet after passing through the high temperature zone.

2. The steam generator according to claim 1, wherein at least a portion of entire circumferential sidewall of the heating body is configured to be not covered with water, to form the high temperature zone.

3. The steam generator according to claim 1, wherein the heating body comprises a heat-conducting part and a heating part, and a hollow internal chamber of the heat-conducting part serves as the heating chamber; and
the heating part is configured to be wrapped around at least a portion of an outer surface of the heat-conducting part.

4. The steam generator according to claim 3, wherein the steam generator comprises a first end and a second end that are opposite to each other along an axial direction of the steam generator;
the water inlet is arranged at the first end of the steam generator, and the air outlet is arranged at the second end of the steam generator; and
the heating body is configured to gradually incline upwardly from the first end to the second end, the heating zone is at a position adjacent the first end of the heating.

5. The steam generator according to claim 4, wherein in a direction from the first end to the second end, an inclination angle R of the heating body & with respect to a horizontal plane meets the following relationship: 5°≤R≤60°.

6. The steam generator according to claim 4, wherein the steam generator further comprises a housing, the heat-conducting part is arranged in an internal chamber of the housing, and a water injection pipe joint of the water inlet is arranged at a first end of the housing.

7. The steam generator according to claim 6, wherein the heating part is configured to have a predetermined distance in an axial direction of the heat-conducting part respectively from a first end and a second end of the heat-conducting part.

8. The steam generator according to claim 7, further comprising:
a pre-heating pipe, being wrapped around the heat-conducting part at a position adjacent to the second end of the heat-conducting part, wherein
an inlet of the pre-heating pipe is configured to be connected to an outside water source, and an outlet of the pre-heating pipe is configured to be connected to the water inlet via a pipe.

9. The steam generator according to claim 8, wherein the pre-heating pipe is wrapped around the heat-conducting part at a position staggered from the heating part.

10. The steam generator according to claim 1, wherein the steam generator comprises a housing, an internal chamber of the housing serves as the heating chamber; the heating body is arranged in the heating chamber and is configured to extend in the heating chamber along a direction from a first end to a second end, and wherein a space above the heating body is larger than a space below the heating body in the heating chamber.

11. The steam generator according to claim 10, wherein the housing comprises:
a first enclosure part arranged below the heating body,
a flaring part connected to the first enclosure part and inclined outwardly from a position of connection with the first enclosure part to outside of the heating body; and
a second enclosure part arranged above the heating body and connected to the flaring part.

12. The steam generator according to claim 11, wherein the first enclosure part and the second enclosure part are in a circular arc shape, and a radius of curvature of the first enclosure part is smaller than a radius of curvature of the second enclosure part.

13. The steam generator according to claim 1, wherein the high temperature zone maintains at a temperature of 280-580° C.

14. The steam generator according to claim 1, wherein the steam generator is provided with a scale deposit chamber in communication with the heating chamber, the scale deposit chamber is arranged on a side adjacent to the high temperature zone and is configured to receive scale.

15. The steam generator according to claim 14, wherein the air outlet is arranged on the steam generator at a position corresponding to the scale deposit chamber, a filter assembly is arranged in the scale deposit chamber, the filter assembly is configured to cover the air outlet.

16. An intelligent device, comprising the steam generator according to claim 1.

17. A cleaning device, comprising the steam generator according to claim 1, wherein the cleaning device comprises:
a body;
a heating apparatus, wherein the heating apparatus comprises a heating body housing and a heating body, the heating body housing has a heating body chamber inside as well as a water inlet and an air outlet that are in communication with the heating body chamber, the heating body is arranged in the heating body chamber, and the heating apparatus is configured to allow only a portion of the heating body to be covered with water and to maintain a surface of the other portion of the heating body not covered with water to be at a maximum temperature of 280-580° C., to allow at least a portion of water entering the heating apparatus from the water inlet to be heated and atomized and sprayed out from the air outlet; and
an air jet head, connected to the air outlet to spray water mist out.

18-21. (canceled)

22. The cleaning device according to claim 17, wherein the heating body comprises:
a heat-conducting rod;
a heating wire, wrapped around the heat-conducting rod and extending from a zone at the first end to a zone at the second end; and
a heating body housing, wherein the heat-conducting rod and the heating wire are both arranged in the heating body housing.

23-24. (canceled)

25. The cleaning device according to claim 22, wherein the heating apparatus further comprises:
a temperature detecting element, configured to detect a temperature of the second end; and
a control unit, configured to control a heating power of the heating body based on a temperature detection result of the temperature detecting element, to maintain a surface of the second end at a maximum temperature of 280-580° C.

26. The cleaning device according to claim 25, wherein a detection point of the temperature detecting element is set inside the heat-conducting rod at the s end.

27-38. (canceled)

39. The cleaning device according to claim 187, wherein a distance between the detection point of the temperature detecting element and an end surface of the second of the heat-conducting rod ranges from 5.5 mm to 10.5 mm.

40. The cleaning device according to claim 17, wherein a thermocouple groove is formed on an end surface of the second end of the heat-conducting rod, the thermocouple groove is configured to receive the detection point of the temperature detecting element; and
the heating body further comprises a support body, the support body is configured to cooperate with the thermocouple groove; the support body is provided with a notch at an end adjacent to the detection point, the detection point is set in the notch.

41. The cleaning device according to claim 40, wherein the heating body further comprises a front support part and a rear support part; and
the front support part is arranged at the second end of the heat-conducting rod and is configured to support the second end of the heat-conducting rod, the rear support part is arranged at the first end of the heat-conducting rod and is configured to support the first end of the heat-conducting rod.

42. (canceled)

43. The cleaning device according to claim 41, wherein the temperature detecting element comprises a positive wire and a negative wire;
the rear support part and a portion of the heat-conducting rod near the rear support part are respectively provided with a positive wire channel and a negative wire channel, and the positive wire channel and negative wire channel are in communication with the thermocouple groove inside the heat-conducting rod; and
the positive wire and the negative wire each extend from an outside of the second end of the heating body to the thermocouple groove, and are connected with each other in the thermocouple groove to form the detection point.

44-92. (canceled)

93. A cleaning device, comprising the steam generator according to claim 1, wherein the cleaning device comprises:
a body;
a heating apparatus, configured to heat water to generate steam; and
an air jet head, provided with at least one air jet nozzle and an air outlet enclosure part, wherein the air jet head is in communication with the heating apparatus and sprays the steam through the air jet nozzle, wherein
the air outlet enclosure part surrounds the air jet nozzle, and a cross-sectional area of a gathering chamber enclosed by the air outlet enclosure part is greater than a cross-sectional area of the air jet nozzle.

94-95. (canceled)

96. The cleaning device according to claim 93, wherein the gathering chamber is cylindrical.

97-100. (canceled)

101. The cleaning device according to claim 93, wherein the air outlet enclosure part surrounds at least two air jet nozzles.

102. The cleaning device according to a claim 93, further comprising:
a filter apparatus, arranged between the heating apparatus and the air jet head and configured to filter impurities in the steam.

103-106. (canceled)
